(19) United States
(12) Patent Application Publication
(10) Pub. No.: US 2009/0132813 A1
(43) Pub. Date: May 21, 2009

(54) Apparatus and Methods for Providing Scalable, Dynamic, Individualized Credential Services Using Mobile Telephones

(75) Inventor: Norman Schibuk, Merrick, NY (US)

Correspondence Address: BROMBERG & SUNSTEIN LLP, 125 SUMMER STREET, BOSTON, MA, 02110-1618, US

(73) Assignee: SURIDX, INC., Wellesley, MA (US)

(21) Appl. No.: 12/267,065

(22) Filed: Nov. 7, 2008

Related U.S. Application Data
(60) Provisional application No. 60/986,534, filed on Nov. 8, 2007.
(60) Provisional application No. 60/992,029, filed on Dec. 3, 2007.
(60) Provisional application No. 61/030,845, filed on Feb. 22, 2008.
(60) Provisional application No. 61/050,904, filed on May 6, 2008.
(60) Provisional application No. 61/060,755, filed on Jun. 11, 2008.

(51) Int. Cl. H04L 9/32

(52) U.S. Cl. 713/158; 726/9

(57) ABSTRACT

Apparatus and methods perform transactions in a secure environment between an individual and another party, such as a merchant, in various embodiments. The individual possesses a mobile electronic device, such as a smartphone, that can encrypt data according to a public key infrastructure. The individual authenticates the individual's identity to the device, thereby unlocking credentials that may be used in a secure transaction. The individual causes the device to communicate the credentials, in a secure fashion, to an electronic system of a relying party, in order to obtain the relying party's authorization to enter the transaction. The relying party system determines whether to grant the authorization, and communicates the grant and the outcome of the transaction to the device using encryption according to the public key infrastructure.

### PRIORITY

This application claims the benefit of the United States Provisional patent applications having the following serial numbers and filing dates: 60/986,534 filed on Nov. 8, 2007; 60/992,029 filed on Dec. 3, 2007; 61/030,845 filed on Feb. 22, 2008; 61/050,904 filed May 6, 2008; and 61/060,755 filed on Jun. 11, 2008. Each of these Applications is incorporated herein by reference in its entirety.

### TECHNICAL FIELD

The present invention relates to apparatus and computer-implemented methods for distributed public key infrastructures (PKI). More specifically, the present invention relates to credential services, such as authenticating individuals and distributing data, using a distributed public key infrastructure, and includes in various embodiments the use of mobile telephones and flash memory to these ends.

### BACKGROUND ART

A public key infrastructure (PKI) provides a model through which electronic devices may authenticate themselves to each other and exchange encrypted messages. PKI is described in industry standards, for example International Telecommunication Union, Information technology—Open Systems Interconnection—The Directory: Public-key and attribute certificate frameworks, hereby incorporated by reference. This standard is known as “X.509”, and may be found on the Internet at http://www.itu.int/rec/T-REC-X.509/en. A PKI allows an individual to validate the public data of another individual, typically a public encryption key. The public key is distributed, via a computer network, in a certificate, and a cryptographic algorithm may be applied to ensure its accuracy. Certificates are described in Internet Engineering Task Force (IETF), Request for Comments 3280: Internet X.509 Public Key Infrastructure Certificate and Certificate Revocation List (CRL) Profile, hereby incorporated by reference, and which may be found at http://tools.ietf.org/html/rfc3280. Several companies, such as RSA Security, offer public key infrastructure software and services. Using a PKI, messages can be sent from one device to another without possibility of undetected alteration, so PKI systems are important in such diverse applications as electronic commerce, physical access systems, and secure communications.

However, present PKI systems suffer from a number of drawbacks. First, an organization (such as the Department of Defense) or business enterprise (such as IBM Corporation) may have thousands of locations and hundreds of thousands of employees. Quickly responding to authentication requests generally requires duplicating and distributing data to many servers and locations. The process of distributing data, and the resultant data availability at a number of sites, introduces security attack vectors. Second, as a practical matter this data model requires authenticating applications to be connected to a data network, potentially incurring high costs to provide connectivity. Third, enterprises may wish to communicate with each other. Trust may be developed differently within each enterprise, and one internal trust model may be different from the other. A party in one enterprise verifying a trust relationship within the other enterprise must use a foreign trust model, a potentially complex undertaking. Given certain PKI constraints, such as limitations on the length of a trust chain, it may be impossible to verify trust cross organizations under certain conditions. Also, each enterprise may need to query many different servers to obtain complete trust information, resulting in slow response times and high network traffic.

These drawbacks may be summarized by noting that the PKI deployment model currently in use does not efficiently serve the relationships and physical geometries of the participating parties to large numbers of authentication transactions. Current systems assume that an authenticating party can be in any place any time, requiring large amounts of bandwidth and large numbers of servers to move authentication data and validate it. This architecture does not scale, even in reasonably small use cases.

### SUMMARY OF THE INVENTION

The present invention addresses the aforementioned drawbacks, and a person skilled in the art may appreciate additional advantages. In accordance with embodiments of the invention, authentication data are protected by a distributed PKI. In a distributed PKI, authentication data are stored on an edge device, typically a mobile electronic device such as a cellular telephone or personal digital assistant (PDA). An individual needing authentication carries this edge device to its place of intended use. The individual presents authentication data directly to a relying party system over a short-range data network. Devices participating in a transaction need not access a remote validation service, saving bandwidth usage and response time. Further, authentication computations may be performed by each device participating in a transaction. Although the total number of computations may be large, spreading the workload to the edge devices decreases the computational power required by each device, bringing edge device hardware and software implementation requirements to practical levels. Increasing the number of devices in use proportionately increases the distribution of authentication data and computational power available, allowing the system to scale linearly. By employing data encryption between the edge device and the relying party system, the individual may enter secure transactions. The encryption keys used by each device may be validated using certificates, which themselves may be validated without access to a data network using cross-certificates and cached OCSP responses. The use of encryption prevents replay attacks against certificate data. By limiting the number of systems involved in any transaction to only two, the invention aids the establishment of trust models between individuals in two enterprises without requiring path discovery of foreign trust chains.

In a first embodiment of the invention there is provided a process for authenticating an individual to participate in a transaction with a relying party. The process includes producing a mobile electronic device, the device storing a digitally signed document containing a set of credential data, derived from a corresponding set of credentials, of the individual, and requiring, as a condition to using the stored set of credential data for authentication purposes, entry into the device of authentication data authenticating a would-be user of the device as the individual. The process further includes entering the authentication data into the device to authenticate the individual to the device, so that the individual can use the stored set of credential data, and also includes causing the device to communicate the set of credential data to a system of the relying party, for purposes of authenticating the individual to participate in the transaction.

In related embodiments, the transaction includes: a purchase; receiving an extension of credit; obtaining access to money stored in a financial account; obtaining access to a physical location; obtaining access to a web page; obtaining access to a computing resource; obtaining access to data by downloading; receiving an HTTP cookie; or uploading medical data of the individual.

In some embodiments the mobile electronic device includes one of a smartphone and a personal digital assistant. The mobile electronic device may include WORM memory, as that term is defined below. The WORM memory may include a set of encryption data, the set having a private encryption key or private signature key of the individual. The mobile electronic device may have a display and an advertisement associated with an item in the set of encryption data, with the process further comprising displaying the advertisement on the display in connection with use of the device. The advertisement may be stored in the WORM memory.

In various related embodiments, the set of credential data is derived from one or more of: a passport, a birth certificate, a Transportation Worker Identification Credential (TWIC), a Common Access Card (CAC), a smartcard, a driver's license, a pilot's certificate, an identification card, an organization membership card, an insurance card, a credit card, a debit card, a store discount card, a public transportation card, or a library card. In other related embodiments, entering authentication data includes entering data pertaining to one of: a fingerprint, a handprint, a photograph, an iris scan, a retina scan, a password, an authorization code, or a personal identification number. Entering authentication data may include providing two-factor authentication data, for example a password and biometric data. The mobile electronic device may communicate by wireless communication. The system of the relying party may include one of: a vending machine, a parking meter, an electronic toll collection system, a physical access system, and a magnetic stripe reader.

In another related embodiment, a suite of applications is stored on the device, and the set of credential data identifies a subset of the suite of applications to be made available to the individual upon authentication of the would-be user as the individual. The process may be continued by causing the device to run an application loaded thereon, the application being unavailable for use until there has been entry into the device of authentication data authenticating the would-be user of the device as the individual.

The process may also be continued in a related embodiment by receiving at the mobile electronic device, from the system of the relying party, a response to the communication of the set of credential data. Receiving the response may include receiving a verification of a credential in the set of credentials, or receiving a notification that the transaction has been completed. Receiving the response may also trigger updating a transaction log maintained on the mobile electronic device, and/or setting of an upload flag to enqueue uploading of data reflecting the transaction. In a related embodiment, the mobile electronic device includes a WORM memory, and the mobile device performs, on the WORM memory, an operation triggered by receiving the response. The operation may be storage of data related to the response, or rendering a portion of the WORM memory unreadable. Independently of receiving a response, causing the device to communicate the set of credential data may trigger storing, in a transaction log maintained on the mobile electronic device, a record having data related to the transaction.

In another embodiment there is provided a process for use by a relying party in authenticating an individual having a mobile electronic device to participate in a transaction with the relying party. As before, the device in this embodiment is storing a digitally signed document containing a set of credential data, derived from a corresponding set of credentials, of the individual and is requiring, as a condition to using the stored set of credential data for authentication purposes, entry into the device of authentication data authenticating a would-be user of the device as the individual. The process of this embodiment includes receiving, in a system in communication with the device, the digitally signed document from the device, wherein receipt of the digitally signed document constitutes verification of entry into the device of the authentication data. The process further includes using the system to evaluate a selected credential in the set of credentials, and storing data, associated with the transaction and the digitally signed document, in the system of the relying party in a transaction log.

In related embodiments, the transaction includes: a purchase; granting an extension of credit; providing access to money stored in a financial account; providing access to a physical location; providing access to a web page; providing access to a computing resource; providing access to data for downloading by the individual; or transmitting an HTTP cookie.

In some embodiments the mobile electronic device includes one of a smartphone and a personal digital assistant. The mobile electronic device may include WORM memory, as that term is defined below. The WORM memory may include a set of encryption data, the set having a private encryption key or private signature key of the individual. In a related embodiment, using the system to evaluate the selected credential includes validating a digital signature of the digitally signed document, using a public signature key of the individual that forms a key pair with the private signature key of the individual.

In various related embodiments, the set of credential data is derived from one or more of: a passport, a birth certificate, a Transportation Worker Identification Credential (TWIC), a Common Access Card (CAC), a smartcard, a driver's license, a pilot's certificate, an identification card, an organization membership card, an insurance card, a credit card, a debit card, a store discount card, a public transportation card, or a library card. Furthermore, receiving the digitally signed document may include receiving the document wirelessly. In other related embodiments, using the system to evaluate the selected credential includes: validating a digital signature of the digitally signed document using a public signature key of the individual; comparing a digest derived from the credential data with a stored digest; comparing the time the digitally signed document was received from the device with a timestamp in the document; and/or obtaining a certificate status response from the mobile electronic device. The timestamp may be indicative of the time when credentials on the mobile electronic device were last updated or when the mobile electronic device was last connected to a network in a session meeting pre-specified criteria. Obtaining a certificate status response is accomplished in some embodiments by transmitting a first message including a cryptographic nonce to the mobile electronic device, the first message encrypted with a public encryption key of the individual; and receiving a second message including the nonce and the certificate status response from the mobile electronic device.

In a related embodiment, using the system to evaluate the selected credential includes communicating with a computer system, of a third party, that can validate the accuracy of the credential data or verify that the credential is unexpired. The third party may be an issuer of the selected credential or an agent of the issuer. Communicating may include receiving, from the third party, data indicating that the selected credential has not been revoked. The process may further include obtaining a certificate status response from the third party, or obtaining a certificate revocation list from the third party.

The process may be continued in another embodiment by transmitting, to the mobile electronic device, a message responsive to receipt of the digitally signed document. Transmitting may include transmitting data indicating that the selected credential in the set of credentials is valid and unexpired, or transmitting a notification that the transaction has been completed.

In another embodiment there is provided a mobile electronic device, usable by an individual for authentication of transactions. The device includes a storage module in which are stored a digitally signed document containing a set of credential data, derived from a corresponding set of credentials, of the individual, and authentication data of the individual. The device has a data entry arrangement for entering data into the device. The device further includes a controller, coupled to the storage module and the data entry arrangement, programmed to require, as a condition to using the stored set of credential data for authentication purposes, entry of the authentication data into the device via the data entry arrangement, so as to authenticate a would-be user of the device as the individual. The device also has a communication port for receiving and transmitting the digitally signed document.

In a related embodiment, the set of credentials includes a plurality of credentials of the individual, so that the device can be used to authenticate distinct classes of transactions, each class of transactions being associated with a distinct credential. In other related embodiments, the storage module includes non-volatile memory, WORM memory, or both WORM memory and WMRM memory incorporated in flash memory. In some of these embodiments, the WORM memory includes the digitally signed document or a set of encryption data, the set having a private encryption key of the individual or a private signature key of the individual.

In one embodiment of the device, the storage module includes an application stored therein, and the device also has a user control module restricting use of the application until there has been entry into the device, via the data entry arrangement, of the authentication data, to authenticate the would-be user of the device as the individual.

In another embodiment there is provided a process for configuring an electronic device to be usable by an individual for authentication of transactions. The process includes storing a digitally signed document in the electronic device, the digitally signed document including credential data derived from a set of credentials pertaining to the individual. The process also includes storing, in the electronic device, authentication data associated with the individual. In this process, the device includes a user control module that precludes access to the credential data without entry into the device of the authentication data.

The set of credentials may include a physical credential. The physical credential may be selected from the group consisting of: a passport, a birth certificate, a Transportation Worker Identification Credential (TWIC), a Common Access Card (CAC), a smartcard, a driver's license, a pilot's certificate, an identification card, an organization membership card, an insurance card, a credit card, a debit card, a store discount card, a public transportation card, and a library card. In a related embodiment, the process is continued by receiving a physical credential from the individual, using the physical credential in manually determining that the set of credentials pertains to the individual, creating the digitally signed document, and entrusting the device to the individual. Alternatively or in addition, the set of credentials includes a virtual credential. The process may be continued by obtaining biometric data of the individual and including the biometric data in the authentication data.

In some embodiments, a digital signature in the digitally signed document is able to be validated using a public signature key of the individual or of a third party. In other, related embodiments, the process includes storing a private encryption key or private signature key of the individual in the electronic device. In yet another embodiment, the electronic device includes WORM memory, and storing the digitally signed document in the electronic device includes storing the document in the WORM memory.

In another embodiment there is provided a computer-implemented method of developing information pertinent to authentication of a set of credentials for each of a plurality of individuals, the set of credentials having a corresponding set of credential data derived from the set of credentials. This method includes, for each of the individuals, placing the individual's credential data in a digitally signed document, and storing the digitally signed document in a credential database. The method also includes, in a computer process, automatically and repetitively checking for revocation of any credentials in the credential database and, for any credentials revoked, storing data identifying such credentials.

Storing data identifying credentials that have been revoked may include updating the credential database, or storing in a revocation database a listing of credentials that have been revoked. Checking may be checking at least as often as once per day, or checking in conformity with a PKI standard. In a related embodiment, the method further includes, for each of the individuals, storing the digitally signed document in a token entrusted to the individual.

In another embodiment there is provided a computer-implemented method of authenticating a given individual's set of credentials, the set of credentials having a corresponding set of credential data derived from the set of credentials, each credential in the set having been authenticated as of a given time. This method includes receiving the set of credential data over a communications network, and in a computer process, using the credential data to compare the set of credentials against a database listing of revoked credentials to identify a credential in the set that has been revoked since the given time. Receiving the set of credential data may include receiving them from a federated data store, or uploading a digital document from a token in the possession of the given individual, the digitally signed document containing the individual's set of credential data. In a related embodiment, identifying credentials of the individual that have been revoked implicitly determines that all other credentials of the given individual have not been revoked. Further, comparing may be performed in a batch computer process.

In another embodiment there is provided a computer-implemented method of processing transactions between a relying party having a transaction system, and a set of individuals, each individual in the set of individuals having an electronic device capable of communication with the transaction system. The method includes obtaining access to a first digitally signed document created in the transaction system of the relying party, the document containing one or more transaction records, each transaction record having data pertaining to a selected transaction between the relying party and a selected individual in the set of individuals. The method next includes, for each selected transaction, (1) obtaining access to a second digitally signed document created in the electronic device of the selected individual, the document containing a transaction record corresponding to the selected transaction; and (2) in a computer process, checking for consistency between the transaction record in the first digitally signed document and the transaction record in the second digitally signed document.

The process may include validating a digital signature of the first digitally signed document, using a public signature key of the relying party. It may also include validating a digital signature of the second digitally signed document of the selected individual, using a public signature key of the selected individual. The process may also include, in the event that checking yields an inconsistency, communicating a warning to the relying party or the selected individual. Each transaction record may contain data pertaining to at least one of a transaction time, a transaction date, a purchase amount, a loan number, a financial account number, a physical location, an address of a web page, an identifier of a computing resource, a file name, an HTTP cookie name, and a medical condition. Obtaining access to the first digitally signed document may include receiving the first digitally signed document over a computer data network, and obtaining access to the second digitally signed document may include receiving the second digitally signed document over a computer data network. Checking may be performed in a batch computer process, or in a process substantially contemporaneously with the selected transaction.

Another embodiment of the invention provides a system enabling a second party to obtain data in a secure manner from a first party. The system has a receiving port for securely receiving the data, along with a digitally signed document associated with the first party and a reference to the second party. The system also has a physical data storage medium for storing the received data and the digitally signed document in association with the second party. The system includes a processor for verifying that the sender of the received data is the first party using the digitally signed document, and for determining whether to securely forward data stored in the storage area to the second party according to a rule associated with the first party and the second party. The system further has a transmitting port for forwarding the data to a computer facility of the second party. The storage area may be readable only by the first party and the second party, and it may be associated with a URL.

In another embodiment there is provided a computerized method enabling a second party to obtain data in a secure manner from a first party. The method includes receiving from the first party items including the data, a digitally signed document associated with the data and with the first party, and a reference to the second party. The method also includes verifying that the received data were sent by the first party, by using the digitally signed document. The method further includes storing the data in association with the digitally signed document and with the reference. The method also includes making the stored data available to the second party using the reference, such that the second party may securely access the data. The data may have been encrypted using a public key of the second party. Further, the items may be included in a message that has been encrypted using a public key associated with the receiver, where receiving the items includes receiving the message from the first party, and decrypting the message using a private key associated with the public key.

In a related embodiment, the reference includes at least one of a digital certificate, a telephone number, a postal address, and an electronic address. Making the stored data available may include encrypting a second message, containing the data and the digitally signed document, using a public key of the second party; and transmitting the encrypted second message to the second party. The storage space may be readable only by the first party and the second party. Receiving the data from the first party may include using a secure communications link.

In a further related embodiment, the method includes deciding whether to forward the data to the second party according to a set of computer-implemented rules associated with the first party and the second party. In another related embodiment, the method includes forwarding the data to the second party. Forwarding the data to the second party may include using a secure communications link.

In yet another related embodiment, receiving the items from the first party includes receiving the items through a communications gateway that is not dedicated to handling trusted data from a particular source. The communications gateway may also handle data other than trusted data. Verifying that the received data were sent by the first party may be accomplished by the communications gateway. If so, doing so may include accessing an authorized certificate store to retrieve a certificate of the first party. In a related embodiment, making the stored data available to the second party using the reference is accomplished by the communications gateway. Storing the data in association with the digitally signed document and with the reference may be caused by the communications gateway.

In still another related embodiment, the method may include, upon receiving the items from the first party, initiating communication with the second party to obtain authorization to cause storage of the data. If the second party has a mobile telephone, making the stored data available to the second party may include sending a communication to the mobile telephone identifying the received data and seeking authorization to make the received data available to the second party, and, upon such authorization, making the received data available to the second party. Making the received data available to the second party may include making the data accessible to the mobile telephone for storage in memory thereof. This memory may be flash memory. The data may include information relating to a credential, and making the data accessible to the mobile telephone for storage in memory thereof includes making the data accessible for storage only in a portion of such memory configured as WORM memory. The WORM memory may be implemented in flash memory. In a related embodiment, the data are digital media content encrypted with a public key of the second party.

In another embodiment, there is provided a computerized method for creating a virtual smartcard for an individual based on a physical credential applicable to the individual. The method includes receiving, over a communications network, credential data derived from the physical credential and authentication data pertinent to the individual. It further includes using a computer process to establish a pair of cryptographic keys. The method also includes creating a virtual smartcard for the individual by storing the credential data and the authentication data in association with the pair of cryptographic keys. The physical credential may be selected from the group consisting of a passport, a birth certificate, a Transportation Worker Identification Credential (TWIC), a smartcard, a driver's license, a pilot's certificate, an identification card, an organization membership card, an insurance card, a credit card, a debit card, a store discount card, a public transportation card, and a library card. Authentication data may be selected from the group consisting of biometric data and a passcode.

In another embodiment, there is provided a method of evaluating a primary credential issued by an agency. This method includes using the primary credential to access from storage a summary certificate associated in the storage with the primary credential, the summary certificate containing a collection of secondary credentials considered by the agency in issuing the primary credential. The method also includes, in a revocation computer process, collecting secondary credential revocation information by (i) identifying each of the secondary credentials that is the subject of a revocation, and, (ii) for each revoked credential, accessing data that characterize a basis for the revocation. The method includes, in an evaluation computer process, applying a set of policy rules to the collected secondary credential revocation information to evaluate its effect on the primary credential.

In a related embodiment, the revocation computer process includes accessing a database of revoked credentials, the database established by automatic, computer-implemented, repetitive checking for revocation of secondary credentials of a plurality of individuals. In another related embodiment, one of the secondary credentials that is the subject of revocation is another primary credential that has been previously revoked by operation of computer processes, so that processes herein may spawn a cascade of revocations when permitted by policy rules to do so. Accessing data that characterize a basis for the revocation may include accessing data indicating that a chain of trust for a secondary credential has been broken. In a related embodiment, the method further includes revoking the primary credential when the policy rules being applied so require. In another related embodiment, the method further includes, in a further revocation computer process, identifying a set of additional primary credentials, the set having at least one member, for which the primary credential serves as a secondary credential in a corresponding set of summary certificates; and also includes, in a further evaluation computer process, subjecting the set of primary credentials to evaluation in a manner generally analogous to the evaluation computer process.

In another embodiment there is provided a computerized method for responding to a given individual's request for access. This method includes receiving, over a first communications network, a first data set defining rights of the given individual to access. The method further includes receiving, over a second communications network, from a token possessed by the given individual, a digitally signed document including a second data set defining rights of the given individual relating to the access. The method finally includes, in a computer process, comparing the first access rights data and the second access rights data to respond to the given individual's access rights.

In related embodiments, receiving over the first communications network includes receiving data from a cellular telephone network or the Internet. In the latter case, a virtual private network may be employed. Receiving over the second communications network may include receiving data from a Bluetooth network. The token may be a smartphone. The method may further include validating a digital signature of the digitally signed document. In this case, validating the digital signature may include receiving data from the token pertaining to a digital certificate, the digital certificate having a public signature key. If so, the data may incorporate a cached OCSP response.

In yet another embodiment there is provided a non-volatile memory device encoded with computer-readable data, such device including a first portion thereof configured as WORM memory in which are encoded credential data and a second portion thereof configured as WMRM memory. The device may be encoded with computer-readable instructions, such instructions including program code defining a cryptographic engine. The credential data may relate to a plurality of credentials of an individual. The device may be implemented in flash memory.

In still another embodiment there is provided a method for efficiently authenticating an individual in connection with a transaction, at a physical transaction location, such location using a public key infrastructure and having a terminal for use in the transaction. The method includes using data provided over a cellular telephone network to estimate a present location of a smartphone of the individual on which is stored credential data relating to a credential of the individual, such smartphone requiring the individual to authenticate himself to the smartphone as a condition of use of the credential data. Next, if the present location is determined to be within a specified range of the physical transaction location, the method requires sending data as to status of the credential to the terminal, so that the individual will be able to present the credential for use in the transaction only by authenticating himself to the smartphone, and status information of the credential will be available to the terminal for use in connection with the transaction when the individual appears at the physical location. The embodiment may estimate a present location using base station data or using GPS data from the smartphone.

In another embodiment there is provided a method for gating communication to a user's smartphone from a caller's smartphone based on a set of pre-specified criteria as to attributes of the caller. This method includes receiving on the user's smartphone a control message from the caller's smartphone constituting a request to establish communication with the user's smartphone, such control message including a credential of the caller. Next, using a process running on the user's smartphone, the method includes determining validity of the credential, and if the credential is determined to be valid, evaluating the credential for conformity with the set of criteria. If the credential is determined to be in conformity with the set of criteria, then the method requires allowing the communication to be established. The set of criteria may include presence of the name of the caller on a white list. Alternatively or in addition, the set of criteria may include a requirement that the caller have an age that is within two years of the user's age.

Another embodiment provides a data gathering device for communicating with a mobile electronic device of an individual, the mobile electronic device being capable of decrypting messages according to an encryption key of the individual. The data gathering device includes a sensor for gathering data; a cryptographic module for encrypting gathered data using the encryption key; and a transmitter for transmitting encrypted data to the mobile electronic device. The transmitter may be a Bluetooth transmitter. The cryptographic module may be a hardware security module, and it may be embedded within a smartcard. The data gathering device may also have a receiver for receiving encrypted data from the mobile electronic device and a display for displaying received data, wherein the cryptographic module is further capable of decrypting received data according to the encryption key. The display may be a video or an audio display, and it may be capable of displaying gathered data. The sensor of such embodiments may gather medical data, when the data gathering device is a medical device.

Yet another embodiment of the invention provides a method for securely obtaining, from a medical data gathering device, medical data pertinent to an individual. The method includes receiving the medical data over a wireless network from a smartphone of the individual coupled to the medical data gathering device. In this method, the smartphone stores and forwards, over the wireless network, the data from the medical data gathering device. Further, the medical data are encrypted with a public key of the individual. In a related embodiment, the smartphone is wirelessly coupled to the medical data gathering device. The smartphone may have flash memory in which are stored the medical data.

In another, related embodiment, the smartphone may have a storage module in which is stored a digitally signed document containing a set of credentials of the individual. The storage module may also store authentication data of the individual, in which case the smartphone further includes a data entry arrangement for entering data into the device, and a controller, coupled to the storage module and the data entry arrangement. The controller is programmed to require, as a condition to using the stored set of credentials for authentication purposes, entry of the authentication data into the device via the data entry arrangement, so as to authenticate a would-be user of the device as the individual.

This embodied method may be extended by storing the data received over the wireless network in a database coupled to a server for access by authorized medical professionals. The method may be further extended by decrypting and granting access to the medical data in response to a request by a person determined to be an authorized medical professional.

### BRIEF DESCRIPTION OF THE DRAWINGS

The foregoing features of the invention will be more readily understood by reference to the following detailed description, taken with reference to the accompanying drawings, in which:

FIG. 1 is a block diagram of major functional components of an embodiment of the invention;

FIG. 2A is a block diagram of a process by which a person may activate a mobile electronic device in accordance with embodiments of the invention;

FIG. 2B is a block diagram of a process by which a person may use a mobile electronic device in accordance with embodiments of the invention;

FIG. 3 is a block diagram of a process by which a digital resume is created, authenticated, and stored, in accordance with an embodiment of the invention;

FIG. 4 is a block diagram of a process by which digital resumes are updated to account for revoked credentials, in accordance with an embodiment of the invention;

FIG. 5 is a block diagram overview of a prior art computer-implemented process by which credential certificates are verified using a public key infrastructure;

FIG. 6 is a block diagram overview of a process by which certificates are verified using an extended public key infrastructure in accordance with an embodiment of the invention;

FIG. 7 is a block diagram detail of a process by which certificates are verified using a public key infrastructure in accordance with an embodiment of the invention;

FIG. 8 is a block diagram of a process by which a person may create a virtual smartcard in accordance with an embodiment of the invention;

FIG. 9 is a block diagram of a process by which a person may enable a device in accordance with an embodiment of the invention;

FIG. 10 is a block diagram of a process, in accordance with an embodiment of the present invention, for batch processing of secured transactions using a mobile device in the manner described and for rapidly detecting fraud;

FIG. 11 is a block diagram of a process by which a person may register a device in accordance with an embodiment of the invention to permit physical access to a secured area;

FIG. 12 is a block diagram of a process by which a person may use a device in accordance with an embodiment of the invention to access a secured area;

FIG. 13 is a block diagram of a process for updating a device in accordance with an embodiment of the invention to alter or revoke permission to access a secured area;

FIG. 14 is a schematic block diagram showing the relevant parts of a prior art system for providing business information;

FIG. 15A is a schematic block diagram showing the relevant parts of a system for providing business information in accordance with an embodiment of the invention;

FIG. 15B shows typical processes for implementing the deposit and secure access of trusted data according to the system of FIG. 15A;

FIG. 16 is a schematic block diagram showing preparation processes, in accordance with an embodiment of the present invention, of a trusted storage system for operation;

FIG. 17 is a schematic block diagram showing a process of updating a trusted storage system with new business data;

FIG. 18A is a block diagram of the flow of data at a business in a trusted system embodiment;

FIG. 18B is a block diagram of the flow of data at a data service provider in the embodiment;

FIG. 18C is a block diagram of the flow of data into the local storage of an electronic device in accordance with this embodiment of the invention;

FIG. 18D is a block diagram, in accordance with an embodiment of the invention, of the retrieval of data from the local storage of an electronic device so that it may be consumed;

FIG. 19 is a block diagram showing an embodiment of the present invention wherein a trusted data storage arrangement is coupled to a general communications gateway environment;

FIG. 20 is a schematic block diagram of another embodiment of the present invention showing a memory device including dedicated write-once, read-many (WORM) storage areas for trusted data;

FIG. 21 is a block diagram, in accordance with a further embodiment of the present invention, showing a process for updating the memory device of FIG. 20 in a manner consistent with consumer needs and a relevant business environment;

FIG. 22 is a block diagram, in accordance with a further embodiment of the present invention, showing a process for downloading digital media content to the memory device of FIG. 20;

FIG. 23 is a block diagram, in accordance with a further embodiment of the present invention, of a process for playing digital media content, from the memory device of FIG. 20, after the content has been downloaded according to the process shown in FIG. 22;

FIG. 24 is a block diagram, in accordance with embodiments of the present invention, of processes for determining which sites require cached credentials;

FIG. 25 is a block diagram, in accordance with an embodiment of the present invention, of caching credentials at a site determined in FIG. 24;

FIG. 26 is a block diagram of a further embodiment of the present invention showing processes for initiating communications between two parties;

FIG. 27 is a block diagram of relevant processes for authorizing a mobile electronic device in accordance with embodiments of the invention to participate in credit transactions;

FIG. 28 is a block diagram of processes by which a mobile electronic device in accordance with embodiments of the invention updates itself after a credit data network becomes available;

FIG. 29 is a block diagram of a method in accordance with an exemplary embodiment of the present invention, in which a phone as described above is prepared and used in card-not-present transactions;

FIG. 30 is a block diagram of a method for extending credit to an individual having a phone prepared as in FIG. 29;

FIG. 31 is a block diagram showing the operation of a single sign-on embodiment of the present invention;

FIG. 32 is a block timing diagram of an embodiment of the present invention in which cookie data is end-to-end encrypted;

FIG. 33 is a diagram showing the different components used in a method for acquiring data with a measuring device and publishing the data to trusted storage for later retrieval by a trusted individual, in accordance with an embodiment of the invention;

FIG. 34 is a block diagram of the process for uploading data in the method of FIG. 33;

FIG. 35 is a block diagram of a method for a trusted individual to access data acquired and published as in the embodiment of FIG. 34; and

FIG. 36 is a block diagram of a method for a trusted individual to transmit information to the measuring device of FIG. 33.

### DETAILED DESCRIPTION OF SPECIFIC EMBODIMENTS

Definitions: As used in this description and the accompanying claims, the following terms shall have the meanings indicated, unless the context otherwise requires:

A digital signature is an output of a public key (asymmetric cryptographic) algorithm used to simulate, in digital form, the endorsing properties of a physical signature. Algorithms for working with digital signature algorithms appear in pairs: one algorithm exists to create the signature, and one algorithm exists to validate the signature. Digital signature algorithms are well known in the art, an illustrative example being NIST, FIPS 186: Digital Signature Standard (DSS), hereby incorporated by reference. (FIPS-186, like other FIPS standards, is an evolving standard. A version current as of the date of filing may be found at http://csrc.nist.gov/publications/fips/fips186-2/fips186-2-change1.pdf) The DSS specifies a Digital Signature Algorithm (DSA) which is partially described in U.S. Pat. No. 4,995,082 (Schnorr) and U.S. Pat. No. 5,231,668 (Kravitz). These patents are hereby incorporated by reference.

A trusted authority is an agency or organization that certifies information relating to third parties by issuing, and digitally signing, electronic documents containing the information. Third parties who wish to validate such information about each other can agree to trust documents promulgated by one or more commonly-trusted authorities.

An identity certificate is an electronic document issued by a trusted authority which incorporates a digital signature to associate an individual with a public encryption key. The individual can use the encryption key to digitally sign electronic documents. A third party can use the encryption key to securely communicate with the individual. By signing a summary certificate, a trusted authority attests that the encryption key is that of the individual. The trusted authority may revoke an identity certificate by publishing notice of revocation using well-known methods, described below.

Online Certificate Status Protocol (OCSP) is a protocol for interactively providing and obtaining the revocation status of certificates. The protocol is described in Internet Engineering Task Force, Request for Comments 2560: X509 Internet Public Key Infrastructure—Online Certificate Status Protocol—OCSP (1999), and its successor documents, hereby incorporated by reference. (RFC 2560 may be found on the Internet at http://tools.ietf.org/html/rfc2560.)

A credential is data representing an attestation of qualification, competence, or authority issued to an individual by a third party having authority to do so. A credential may be embodied in a physical form, which we denote herein a physical credential. An example of a physical credential is a driver's license. A credential may also exist in electronic form, which we denote herein an electronic credential. An example of an electronic credential is a virtual smartcard in accordance with an embodiment of the present invention. A credential should be distinguished from the identity of its holder a credential may expire, while the identity of its holder does not.

A smartcard is a vehicle physical or virtual for providing one or more credentials. When the vehicle is physical, the physical smartcard is typically implemented as a pocket-sized card with embedded integrated circuits which can securely store and process information such as encryption keys, biometric data, and personal identification numbers. When the vehicle is virtual, the virtual smartcard is a computer system that simulates the behavior of a physical smartcard. Smartcards may comply with federal standards for use as identity credentials such as Federal Information Processing Standard 201 (FIPS-201), described in National Institute of Standards and Technology (NIST), FIPS 201: Personal Identity Verification (PIV) of Federal Employees and Contractors, which is hereby incorporated by reference. (FIPS-201 is an evolving standard. A current version is http://csrc.nist.gov/publications/fips/fips201-1/FIPS-201-1-chng1.pdf)

A hardware security module (HSM) is a device for generating and storing long term secrets for use in cryptography, and for physically protecting the access to and use of those secrets over time. Such secrets may include private keys for use in a public key encryption algorithm. For maximum secrecy, a secret generated using the hardware security module is never transferred from the module to other hardware or software. An HSM provides cryptographic services to a user of the smartcard, such services including creation and secure storage of encryption keys, and implementation of cryptographic algorithms. HSMs are well known in the art, for example as described in NIST, FIPS 140: Security Requirements for Cryptographic Modules (May 2001), hereby incorporated by reference. (FIPS-140 is an evolving standard. A current version of this evolving stand may be found at http://csrc.nist.gov/publications/fips/fips140-2/fips1402.pdf) Smartcards having an HSM are known in the art. Such smartcards typically present a programming interface that allows software, such as a host operating system, to access HSM functions. An illustrative example of a standard specifying such an interface is described in RSA Laboratories, PKCS #11: Cryptographic Token Interface Standard, hereby incorporated by reference. (PKCS #11 is an evolving standard. A version current as of filing is ftp://ftp.rsasecurity.com/pub/pkcs/pkcs-11/v2-20/pkcs-11v2-20.pdf. The standard has been amended three times, with two additional amendments proposed.)

A credential certificate is an electronic credential issued by a trusted authority which incorporates a digital signature to associate the credential data with an individual. By signing a credential certificate, a trusted authority attests that the individual possesses the credential. The trusted authority may revoke a credential certificate by publishing notice of revocation using well-known methods.

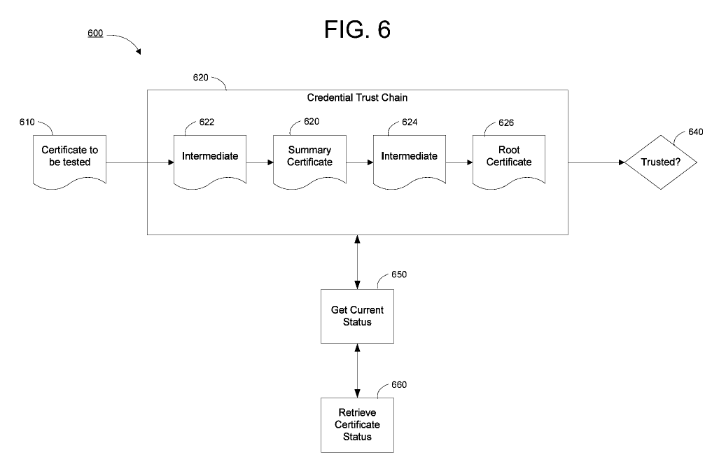

A summary certificate is an electronic credential issued by a trusted authority which incorporates a digital signature to associate a primary credential with one or more secondary credentials upon which the issuance of the primary credential relied. A summary certificate represents indirect trusts, rather than identities. By signing a summary certificate, a trusted authority attests that the secondary credentials were considered in the process of, and relied upon in the issuing of, the primary credential. A method for revoking a summary certificate in accordance with an embodiment of the invention is depicted in FIG. 6 and described below.

A digital resume is an electronic document issued by a trusted authority which incorporates a digital signature to associate an individual with a collection of credential certificates, summary certificates, or both. By signing a digital resume, a trusted authority attests that the collection of certificates is properly associated with the individual.

A trust chain, or chain of trust, is a list of trusted authorities wherein each trusted authority obtains its own identity certificate from the next trusted authority in the list. Such certificates, wherein one authority certifies another, are known as cross-certificates. A chain of trust terminates with a root authority, or trust anchor, which issues an identity certificate for itself that has both the root authority's public key and a self-signature which may be validated using the same key. As the root authority attests to its own identity, it must be a well-known and broadly trusted agency or organization.

An authentication token is a device that an authority gives a user of computer services to aid in authenticating the user to those services. An authentication token is typically small enough to be carried inconspicuously on the user. A common example of an authentication token is a wallet-sized smartcard having a hardware security module that stores data that may also be pertinent to authentication.

A virtual smartcard is a set of data and computer-implemented algorithms, associated with an individual, which simulate an authentication token containing a hardware security module.

A message digest is a fixed-length set of data which encodes other data of any size using a non-reversible hash function. Such hash functions are well known in the art. An example hash function is described in NIST, FIPS 180: Secure Hash Standard, which is hereby incorporated by reference. (FIPS-180 is an evolving standard. A current version is http://csrc.nist.gov/publications/fips/fips180-2/fips180-2withchangenotice.pdf) Since the hash function is non-reversible, a relying party may be confident that two digests are equal only if their inputs are equal. (As digests may be created that are smaller than their inputs, collisions can occur. However, a judicious choice of a hash function can make it difficult for an untrusted third party to construct colliding inputs. A “good” hash function has the property that each bit altered in the message data will result in approximately half of the output bits being altered.)

Wi-Fi Protected Access (WPA) is a communications security protocol described in Institute of Electrical and Electronics Engineers (IEEE), IEEE Standard for Information technology—Telecommunications and information exchange between system—Local and metropolitan area networks—Specific requirements—Part 11: Wireless LAN Medium Access Control (MAC) and Physical Layer (PHY) specifications—Amendment 6: Medium Access Control (MAC) Security Enhancements (“802.11i”), hereby incorporated by reference. (802.11i is an evolving standard. A version current as of the date of filing may be found at http://standards.ieee.org/getieee802/download/802.11i-2004.pdf.)

A PKI standard is a standard governing the implementation of public key infrastructure, established either de facto or by a standards-setting body. At present, the X.509 standard, established by the International Telecommunication Union, and referenced below in this description, governs implementation of public key infrastructure and satisfies this definition.

A federated data store is a collection of two or more data storage devices connected by a communications network, where each data storage device is operated by a different data service provider, and the data service providers act in concert to provide data storage.

An access control system is a set of devices for permitting a person access to a physical space. An access seeker presents a token, such as a smartcard, to the system. An access control system headend, or central controller, responds by validating the individual's credential, and if authorized, sending electrical signals to various physical barrier controls, such as magnetic door locks, causing them to unlock and permit the individual access to the area beyond. A typical example of an access control system is a subway turnstile.

A transaction is an activity, such as physical access to premises or to a region, purchase of a good or service, extension of credit, or performance of a service, with respect to which authentication or authorization (or both authentication and authorization) of an individual is desired.

A credential service is a service by which desired authentication or authorization (or both authentication and authorization) of an individual may be determined for purposes of a transaction.

A smartphone is a cellular telephone providing storage capacity and processing capacity to permit the telephone to handle computational tasks (in particular to run applications) in addition to wireless telephone service and to handle data in addition to cellular telephone data.

A payment token is a number that has certain properties that allow its uniqueness and association with a particular user to be determined mathematically. Creation and use of payment tokens is described in, among many places, U.S. Pat. No. 5,224,162 (Okamoto et al.) and U.S. Pat. No. 6,236,981 (Hill), hereby incorporated by reference.

Write-once, read-many (WORM) storage refers to a computer data storage arrangement, including computer memory, to any portion of which data can be written only a single time (wherein data thus written cannot be altered) and from which data can be read multiple times. Typically, the act of storing data to a WORM device includes physically altering the device irreversibly, so that the data being written cannot be rewritten. An example of WORM storage is a recordable compact disc (CD-R), whose substrate is irreversibly burned by a laser. Another example of WORM storage is a programmable read-only memory (PROM), where a bit of memory is permanently fixed as a zero or one by irreversibly burning an appropriate fuse.

A passcode is a secret character string that may be required as a condition for access to a digital resource (such as data, or a computer network, or a computer facility), as a measure to preclude unauthorized use of the resource.

Embodiments of the present invention provide an end-to-end arrangement permitting the rendering of credential services in a fashion that is scalable, dynamic, and individualized. Various embodiments utilize mobile telephones. In some of these embodiments, the telephones may be implemented using flash memory or other storage arrangements. Although not all embodiments require mobile telephones and not all of the mobile telephone embodiments require flash memory, those embodiments utilizing both offer enhanced functionalities.

### Overview of Core System Components

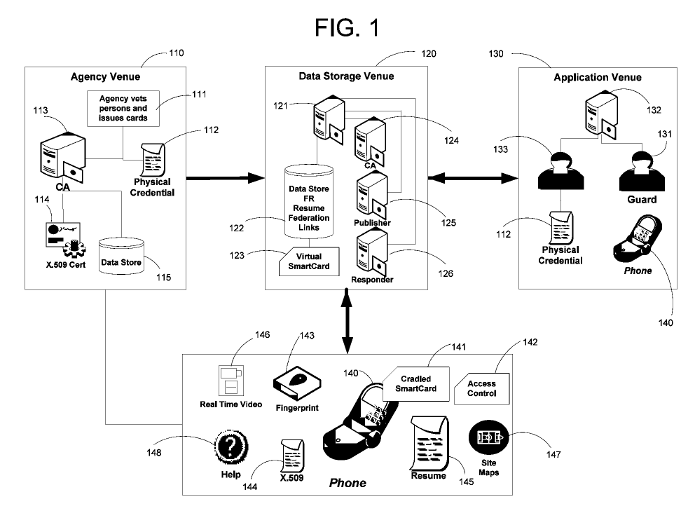

FIG. 1 is a block diagram of major functional components of an embodiment of the invention. Functional components include an agency venue 110, a data storage venue 120, an application venue 130, and an electronic device 140. The illustrated arrangement of these components enables a data service provider to provide credential services to individuals on behalf of one or more agencies. With the components embodied and arranged as described below, the data service provider may scale its operations dynamically to service a large number of agencies, accommodate a large number of individuals, or both. Although we have here used the term “agency” for the credential issuer, we show in further detail below, that the architecture described in this embodiment is applicable to a wide range of credential issuers, including also, banks (with respect to bank accounts, loan accounts, and credit card accounts, among other things), other credit card issuers, enterprises (with respect to physical access to premises and access to computing facilities), health care institutions, educational institutions, etc.

An agency issues credentials to individuals. To service its personnel or the public, the agency establishes an agency venue 110. For example, a state Department of Motor Vehicles (DMV) is an agency that establishes an office where citizens may obtain licenses allowing them to operate motor vehicles on state property. As another example, the Federal Aviation Administration is an agency that issues certificates to individuals allowing them to operate aircraft in the National Airspace System. This list is illustrative only, and it is to be understood that an agency may be any organization, public or private, that issues credentials to individuals. Also, an agency may establish multiple agency venues.

Typically, an agency will undergo a process 111 of vetting an individual, then issuing the individual a physical credential 112. The vetting process may vary from one agency to the next. By way of illustration, a DMV may require a person to identify herself by presenting other credentials such as a passport, birth certificate, or foreign driver's license to an agent at an agency venue 110. In addition to the identification credentials, the DMV may require the person to pass a series of tests, such as a vision test, a knowledge test, and a skills test, in order to satisfy the agency that she meets statutory requirements for operating a motor vehicle.

Once vetting is complete, the agency issues the individual a physical credential 112, certifying that she has met the requirements for its issuance. Physical credential 112 may be, without limitation, a driver's license, a Transportation Worker Identification Credential (TWIC), or a FIPS-201 compliant smartcard. Physical credential 112 may also be a smartcard containing a hardware security module (HSM), in accordance with embodiments of the invention. In addition to (or in lieu of) issuing a physical credential 112, an agency venue 110 may issue an electronic credential in accordance with an embodiment of the invention. To do so, the agency may participate in a public key infrastructure (PKI). The agency may establish a Certificate Authority (CA) 113, such as that described in X.509, or the agency may contract with a third party CA. The CA issues an identity certificate 114 to the agency according to procedures well known in the art, such as may be found in X.509.

The agency creates a credential certificate by using identity certificate 114 to sign a credential using a digital signature algorithm. The presence of the agency's digital signature allows a party in possession of the credential to verify that its contents have not changed between the time of signing and the time of verification. A credential certificate may have substantially the same information as physical credential 112, or it may contain additional or different data which better lends itself to digital manipulation. An agency may store a credential certificate in a data store 115 for its own records and for sharing with others.

Agency venue 110 may share its electronic credentials with a data service provider, which operates at least one data storage venue 120 according to an embodiment of the invention. A data service provider offers first responder agencies and other organizations with a data service for authenticating individuals. There can be many data service providers, and an agency may choose a data service provider based on its needs. Different data service providers may establish trust with one another, cooperating to form a network of highly-available, federated data storage and services using methods which should be apparent to those skilled in the art.

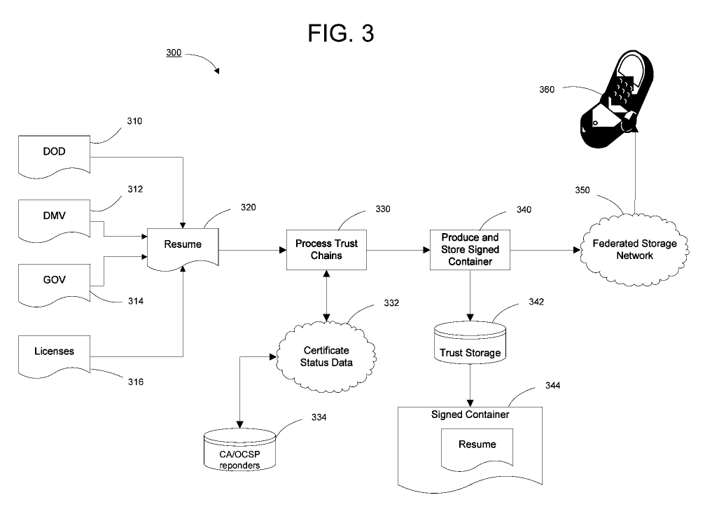

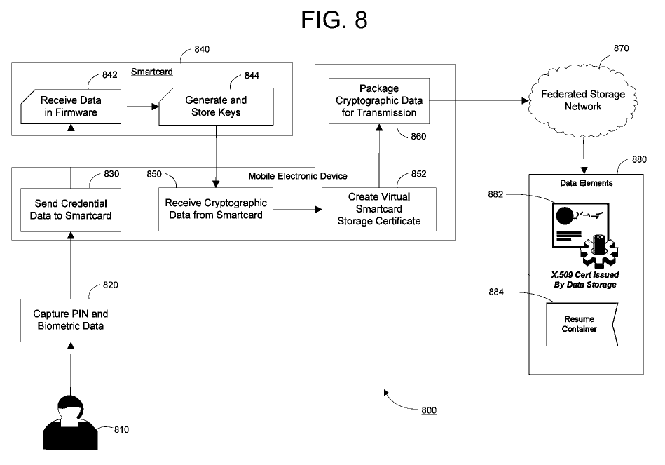

At any given data storage venue 120, a data storage engine 121 receives electronic credentials from agency venue 110, and place them in a data store 122. The data service provider collects and maintains these credentials according to methods depicted in FIG. 3 through FIG. 7, and described in detail below. Data storage engine 121 may create a virtual smartcard 123 associated with the credentialed individual, using a method depicted in FIG. 8 and described in detail below. In order to create the virtual smart card, data storage engine 121 utilizes a CA 124. The storage provider that operates the data storage venue 120 may establish its own CA, or contract with a trusted third party for this purpose. Data storage venue 120 may publish credential certificates to an application venue 130 using a publisher 125, which may be a web server or other network service provider. Data storage venue 120 responds to certificate verification requests using an OCSP responder 126, which also may be a web server or other network service provider.

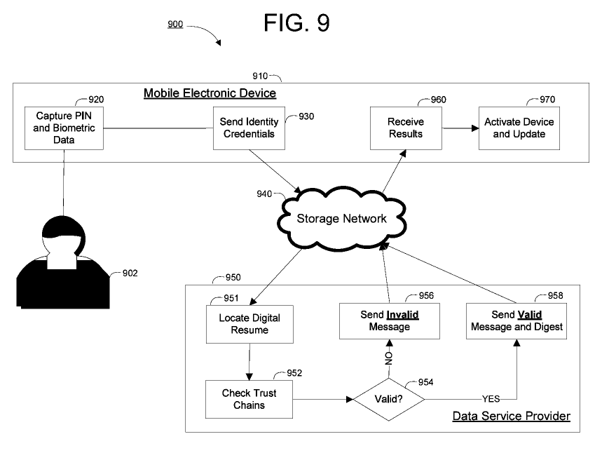

An application venue 130 is a site at which an individual must be certificated. Such sites include, by illustration and without limitation, a disaster area, a facility processing classified information, and a roadside car stopped by a law enforcement officer. Taking as example a disaster area, the venue may have on-site emergency management personnel, such as a guard 131. Guard 131 determines that certain software applications are required to deal with the emergency and that first responders must have certain privileges required to access the software. Guard 131 enters this information into management software in a command-and-control system 132. When a first responder 133 arrives, he presents at least one physical credential 112, which he earlier obtained from an agency venue 110, as well as additional information such as a password or personal identification number (PIN). Using the process depicted in FIG. 9 and described below, software on command-and-control system 132 verifies his credentials, and registers a mobile electronic device 140. Management personnel download software applications for first responder 133 onto mobile electronic device 140. The applications are chosen based upon the physical credential 112 presented by first responder 133. The first responder 133 may then use the applications on mobile electronic device 140 to respond to an incident.

Mobile electronic device 140 may be used, among other things, to provide first responders with application-specific software and data that they can use to deal with emergencies. More generally, as we describe in further detail below, the mobile electronic device may be used to authenticate a wide range of transactions, including physical access to a region or to premises, access to computational facilities, financial transactions, including the purchase of goods or services, the extension of credit, licensing of individuals in various contexts, including performance of health care services, operation of a motor vehicle, etc. The mobile electronic device 140 may be, among other things, a personal digital assistant (PDA), a cellular telephone, or a laptop computer.

In accordance with embodiments of the present invention, a person will be permitted to expose and use credentials on the device 140 for transactions only after the person has authenticated himself to the device 140. In authenticating himself to the device 140, the user may be required to provide multiple forms of identification (multi-factor authentication), including at least one physical credential 112. In one embodiment, the user provide the physical credential by swiping a finger on a fingerprint reader 143, which may be implemented in the device 140 (or which may be external to it), wherein the physical credential 112 is implemented as a biometric identifier. In addition, the user may also have to provide a personal identification number (PIN) to the device 140. In another embodiment, physical credential 112 is implemented with a smartcard 141, which is cradled in a receiver designed for that purpose. In this context, the smartcard 141 serves as a token. Smartcard 141 may be issued by a credentialing agency or another organization. In another embodiment, a user does not have a smartcard. Instead, physical credential 112 is, for example, a driver's license or a credit card (which are also tokens). Such physical credentials are challenged by scanning a 2-dimensional barcode or reading a magnetic stripe on the credential, rather than using cryptography. In these embodiments, the challenge response may be verified by comparing it to trusted external data provided by an issuing agency. Because the device 140 may itself serve as a token (because it embeds one or more credentials), requiring a biometric for the user to authenticate himself to the credential has the benefit of requiring a separate type of factor in the authentication process. Mobile electronic device 140 may have a hardware security module to facilitate the user authentication process. Authentication software may require that mobile electronic device 140 be docked or cradled to another device (not shown) that is connected to a keypad, keyboard, biometric device 143, or other data entry arrangement such as a barcode scanner or magnetic stripe reader, in order to securely verify identity challenges using the phone's own HSM.

Mobile electronic device 140 contains an identity certificate 144 for use in secure communications with another mobile electronic device 140, application venue 130, or data storage venue 120. Using digital certificate 144, the device can download from a data storage venue 120 a digital resume 145 containing additional credentials. A phone implementing device 140 may also have photo and video capture software 146, building blueprints or site maps 147, terrain data from a geographical information system (GIS), software for accessing a criminal records database or a security clearance database, a materials safety data sheet (MSDS), resource and incident management software, status reporting software, help functions 148 for any or all of these things, or other useful or necessary applications and data.

A mobile electronic device 140 has several functional components. Such a device includes a secure storage module which may store a digital resume containing a set of credentials and authentication data. An example of a storage module is a flash memory, or other non-volatile memory device such as a hard disk drive. Mobile electronic device 140 has a data entry arrangement, as described above, for entering authentication data. Device 140 has a controller, coupled to the storage module and the data entry arrangement. The controller may be a microprocessor or other computing means that can be programmed to require a user to enter into the device the stored authentication data before granting the user access to a stored digital resume. Device 140 also includes a communication port for receiving and transmitting data to other devices. A communication port may be a wire port, such as a socket for a networking cable plug, or it may be a wireless transceiver. Those skilled in the art will recognize that a mobile electronic device may be implemented using other types of hardware devices, suitably arranged and functionally connected.

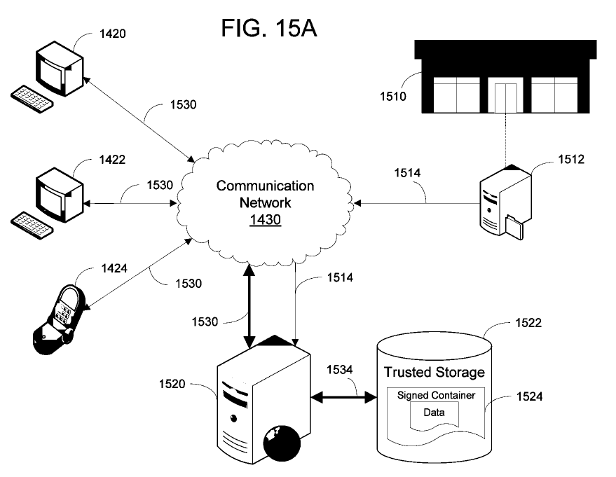

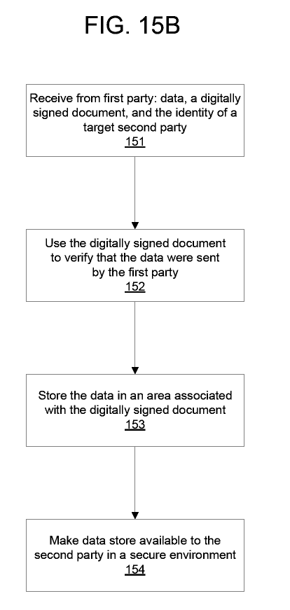

It should also be appreciated by those skilled in the art that the foregoing features of a mobile electronic device embodiment, such as encryption, data storage, communication by wired or wireless data network, and so on may be implemented by a number of other types of electronic device that lay within the scope of the invention. Such other devices may include desktop computers, server computers, mainframe computers, pagers, or any other electronic device with the appropriate functional components. For an example embodiment making use of a desktop computer, see FIG. 15A and the discussion thereof. These other embodiments may be used in addition to, or instead of, a mobile electronic device. Such use may occur, as an example, if a battery charger for a mobile electronic device cannot be found, or if an adequate power source for recharging the device cannot be found. In such a case, a desktop computer may be used, for example, to perform the security or encryption functions of a mobile electronic device.

A mobile electronic device 140, such as a smartphone, has four key properties that render it particularly suitable for use in embodiments of the invention described herein: computing facilities, secure storage, updatability, and an association with a unique user. Each device 140, as described above, contains computing facilities (e.g., a microprocessor). These facilities allow the device 140 to participate in encrypted transactions without the need to consult another device. Each device 140 also contains secure storage, which ensures that credential data stored on the device cannot be altered, either accidentally or deliberately. Each device 140 has the ability to update credentials stored on it, which enables the device to add or remove an individual's authorization to perform given tasks using the device on a near-real time basis. And each device 140 is associated with a unique user, allowing that user to use the device as a token for authentication.

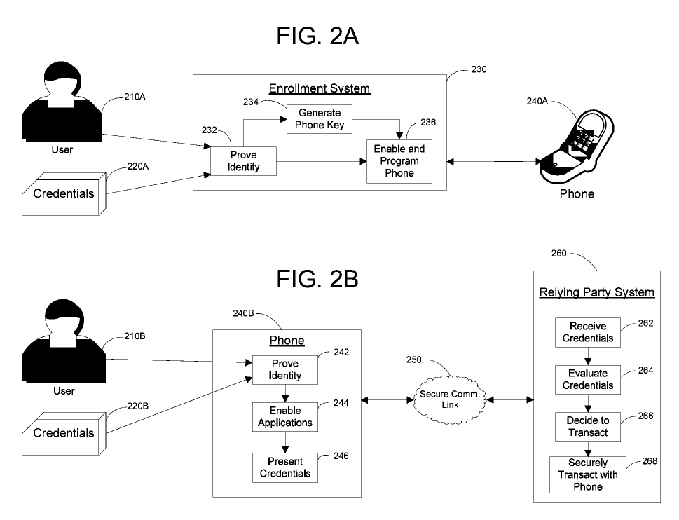

FIG. 2A is a block diagram of a process by which a person may activate a mobile electronic device in accordance with embodiments of the invention. Illustrative embodiments employ a smartphone, but it should be understood to those skilled in the art that other electronic devices may be used, such as personal digital assistants (PDAs), laptops, and other computing devices. FIG. 2A and FIG. 2B depict the initialization and use of a phone 240 in accordance with embodiments (represented in the Figures as 240A and 240B for clarity of description). A user 210 (210A and 210B in the Figures) obtains an activated phone 240 that contains secure applications and data. These applications and data may be used by user 210, for example, to respond to an emergency. Applications and data may also be used by a third party system 260 in order to securely transact with user 210.

User 210 begins the activation process (for initially setting up the smartphone for use by the user) in FIG. 2A by presenting herself for identification at a security office, human resources office, or a similar processing location. A security officer (not shown) at the location accesses enrollment system 230, a computing system that includes software that performs cryptographic functions and phone initialization functions. User 210 presents credentials 220A to the security officer, who enters relevant data from the credentials into enrollment system 230. Enrollment system 230 then verifies the user's identity in process 232, described more fully below. Once the identity of user 210 has been proved, enrollment system 230 may take one of two paths to enable a phone, depending on the kind of credentials 220A presented. First, if credentials 220A include a smartcard having an HSM containing a private key, the system directly enables and programs phone 240A in process 236. But, if credentials 220A do not include a smartcard having an HSM containing a private key, enrollment system 230 creates a private key for storage on the phone 240A in process 234 first, then enables and programs the phone in process 236. The private key stored on phone 240A or on a smartcard, and the presented credentials, can later be used to prove the identity of user 210A at a later time, as depicted in FIG. 2B.

Process 232 for proving a person's identity may be accomplished in two ways, again depending on the number and types of credentials 220A presented. The process ensures multi-factor authentication with at least two factors. If credentials 220A include a smartcard with an HSM (for example, a FIPS-201 identification card) then the card is read and its contents validated by an activation challenge such as a fingerprint or a PIN. Once this occurs, user 210A has produced a physical token and a challenge response which satisfy two-factor authentication requirements. On the other hand, if credentials 220A do not include a smartcard, a security officer may determine that several credentials are required to establish the identity of user 210A. The officer enters information from these credentials into the enrollment system 230. The officer may challenge user 210A for a PIN or a biometric, such as a fingerprint, to guarantee multi-factor authentication. Credential data may be entered manually or through the use of technology such as a barcode scanner, fingerprint scanner, or other similar device.

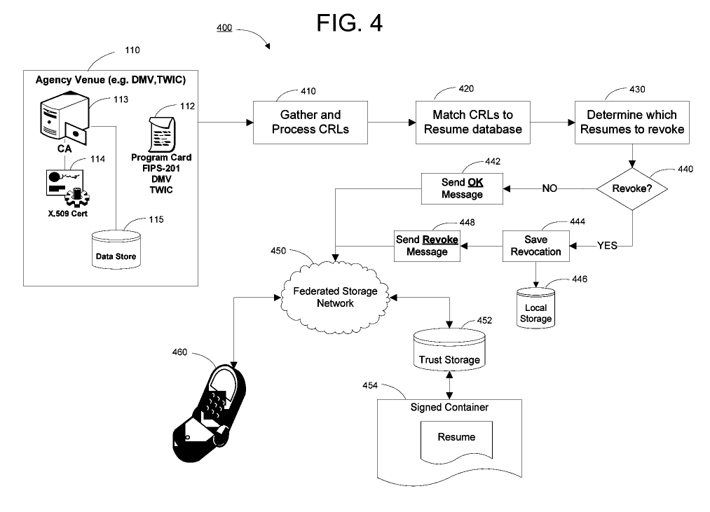

Once credential data has been entered into enrollment system 230, regardless whether it derives from smartcards, other identity documents, or a challenge response, the credentials themselves are tested for validity in accordance with embodiments of the invention, using the process depicted in FIG. 4. If one or more credentials are invalid, the security officer may require user 210A to present alternate credentials, or take other remedial actions as appropriate. Credentials can be validated when a secure communications link can be established between the enrollment system 230 and a data service venue, such as that depicted in FIG. 1, that contains up-to-date credential validity data.

Process 236 for enabling and programming a phone also entails several processes. Once a user has adequately identified herself to enrollment system 230 using credentials on hand, the system obtains additional credentials in the form of a digital resume using the processes depicted in FIG. 3 and FIG. 9 and described more fully below. Alternatively or in addition, user 210A may wish to create a virtual backup of her physical credentials, in case the latter are lost or misplaced. User 210A can create a virtual smartcard that represents data stored on a physical credential, in accordance with embodiments of the invention, as depicted in FIG. 8 and described more fully below. At the same time, the enrollment system 230 creates a virtual smartcard for phone 240A using a private key stored in the phone's own HSM by the same process. Then, if a user loses a first phone 240A, another phone in accordance with embodiments may be given to the user, and data encrypted using the first phone's private key may still be accessed using the old phone's virtual smartcard.

Process 236 may also create an authentication digest for storage on phone 240A using credential data. The digest can be used later in process 242 to show that user 210A is the same as user 210B, that credentials 220A are the same as credentials 220B, and that phone 240A is the same as phone 240B. Equality may be shown by recomputing the digest using the same hash function on the phone, and comparing it to that stored on the phone or at a trusted back-up data storage venue. If the two digests are equal, all inputs almost certainly match. If they differ, then the current inputs must differ from the inputs used to compute the first digest, and further security procedures may be invoked.

In addition to storing an authentication digest on the phone 240A and software necessary to calculate the hash function, process 236 may upload sensitive or classified software applications, data, or both to the phone. These applications and data may be used by user 210 according to conditions programmed by the enrollment system 230. For example, some or all of these applications and data may not be accessible unless a person authenticates herself to the phone, as in FIG. 2B. Or, applications may only be accessible within a certain physical area. In which case, process 236 installs software on phone 240A that can lock and unlock other applications in response to certain messages received by the phone from a trusted access control system. The design of such software should be apparent to one having skill in the art. Also or alternatively, process 236 may install software that interfaces with third-party systems, such as credit card processing systems. Other types of software which might be installed on a phone, and the methods for doing so, should be apparent to those skilled in the art.

FIG. 2B is a block diagram of a process by which a person may use a mobile electronic device in accordance with embodiments of the invention. The process does not assume that user 210B is the same as user 210A. For example, the phone may have been lost by legitimate user 210A and found by malicious user 210B. The process does not assume that credentials 220B are the same as credentials 220A. For example, the user may have forgotten or misplaced credentials 220A, and may attempt to use different (or even false) credentials 220B to authenticate herself so that she may use the phone. The process does not assume that phone 240A is the same as phone 240B. For example, a user may have attempted to copy data from one phone to another, to make a backup, or for malicious purposes. At the conclusion of the process depicted in FIG. 2A, phone 240A has been enabled and programmed with applications and data, and given to user 210A. Further, phone 240A contains an authentication digest which allows user 210A to identify himself to the phone. Now, user 210A may use phone 240A to engage in a wide range of transactions, with respect to which security is provided by the use of credentials in the manner we describe herein.

To authenticate a phone in the field, a user docks the phone to a service station and answers various challenges to reproduce the digest. It will be understood that a user may communicate with a service station in a variety of methods, including by local wired or wireless methods. Communication with a central data store or a data service provider is not necessary. Such a system is advantageous, for example, at an airport security checkpoint. In this example, a security worker may securely verify a person's identity and validate the data stored on a phone simultaneously, based only on a person's non-electronic physical credential, while the person waits in line, without needing to contact the agency that issued the credential.

The process for using the phone begins with the phone 240B in a locked state. To protect sensitive or classified applications and data stored on phone 240B, the phone must enter a locked state after a period of inactivity or after a triggering event, such as deactivation by user 210B. Thus, user 210B must first re-prove her identity in order to unlock the phone, in process 242. Process 242 is similar to process 232: user 210B presents credentials 220B to the phone to authenticate the user. Such authentication may take the form, for example, of entering a personal identification code (PIN) and swiping a finger for a fingerprint. After receiving these credentials, the phone 240B processes these credentials to authenticate the user. In one embodiment, the phone calculates a digest of the credentials using software on the phone, and compares the calculated digest to the previously stored digest. If the two digests match, then the software concludes that the user 210B, the credentials 220B, and the phone 240B are the same as user 210A, credentials 220A, and phone 240A respectively (referred hereinafter without suffix). If the two digests differ, the phone software for authenticating a user may request that the credential data be input again, lock the phone against further attempts to authenticate, or take other appropriate action.

If the digests match, the authentication of the user to the phone has succeeded, permitting the phone to be used downstream in authenticating a transaction. Before the phone is used for transaction authentication, a number of additional processes are typically employed in embodiments of the present invention. In one embodiment, the phone may check stored credentials to verify their consistency. In this embodiment, the phone encrypts a random number with a public key of the user; it then decrypts with result with a stored private key of the user functioning as a credential of the user; if the results match, then the phone has verified the consistency of the public key and the store private key in the credential. After this verification, the phone software determines which applications to enable in process 244. Next, there may be processing on the basis of data external to the phone to determine whether credentials presented in the phone are still valid, in accordance processes depicted in FIG. 4 and batch processes described later. If the credentials are not all valid, phone 240 may indicate to user 210 that, while his credentials are recognized, they must be renewed before access to certain applications and data is granted. If the credentials are all valid, or if the software determines that not all credentials must be current, access to secure applications and data may be enabled in accordance with the limitations and conditions programmed into the phone by enrollment system 230. At this point, user 210 can expose the user's credentials for use in a wide range of transactions, such as access to premises or computing facilities or financial transactions involving purchases or the extension of credit or both.

Accordingly user 210 may use a phone 240 in accordance with embodiments of the invention to securely identify herself to a relying party and engage in various secure transactions. Such transactions arise, for example, in a marketplace, where a merchant wishes to identify an individual and charge a purchase to that individual's credit. Or, an organization may wish to identify an individual for the purpose of granting that individual access to areas within a campus or building that require special permission to enter. Other, similar secure transactions may be readily envisioned by a person skilled in the art.

A secure transaction begins with process 246, where phone 240 presents the credentials of user 210 to a relying party system 260. The communication of credentials may occur using a secure communications link 250, which may be, without limitation, a wireless communications network or a physical, wired connection between phone 240 and relying party system 260. Communications security may be provided, for example, by the use of WPA or another communications security protocol.

Once the phone has presented the credentials of user 210, relying party system 260 receives them in process 262. Next, relying party system 260 evaluates the credentials in process 264. This process may be manual, for example displaying the credentials to a human guard or merchant on a computer display for approval or disapproval. Process 264 may include automated processes, such as verifying that the credentials are still valid, as in FIG. 4. A merchant may wish to perform this check because it is possible that, at the time user 210 authenticated herself in process 242, the latter process was unable to verify the credentials in accordance with FIG. 4, yet still determined that the phone 240 should be unlocked. Also, the merchant may have a hard-wired connection to a data service provider required by FIG. 4, while phone 240 may have only a less reliable, wireless connection.

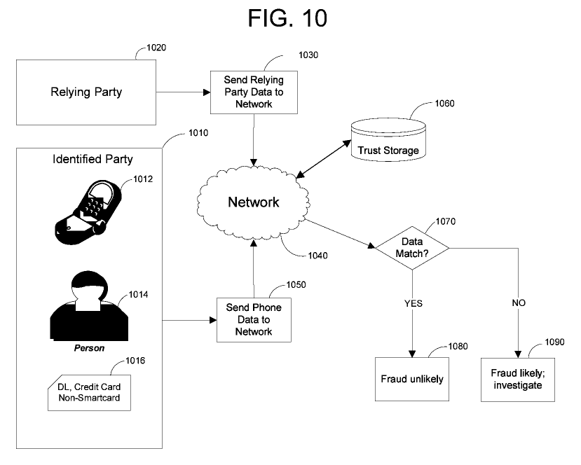

Next, the relying party decides whether or not to transact with user 210 in process 266. For example, a merchant or a security officer may decide that the credentials presented for evaluation in process 264 are not sufficient to adequately determine the identity of user 210. Or, a merchant may use the credentials to fetch a credit score for user 210 that the merchant determines is insufficient to complete the transaction. Or, a security officer may use the credentials to fetch permissions for user 210 that the officer determines are insufficient to grant the user physical access to a secured area. If, however, the decision is positive, relying party system 260 securely transacts with phone 240 using secure communications link 250 in process 268. Various embodiments of secure transactions are depicted in FIG. 10 through FIG. 13 and described below.

As a preliminary example use of a phone credential, an individual may store her driver's license, auto registration, and insurance information in credentials on the phone, and expose them to a police officer during a traffic stop. On the other hand, she may not wish to expose them for some reason. In such cases, a phone may be programmed to allow the police officer, or someone else with sufficient credentials, to retrieve certain of the individual's credentials in any event. In other words, the phone may have various overrides that allow certain others to access specific credentials in case of an emergency. A police officer may be able to engage an override, but still only get access to the individual's license and registration. A medical technician could engage an override, but only get access to the individual's drug prescriptions, or other necessary medical data. Furthermore, the override transaction can be logged by the phone for later auditing or evidentiary purposes, to determine that the override was proper. Thus, the phone can be viewed as a device that allows first responders to get access to important data, while preserving the privacy of those who may be involved in an emergency.

### Digital Resumes

A digital resume is a collection of credentials which may be stored on a phone in accordance with various embodiments. These credentials may be used to authenticate a user during process 236 or 242, or for presenting to a relying party 260 to initiate a secured transaction.

FIG. 3 is a block diagram of a process by which a digital resume is created, authenticated, and stored, in accordance with an embodiment of the invention. The process begins with credentialing agencies. Such agencies include, without limitation, the Department of Defense 310, a state Department of Motor Vehicles 312, other agencies of a state or the federal government 314, and an independent licensing authority 316. These credentialing agencies issue credential certificates to an individual, as described above in connection with FIG. 1. A data service provider accumulates these credential certificates at a data storage venue 120 to form a digital resume 320 for the individual. As more agencies issue certificates, they are added to the digital resume 320.

In process 330, the data service provider processes each credential's trust chains using its digital signature, in accordance with the digital signature algorithm specified by the credentialing agency. For example, if the Department of Defense uses the DSA to sign a credential, the data service provider will authenticate the credential using the signature authentication algorithm specified by the DSS. Furthermore, the data service provider also communicates with the issuing CA 334 to determine whether a credential has been revoked. This check is performed using methods well known in the art. For example, the CA 334 may publish a Certificate Revocation List (CRL), as described in X.509, which lists certificates that the CA has decided to revoke. Alternatively or in addition, the CA 334 may participate in OCSP. Or, the CA may designate a responder to reply to authentication requests. The data service provider uses these CRLs and OCSP responses 332 as input to standard algorithms in process 330 for processing the trust chains. The details of processing the trust chains are described more fully below.

Once the trust chain of each credential in a digital resume 320 has been processed in process 330, the data service provider digitally signs and stores in process 340 the digital resume. The data service provider utilizes a CA for the purpose of generating a digital certificate to use in signing resumes. The data service provider's signature on the resume allows a party in possession of the resume to verify that its contents have not changed between the time of signing and the time of verification. This signature thus encourages trust between a party and a data service provider that the contents of the resume (that is, agency-issued credentials) are authentic. Such parties may include emergency management personnel at an application venue, or authentication software in a mobile electronic device 360 used to unlock sensitive application software.

A data service provider places the digital resume and digital signature in a container 344, and place the container into trusted storage 342. The trusted storage 342 may be located at the data storage venue where the resume was digitally signed, or it may be located in federated storage at another data storage venue. Alternatively or in addition, the data service provider transmits the signed resume to a federated storage network 350. A mobile electronic device 360 may then download the signed resume from the federated storage network 350 for use in registering and enabling the device, as described more fully below. Also, a data service provider may generate an index of credentials, matching to each credential a list of digital resumes containing that credential.

In addition to issuing credential certificates, agencies will have occasion from time to time to revoke certificates. Several types of credentials routinely expire after a fixed period of time. A familiar example of a regularly-expiring credential is a driver's license. An agency may also revoke credentials irregularly, due to the discovery of fault within the agency itself. For example, a DMV may revoke a driver's license because it discovers that the clerk who issued the license did so fraudulently, or because the clerk fraudulently obtained employment at the agency. In one embodiment, an agency generates and publishes from an agency venue a Certificate Revocation List (CRL) under well-known PKI algorithms, in order to notify those relying on its credential certificates that some of those certificates should not be honored. In accordance with another embodiment, the agency venue participates in OCSP, described above, or use another protocol for notifying third parties that a certificate has been revoked.

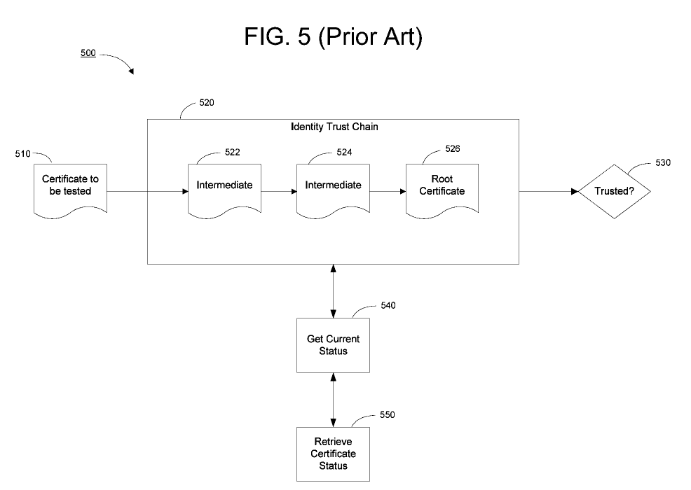

FIG. 4 is a block diagram of a process by which digital resumes are updated to account for revoked credentials, in accordance with an embodiment of the invention. A data service provider begins the revocation process 400 by gathering and processing CRLs in process 410 from each of several agency venues. The data service provider may perform this task on a preset schedule, typically once per day. The process for gathering a CRL from an agency venue is well known in the art of PKI. For each list gathered, the data service provider then can search through an index of credentials in process 420 to identify which digital resumes contain those certificates which are revoked. If a resume is identified, its trust chains are processed according to the processes depicted in FIG. 5 through FIG. 7, more fully described below, and represented as process 430. The processing results in a yes-or-no decision in process 440 whether to revoke the resume or any particular credential certificate within the resume. The use of revocation lists encourages trust between an agency and a data service provider that credentials stored by the provider are still valid and should be honored.

Once a data service provider has processed each resume, it may update any party which relies on having timely and accurate resumes. Depending on the outcome of process 440, a data service provider in process 442 may send the party a confirmation notice if no updates occurred. Alternatively, if the outcome of process 440 triggers a revocation, then in process 444 a data service provider stores, in storage 446, a revocation for auditing and efficient processing of later revocations, and in process 448 a revocation message is sent. The storage 446 may be on-site local storage. Alternatively in lieu of local storage, or in addition to it, there may be employed remote trusted storage identified as item 452, accessible via federated storage network 450. In the case where only a part of the resume was revoked, the provider first creates a new resume not containing the revoked credential and places it in signed container 454. The data service provider sends the container to a trusted storage 452 located at a data storage venue under its control, or under the control of another trusted data service provider in federated storage network 450. The newly signed and updated resume is then sent to a mobile electronic device 460, such as a cellular telephone. Special-purpose software on the phone can replace a stored resume with an updated resume, or remove a revoked resume. Frequent and reliable re-signing of resumes encourages trust between a data service provider and a party relying on credentials contained in a resume that those credentials are still valid and should be honored.

### Summary Certificates

A summary certificate is an electronic document issued by a trusted authority which incorporates a digital signature to associate a primary credential with one or more secondary credentials upon which the issuance of the primary credential relied. A summary certificate captures relationships between credentials, in an analogous manner to the way prior art PKI trust chains capture relationships between identities.

Consider, by way of illustration, a driver's license. Typically, a DMV will issue a driver's license to an individual only after the individual has presented an agent with several forms of identification. An agency may first verify that the credentials were properly issued, and then weigh their information to make a decision whether to issue a license. If the identification documents are digital, the agency may use a prior art PKI to verify credentials. The information used when deciding whether to issue, however, may be captured using an extended PKI in accordance with embodiments of this invention.

Perhaps an individual presents a social security card, a birth certificate, and a recent utility bill. These documents represent partial proofs of identity, citizenship, and residency respectively. The agency weighs the information contained in these certificates based upon the authority of the agencies issuing them the Social Security Administration, a hospital, and a utility company. The agency may rely on the accuracy of these documents, or a subset of them, in whole or in part, when making its decision to issue the driver's license. The agency may also rely on various tests, such as an optometric examination, a written knowledge test, or a skills test. These tests may be conducted by a third party or by the agency itself. The agency may rely on doctors or agents to properly conduct these tests, and to certify that the individual has met the legal requirements for passage. An agency may choose to so rely if the doctors and agents are properly credentialed. A summary certificate, such as might be associated with an issued driver's license, is used to explicitly capture all of these indirect trusts upon which an agency formerly relied implicitly.

By capturing these indirect trusts, a summary certificate enables explicit, later re-evaluation of the basis for an agency's decision to grant an individual a credential. In the prior art PKI context, a revocation of authority of any certificate in a chain of trust causes explicit revocation of all the certificates which rely on that certificate. Extending PKI by the concept of summary certificates having multiple secondary credentials permits finer analysis than in prior art systems, potentially enabling elimination of the requirement that a single failed secondary credential would invalidate the rest of a chain of trust.

A summary certificate enables finer analysis of credentialing decisions by applying revocation policies to a group of secondary certificates. A credentialing agency may issue these policies at the same time it issues a credential certificate, or it may have already issued such policies with a prior certificate. An example policy may specify that a primary credential (e.g. a passport) will not issue unless an applicant presents one secondary credential from list A, or one secondary credential from list B and one from list C. However, an applicant may present multiple credentials from list A, each of which is sufficient to support issuing a primary credential. Alternately, an agency may revoke a secondary credential because it was due to expire, or because an individual obtained it through fraud. A summary certificate enables a later authority to distinguish among these cases. Like any certificate in prior art PKI, a summary certificate may contain an expiration date, which an agency may compare to the certificate's date of revocation. If the dates are identical, the primary issuing authority need not suspect foul play, while if they differ, further research may be warranted.

Returning to the driver's license example, an individual seeking a license may present both a birth certificate and a passport as proof of citizenship. A DMV may rely on either document to establish this proof, but may not be legally required to rely on both. Still, both credentials are incorporated into a summary certificate. Later, if either credential turns out to be fraudulent or is revoked, the revocation policy may specify that the other secondary credential is still sufficient to support the original decision to issue a license. In such a case, the agency need not revoke the license. A similar result obtains if the agency discovers that the agent who issued the license obtained his employment through fraud. A summary certificate and associated policies can capture whether this discovery should require revoking the license.

Suppose now that the DMV merely suspects that an individual obtained a license by presenting a fraudulent birth certificate, and seeks to verify the accuracy of the certificate. The doctor who issued the certificate may have died or become mentally incompetent. In such a case, the DMV may be unable to consult the doctor who issued the certificate. Further, the hospital that issued the birth certificate may have closed, and their records lost or their whereabouts unknown. However, facts such as time and place of birth do not change, despite an inability by the individual who initially recorded them to verify the accuracy of the recording at a later time. The DMV may be satisfied if the issuing doctor was properly credentialed at the time she issued the certificate.

A summary certificate according to an embodiment can enable the DMV to investigate further, as it captures all of the data on which the decision to credential was made. In this case, the summary certificate will contain the issuing doctor's medical credentials in a nested summary certificate, signed by the credentialing agency. The doctor's medical credentials may contain, for example, a transcript from a medical school, the results of a board certification examination, or other credentials. The DMV may verify each of these credentials recursively, for example by verifying the medical school transcript credential, and proceeding to the others. If these secondary credentials are correct, then no doubt has been cast upon the basis for the original issuing decision, and the DMV may rely justifiably upon the conclusion that the doctor was properly credentialed at the time she issued the certificate. Then by implication, the birth certificate was properly issued, and the DMV should not revoke the individual's driver's license.

However, the DMV need not suffer through this verification process, as summary certificates in accordance with embodiments of this invention may be revoked recursively, as in traditional PKI. This functionality enables a data service provider to cascade revocations in novel ways. Suppose an individual goes to a hospital and obtains a birth certificate from a doctor falsely claiming to have graduated from a certain medical school. This birth certificate may, for example, falsely indicate that the individual is of a certain age, when in fact he is not. Suppose that the individual uses that birth certificate to obtain a driver's license in one state, then takes that license to a second state and exchanges it for a driver's license in the second state. The second state's DMV may not be aware if the first state's DMV eventually revokes the license upon which the second state's DMV relied. Further compounding the fraud, the individual may use the second driver's license to obtain a passport, weapons permit, security clearance, or other follow-on credential. The use of summary certificates may alleviate these problems, by recursive revocation. Thus, for example, if the original ‘doctor’ claims graduation from a medical school that subsequently repudiates that claim, a data service provider may, automatically and without contacting any outside agency:

(a) apply a medical board's revocation policy to revoke the doctor's primary medical credential;

(b) apply the hospital's employee-hiring revocation policy to invalidate the birth certificate issued by the doctor;

(c) apply a first state DMV's revocation policy to invalidate the first driver's license obtained using the birth certificate;

(d) apply a second state DMV's revocation policy to invalidate the second driver's license obtained using the first driver's license; and

(e) apply the State Department's revocation policy to invalidate the passport obtained using the second driver's license.

A data service provider may apply any, all, or none of these policies as warranted.

A data storage engine in accordance with embodiments of the invention may advantageously process these revocations in near real-time, or on a regular basis. Further, the engine may notify each of the authorities in the chain that the policies in place call for revoking the respective certificates. This notification saves each authority from performing this check itself, and may indicate to an authority that it may wish to verify its own records independently. On the other hand, each revocation is based on application of policy rules (which may be implemented in computerized processes) to the pertinent secondary credentials in a summary certificate associated with the relevant primary credential. The use of summary certificates in this fashion is conducive to computerized application of policy rules that, under appropriate conditions, may permit a cascade of revocations. In each layer of the cascade, therefore, a primary credential is evaluated analogously in relation to the secondary credentials in view of applicable policy rules. Indeed, a primary credential in one layer may become a secondary credential in the next layer.

FIG. 5 is a block diagram overview of a prior art, computer-implemented process which verifies the identity of a certificate issuer using a public key infrastructure. The test may be required, for example, in order to grant a credential holder access to restricted or sensitive functionality, or to verify that the public key information in the certificate belongs to the person named therein. The process 500 operates on a certificate 510, which has the digital signature of a trusted authority that attests to the authenticity of its information. For a credential certificate, this authority is likely the authority that issued the credential. However, a third party seeking access to a phone's sensitive functions may have signed credential certificate 510 using a fraudulent identity certificate. Thus, a party may wish to validate the chain of trust 520 to guarantee that each digital signature was issued by an authorized party.

The process begins with verifying the signing authority's identity certificate 522. Identity certificate 522, however, was digitally signed by a different trusted authority the authority that issued identity certificate 522. For the same reasons just discussed, the identity certificate 524 used to create this identity certificate 522 may not be trusted, and further verification sought. A computer implementing the process ‘walks’ trust chain 520 until it reaches a root certificate 526 that is “self-signed.” Identity certificate 526 has a digital signature that may be validated using the public key stored in the same identity certificate 526. By walking and validating a chain of trust 520, one may verify that the information in certificate 510 was issued by an authorized agency, and reach a decision 530 whether it should be trusted. For each certificate in the chain, it is necessary to use process 540 to initiate a request for current status of the certificate so as to cause retrieval in process 550 of certificate status. This information is used in validation of the chain. A failure in trust chain 520 will cause a submitted certificate 510 to fail the test.

There are currently several different methods to verify certificates. For example, each intermediate identity certificate may be revoked using a CRL published by the trusted authority which issued the certificate. The root certificate may be revoked using a CRL issued by the root authority, as it self-signed the certificate. Alternately or in addition, certificates may be revoked using another protocol, such as OCSP. Referring back to FIG. 1, data storage venue 120 is depicted with an optional OCSP responder 126 for this purpose. Validating software, typically located on the device having the sensitive application, may check the CRL for each trusted authority recursively.

FIG. 6 is a block diagram overview of a process by which certificates are verified using an extended public key infrastructure in accordance with an embodiment of the invention. In this embodiment, public key infrastructure is extended by introducing the concept of a summary certificate. The process begins, as before, with a credential certificate or summary certificate 610 having data whose validity must be determined. A computer may optionally walk trust chain 620 as before to verify the identity of the signer of certificate 610. (Alternatively, revocations may be processed in a batch mode as described above in connection with FIG. 4.) If certificate 610 is a summary certificate, it represents a primary credential that relies upon several secondary credentials for its validity. The identity chain of trust and the hierarchy of credentials for each of these secondary credentials may be checked as well, to determine whether they all remain valid. Thus for each secondary certificate in the chain, there may be employed process 640 to initiate a request for current status of the secondary certificate so as to cause retrieval in process 650 of secondary certificate status. This secondary credential information is made available for decision-making in relation to the primary credential. A data service provider may then apply policies determined by the agency issuing the certificate, to decide whether the agency would revoke the primary credential due to the revocation of one or more secondary credentials. For example, if a secondary credential is invalid due to a broken chain of trust, the policy may be to revoke the primary credential or not to revoke it, depending on which secondary credential is invalid.

Further, an identity certificate 630 may also be a summary certificate. This situation arises if a trusted authority used several credentials to prove its identity to an ‘upstream’ trusted authority which issued certificate 630. In such a case, if the upstream authority discovers a fraud, it can revoke intermediate identity certificate 630, thereby implicitly revoking certificate 622 and certificate 610 in accordance with existing PKI standards. Here, the credential represented by the identity certificate is the authority to attest to third-party information. Persons skilled in the art should recognize other, similar ways to extend existing PKI systems using summary certificates.

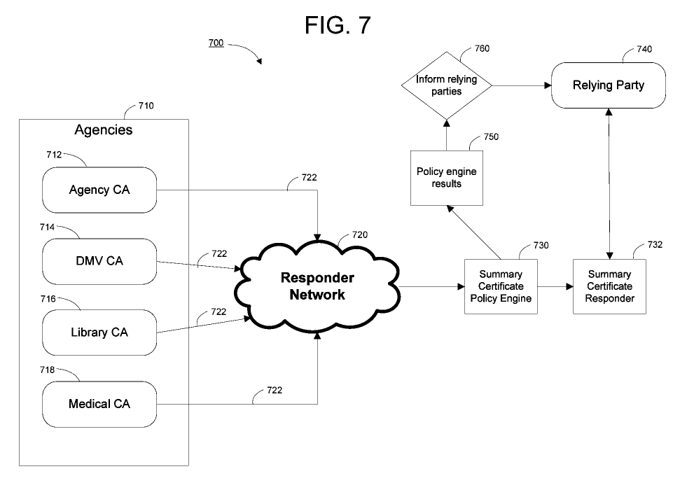

FIG. 7 is a block diagram detail of a process by which certificates are verified using a public key infrastructure in accordance with an embodiment of the invention. As discussed above, various agencies 710 issue credential certificates, including summary certificates. Certificates may be issued by, without limitation, a government agency CA 712, a DMV CA 714, a public library CA 716, or a hospital or medical professional CA 718. An agency may also issue a CRL, or participate in OCSP, in order to revoke certificates. Process 700 begins after agencies have issued credential certificates that a data service provider has collected. Some of these certificates may be summary certificates. The data service provider may participate in OCSP, whereby the provider accesses a responder network 720 of OCSP participating responders. The responder network 720 publishes certificate revocations 722 as they are received, in accordance with the OCSP standard. The revocations are received by a summary certificate policy engine 730.

The summary certificate policy engine 730 determines whether or not a digital resume, or a given summary certificate within a digital resume, should be revoked. The policy engine 730 may maintain a reverse index, wherein each credential is associated to a list of one or more summary certificates containing the credential. As summary certificates are added to data storage, they are added to the index. Agencies issuing summary certificates may transmit an accompanying revocation policy that captures the complex interactions between secondary credentials, as described above. The policy engine 730 stores these policies, which allow the engine to later determine whether a primary credential should be revoked in response to the revocation of a secondary credential.

During normal operation, the engine 730 receives credential revocations from the responder network 720. For each credential that is revoked, the engine retrieves from the reverse index the summary certificates associated to that credential. Some digital resumes may not contain a summary certificate associated with the revoked certificate. For these digital resumes, the engine 730 need not perform any action the architecture of the system guarantees that a trust chain using that summary certificate is still valid. Some digital resumes will contain a summary certificate associated with the revoked certificate. For each of these summary certificates, the engine 730 applies the associated policy to determine whether to revoke the summary certificate, given that the secondary credential was revoked. If the policy is to revoke the certificate, the data service provider may publish this information to its own OCSP responder 732, depicted in FIG. 1 as responder 126. A relying party 740, such as a first responder possessing a mobile electronic device, may access the revocation notice from OCSP responder 732.

Even if policy engine 730 does not revoke a summary certificate, a relying party 740 may be interested to know that a credentialing agency has revoked a credential on which the primary credential relies. In such circumstances, a relying party may subscribe with the data service provider to receive such ‘partial’ revocations independently. If this is the case, the policy engine results 750 are separately transmitted to a relying party 740. In one embodiment of the invention, a data service provider may initiate contact, informing 760 relying parties of revocations. In another embodiment, a relying party 740 may contact a data service provider.

### Virtual Smartcards

In prior art PKI systems, smartcards have cryptographic secrets, such as private encryption keys, that should only be used by one individual. An individual having a smartcard authenticates his ownership of those secrets by cradling the card in a device and responding to a series of challenges. A challenge may be biometric, such as collecting a fingerprint. A challenge may be knowledge-based, such as requesting a PIN or a password which only the authorized individual knows. Once the individual meets these challenges, the device allows software applications access to the cryptographic secrets stored on the smartcard (for example, by providing a PKCS #11 interface).

However, not all credentials support this mode of operation. Driver's licenses, passports, firearms permits, and many other credentials may not contain a smartcard or an HSM. Credentials such as these are not electronically verifiable, thus do not support a high level of assurance that the individual offering the credential is its true owner. Further, some individuals such as emergency medical personnel and hazardous materials response team members may benefit from the security features that smartcards provide. Yet a supporting infrastructure, such as a state environmental agency, may not be able to afford issuing authentication tokens to all of these personnel. At the same time, the agency may desire that sensitive information be available to the personnel at an application venue.

Even smartcards containing an HSM are subject to certain limitations. For instance, a smartcard HSM may contain the only copy of an individual's private encryption keys. If she were to lose her smartcard, or even misplace it temporarily, she would no longer be able to decrypt potentially time-critical communications sent to her. Nor would she be able to decrypt old, sensitive messages stored in an encrypted form. Additionally, she would have to request issuance of a new smartcard, incurring time and expense. If the smartcard also acted as an identity document, she may be denied entry to her workplace.

One solution to these problems is a virtual smartcard. Although the term “virtual smartcard” is known in the art, embodiments of the present invention achieve implementations that differ from the prior art. In exemplary embodiments of the present invention, a virtual smartcard is a set of computer-implemented processes, associated with an individual, which simulate an authentication token containing a hardware security module. Such a virtual smartcard is advantageously electronic in nature, and does not incur overhead costs associated with distribution of physical tokens, or the danger of being misplaced. An individual may only access her virtual smartcard if she has properly authenticated using a physical authentication token, biometric information, a secret known only to the individual such as a personal identification number (PIN), or a combination of these. In this way, the virtual smartcard may be associated with a physical credential, even if that credential is not a smartcard. In one embodiment, a virtual smartcard is associated with a single physical credential. In another embodiment, a virtual smartcard is associated with a number of different physical credentials. A single virtual smartcard may hold, for example, data associated with several credit cards, driver's licenses, bank accounts, a social security number, passport, or any combination of these. A virtual smartcard may act as a unified, secure mechanism by which a person may maintain and protect his credential data against the loss of a physical smartcard or of a non-smartcard credential, using ordinary PKI techniques.

A virtual smartcard may have a unique set of public and private keys, different from those of a physical smartcard to which it is associated. However, a virtual smartcard can represent the data contained in the physical smartcard or other physical credential or token. Thus, if a person misplaces a physical token, such as a physical smartcard containing encryption keys, she may still access the keys if she had previously associated a virtual smartcard with the physical one. Additionally, the person may notify a data service provider of the loss, and the data service provider may place the certificate for the physical token in a certificate revocation list or publish it through OCSP. Meanwhile, the person may inform others to substitute the virtual smartcard certificate for the physical smartcard certificate. Since a virtual smartcard may emulate traditional PKI functions such as digital signing and message decrypting, and because the data encryption keys contained by the former may be the same as those in the latter even if the signing keys differ, the change may be nearly transparent to an end user of the PKI.

An individual may request access to a virtual smartcard using a networking device, such as a mobile electronic device in accordance with embodiments of the invention. The networking device securely communicates with a data service provider that provides the virtual smartcard. The data service provider replies with a series of challenges, similar to traditional PKI. When the individual meets these challenges, the data service provider allows the authenticated networking device to access the secrets stored by the virtual smartcard.

A virtual smartcard is used in one embodiment to encrypt sensitive data, such as a digital resume, so that only the individual associated with the resume may read it. A virtual smartcard is used in another embodiment to encrypt communications between individuals using mobile electronic devices. In another embodiment, a virtual smartcard is used to digitally sign email sent by an individual. It will be understood that a virtual smartcard may be used for other purposes that a traditional physical smartcard enables.

FIG. 8 is a block diagram of a process by which a person may create a virtual smartcard in accordance with an embodiment of the invention. The process begins with a first responder or other party 810. The party may optionally possess a smartcard 840 having a hardware security module (HSM). Party 810 cradles smartcard 840 in a mobile electronic device in accordance with an embodiment of this invention. If the individual already has a smartcard, it may be used. If not, one may be provided by another party, such as a guard at a visitor control center. In the latter case, the individual may return to visitor control to access the virtual smartcard each time the certificate in resume container 884 expires. Next, in process 820 the device captures identity credentials, including biometrics like a fingerprint, or a secret known only to the individual. The electronic device uses smartcard software 830 on the mobile electronic device to transfer these identity credentials to smartcard firmware 842, which generates encryption keys using the smartcard HSM in process 844. Smartcard 840 stores private keys generated in the HSM for maximum security and later use. Software process 850 copies encryption keys from the smartcard, and collects information pertaining to the virtual smartcard in a storage certificate 852. The mobile electronic device signs the certificate to prove its origin. The certificate 852 is packaged for transmission in process 860, and sent via a federated storage network 870 to data storage venue 880. There, a data service provider creates a record of the cryptographic keys, and provides an interface to accessing them. This interface may be implemented in accordance with smartcard interface standards, for example PKCS #11, thereby presenting to accessing applications the appearance of an interface with a real, physical smartcard. The data storage venue may use the virtual smartcard to issue an identity certificate 882, or digitally sign the digital resume 884 of user 810 in accordance with PKI standards.

In an alternate embodiment, process 800 is performed without a smartcard 840. Instead, a computer having a host operating system provides the cryptographic services required. In such an embodiment, smartcard 840 is replaced a software application programming interface, and communications processes 830 and 850 are replaced by software functions not relating to operating a smartcard, but that otherwise perform analogous operations.

FIG. 9 is a block diagram of a process by which a person may enable a mobile electronic device in accordance with an embodiment of the invention. At the completion of process 236, a mobile electronic device, such as phone 910, contains sensitive software applications. These applications may remain on the phone for an extended duration, during which the phone may pass out of the immediate control and possession of the first responder who registered it. To maintain maximum security of sensitive data, it is advantageous that a phone be disabled when not in use by an authorized first responder. A phone may disable access to sensitive applications and data when it is turned off, or after a fixed period of power-on idling.

Process 900 may be used to enable access to applications on a phone 910 in accordance with an embodiment of the invention. The phone first captures identity proofs, such as biometrics and knowledge challenges, in process 920, from a user 902. Once the identity proofs are assembled, process 930 transmits them securely via a storage network 940 to a data service provider 950. Next, process 951 locates a digital resume associated with the user 902 using the received identity proofs and a reverse index in accordance with embodiments of the invention. In process 952 the data service provider 950 validates the trust chains for each credential certificate and summary certificate contained in the resume. This validation process serves two purposes: first, to verify the credentials presented to unlock the phone 910, and second, to update the digital resume of user 902.

In one embodiment, the data service provider applies revocation policies in process 954 to determine whether the credentials presented are still valid, and whether the individual's digital resume has been revoked. If the presented credentials are invalid, in process 956 the service provider transmits an INVALID message. If they are valid, the service provider in process 958 transmits a VALID message along with the updated digital resume. It transmits this decision to the phone, and the phone receives this data in process 960. The phone then enables applications and updates the resume in process 970. If the first responder's credentials are not valid, the phone will not enable access to the sensitive applications. If the credentials are valid, the phone then may enable access to at least some of the applications or data based on the resume that it received.

Each digital resume may contain dozens or hundreds of credentials. It may be inefficient to transmit the digital resume throughout a storage network or to phone 910. However, a digital storage provider may advantageously transmit a digest of a digital resume, rather than the resume itself A digest is as useful for validating a resume as the resume itself, because any change in a resume produces a different digest. (Also, referring to FIG. 2, the digest of the resume can be used as ‘credential data’ during authentication in process 242.) The phone compares the received digest 960 to a digest already stored in the phone. If they are identical, then the mathematical properties of the digest hashing function strongly indicate that the individual's digital resume has not changed since the last time such a request was made. The phone may therefore enable the same applications as the last time the phone was activated. If the two digests are different, the phone may request from data service provider 950 that a new copy of the entire digital resume be sent to the phone, or that some portion of the digital resume be sent to the phone. In response the data service provider matches identity proofs it received from the phone with a virtual smartcard associated with user 902, the virtual smartcard previously established in accordance with an embodiment of this invention as in process 800. The data service provider encrypts the digital resume using the user's virtual smartcard, and securely transmits it to the phone. Now the phone may use up-to-date resume data to determine which applications and data the user should be allowed to access, and enable the corresponding software. It should be noted that several of the data transmissions described above may be combined for communications efficiency, using methods which should be apparent to those skilled in the art.

In the prior art, a device seeking to verify a set of credentials would verify each trust chain in a series. In particular, the device would consume network resources to download credentials and to validate digital signatures serially, and consume time to process the signatures. However, in embodiments of this invention, a data service provider, rather than the device, consumes the computing resources to check each credential's validity on demand. Embodiments of this invention thus advantageously allow a central service provider with large computing resources to process the trust chains, allowing for faster response time. Also, it is advantageous to transmit a resume digest instead of a resume. To authenticate user access, a mobile electronic device need not process a digital resume, but need only determine whether the digital resume has changed. Thus, a digital service provider need not always transmit the entire digital resume to the device, only whether it has changed. Transmitting only a digest saves computing resources, networking resources, and time. As a further advantage, the device need only verify a single digital signature of the data service provider attached to a resume digest, to determine that an entire digital resume of credential certificates and summary certificates has not changed. The phone may thus determine implicitly that none of the certificates in the digital resume has been revoked, by validating a single identity certificate.

The above process 900 for enabling a phone may be applied in a variety of situations. For example, in one embodiment the phone belongs to an ordinary citizen who is involved in a traffic accident. A first responder, such as a police officer or emergency medical technician, cradles his own smartcard in the phone 910, and answers the phone's authentication challenges. This data is transmitted to a data service provider according to process 900 to access the first responder's virtual smartcard and download his digital resume. The phone then accesses the resume to determine, for example, that an EMT should be allowed to access the individual's medical history, or that a police officer should be allowed to access the individual's licensing, insurance, and vehicle registration data. Those skilled in the art may easily envision other uses to which this process may be applied and remain within the scope of the invention.

### Batch Certificate Processing

Batch processing may be used to transact operations associated with large numbers of mobile electronic devices. Those mobile electronic devices carrying credentials in accordance with embodiments herein can have their credential certificates updated to reflect any revocations as a result of the batch processing. Classes of these mobile devices, such as smart mobile telephones, can be configured to cause such updates automatically whenever the devices are connected to their respective networks. With automatic updating, a mobile device that has been connected to the network for a period of time can be reasonably assumed to have updated credentials and therefore can be used immediately for a transaction, without the need for any further interaction with a remote source. This approach, discussed in the following paragraphs, is efficient and eliminates the need for network traffic and processing associated with separate authentication of each transaction. A flag can be pushed, for example, on a daily basis, to each mobile device indicating the continued validity of its credential, and this flag can be used as an indicia of validity of the credential for a transaction. Further, each transaction can be the subject of a direct query to a credential server to confirm validity of the relevant credential.

In using the mobile device in the fashion described, a user first authenticates himself to the device. Such authentication may take the form, for example, of entering a personal identification code (PIN) and swiping a finger for a fingerprint, all as described above in connection with FIG. 2B. This authentication (following an internal verification of the consistency of the user's credentials as explained in connection with FIG. 2B) permits the user to expose the user's credentials stored on the mobile device for use in a secure transaction, such as a retail purchase on credit. A party that relies on the security of the transaction, such as a merchant, using a suitable machine, obtains relevant credentials from the mobile device and keeps a log in which is stored information pertinent to each purchase. The mobile device itself keeps a log of the transactions in which it is used. A background batch process performed for example by the credit facility may compare data on merchants logs with data on logs of mobile devices, to reconcile successful transactions and detect fraudulent transactions.

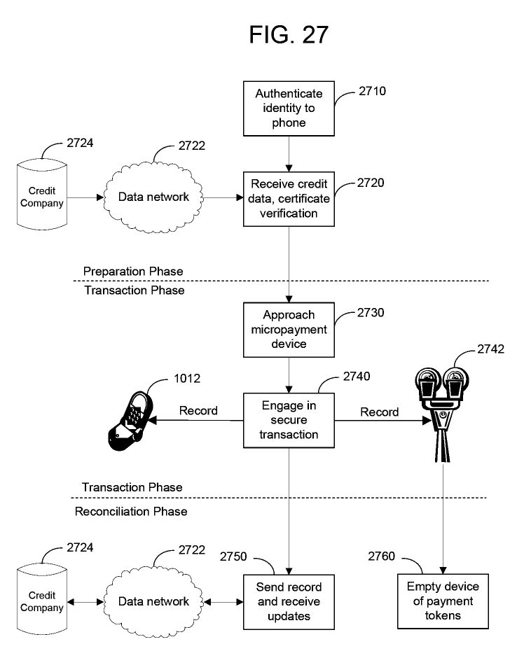

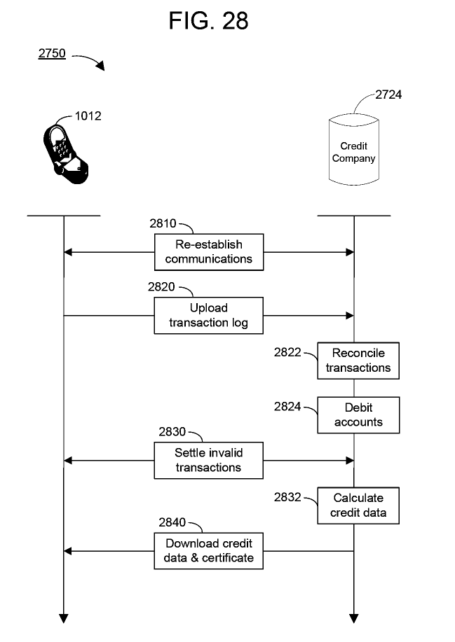

Batch processing enables (among other things) rapid fraud detection, as depicted in FIG. 10. Batch processing also enables processing of transactions, such as micro-payments, in which a disconnected device participates, as depicted in FIGS. 27 and 28.

FIG. 10 is a block diagram of a process, in accordance with an embodiment of the present invention, for batch processing of secured transactions using a mobile device in the manner described and for rapidly detecting fraud. The process begins with a person 1014 who has been previously authenticated to the device using process 242. The person 1014 uses the mobile electronic device depicted as a smart phone 1012, and the secure document 1016, and together we have shown these as components of the identified party 1010. The person 1014 enters into a secure transaction with a relying party 1020, using the phone 1012 and the secure document 1016. Additionally, the relying party (such as a merchant) will supply equipment such as a card-swipe machine or a barcode reader to read data from the secure document 1016. A swipe machine may read credit information from a credit card, while a barcode reader may read a two-dimensional barcode from a driver's license. In either event, both the phone 1012 and the relying party 1020 store information about the secure transaction for later comparison. At this time, the relying party 1020 may transmit a message to phone 1012, asking whether or not to confirm the transaction.

In process 1030 the relying party sends transaction logs over a network 1040 to trusted storage 1060 hosted by a data service provider. Communication may occur at once, as each transaction occurs, or as a bulk upload. Also, phone 1012 sends its own transaction logs to trusted storage 1060, either at once or some time later. (See discussion below in connection with FIGS. 15-18 discussing trusted storage.) In process 1070, the data service provider compares the two logs it received to look for discrepancies in a batch process. This comparison may occur on a regular basis, such as every night. If the comparison determines that there is a data match, then in process 1080, fraud is unlikely, and no further processing is necessary. However, if the comparison determines that there is not a data match, then in process 1090, further remedial steps are taken, including launching an investigation, freezing a credit card account, or sending notices of potential fraud to the person 1014, the relying party 1020, a credit card company, or another party with an interest in the transaction.

There are several advantages to comparing logs in a batch process, in the manner illustrated above. By performing comparisons on a regular and frequent basis, more fraud can be detected sooner, avoiding greater losses of money during the time lost in detecting the fraud. Comparing logs may be done at a central location. Thus, more processing resources such as disk space, memory, and CPU power can be brought to bear to reconcile the logs than if the comparison were done on the phone 1014. Also, the system may be run automatically. Such a system provides fraud detection without human intervention such as visually scanning credit card bills for suspicious-looking transactions. The system can automatically notify a card holder and a merchant, allowing both parties to the secure transaction to begin to mitigate losses quickly. Additionally, once the infrastructure for batch processing is in place, there is no absolute need for each transaction to be cleared at a central server in real time; instead such an approach is merely an option for a merchant.

Accordingly, the phone may be used optionally for transactions, even when a network is unavailable, and an individual may use phone 1012 in a ‘disconnected’ state. The individual may enter into several transactions consecutively, carrying a log of all transactions on phone 1012 for uploading and verification when the network becomes available again. The phone itself may keep a running total of all purchases made, and compare that to a stored credit balance. When appropriate, the phone may warn the person that their credit has been or soon will be exceeded. When connectivity is restored, or simply on a periodic basis, the phone 1012 uploads transaction data in a batch process, similar to each relying party.

A phone 1012 may be used this way, for example, as a micro-payment device. Such a device may be used to pay for a soft drink, purchase small items like stamps or candy, pay a fee at a toll booth or a parking meter, or any of a myriad of other uses that may be envisioned by those skilled in the art, because its use on each occasion need not require communication with a central server on a network. Also, phone 1012 may contain wireless technology such as Bluetooth to communicate with a corresponding device of the relying party 1020, thereby implementing secure, fraud-safe, wireless micro-payments. This embodiment of the invention provides a method of providing micro transactions with minimal communications that will work in any environment and device so enabled. Dispensing devices are protected by PKI and isolated to short-range communications, thus providing a very high level of security.

Since the cell phone may have a full PKI engine, the threat of replay attacks against transaction data may be reduced as well. Current OCSP servers send data across in clear text, thereby allowing the transaction data to be copied and replayed at a later time. All communications with the phone 1012 can be fully encrypted, thereby preventing a replay even if the data were intercepted. This is because the transaction described is localized, and does not require any network services.

FIG. 27 is a block diagram of relevant processes for using a mobile electronic device to make a micro-payment in accordance with embodiments of the invention. A device may store a cached certificate verification response, such as an OCSP response, for use in a transaction in which a data authentication network is not available. The user device provides the OCSP response certificate to the retail device. The retail device uses the OCSP response to validate the user's credentials, while validating the response certificate itself with a cross-certificate it has stored. In this way, all verification may be performed without contacting an authentication network. These procedures enable non-networked retail devices, such as parking meters and vending machines, to perform certificate validation without direct access to a validation server. In particular, a non-networked retail device may only need to store a small number of trust anchors and cross-certificates, whereby the last link in the trust chain (between the user credential certificate and a cross-certificate) is provided by the mobile electronic device itself at the time of a transaction.

A response issuer may set a cached response to expire after a given length of time, determined by an amount of risk tolerance. For example, a user of a phone on which a response is stored may purposely avoid connecting to a validation network in case she knows that the credential was revoked, while to a merchant, the response appears to validate the certificate. Thus, too long of an expiration may be undesirable for some applications. On the other hand, an expiration period that is too short results in too many validation requests, and defeats the purpose of caching. Embodiments of the invention allow for expiration times of all lengths, including no expiration length, in which a certificate response is valid until it is expressly revoked.

The process described above may be implemented in three phases as follows. Preliminarily, for any use of the phone, in process 2710 a user authenticates herself to a phone 1012 to become an identified party, as in FIG. 10. Also preliminarily, in process 2720 the phone 1012 is placed in communication with a credit company 2724 using a data network 2722 and receives a certificate having credit data for the identified individual, and a certificate verification. The credit data include information such as a balance or transaction limit. The certificate verification guarantees that the credit data will be valid for a certain period of time, and may be an OCSP response or other self-expiring certificate verification. At this point the phone can be used for transactions in the manner described. Once this preparation phase is complete, the user may engage in a secure transaction at some time later when the credit card data network 2722 happens to be unavailable.

Thus, in process 2730 the user approaches a micro-payment device, for example parking meter 2742, to initiate a transaction. Initially, in the manner previously discussed in connection with FIG. 9, the user authenticates himself to the phone (e.g. by entering a personal identification code and a finger swipe). As the user approaches, the phone 1012 and device 2742 then establish a communications link using a wireless technology, such as Bluetooth. In order to provide a secure communications link using public key encryption in accordance with embodiments of this invention, the phone 1012 and device 2742 each have cryptographic hardware or software to implement physical or virtual smartcard functionality as described above in connection with FIG. 8. In process 2740 the phone 1012 and device 2742 engage in a secure transaction, for example as shown in FIG. 2B. As an example of a micro-payment transaction, a parking meter 2742 sends a message indicating how much each increment of time costs, and the user makes a selection of how much time to purchase. The meter decides whether to honor the transaction, and a record is generated. (We discuss in further detail below criteria for honoring the transaction.) Both the phone 1012 and device 2742 store a record of the transaction, as indicated in FIG. 27. If the transaction is successful a billing record will be established on the meter's memory and on the phone and the available amount on the phone of credit for future charges is reduced. All transactions are digitally signed by the phone or dispending device as appropriate.

Some time after the conclusion of the transaction phase, when the credit card data network 2722 is available again, phone 1012 must reconcile its transactions with the credit company 2724 so that the user's account may be debited. Thus, in process 2750 the phone transmits records of its micro-payment transactions to the credit company, and receives updates to the credit data and certificate verification. Process 2750 is described in greater detail in connection with FIG. 28 below.

After process 2740 the device 2742 takes a different path. In retail fee-collection embodiments such as vending machines and parking meters, the device itself is a secure transacting party. For example, over the course of a day, a parking meter 2742 may accept coins or wirelessly deduct payments from several phones 1012 by storing payment tokens (obtained by whatever method). Throughout the day, records of transactions are stored inside the meter. At the end of the day, a collector may visit the parking meter 2742 and collect any physical coins stored in the meter. At the same time, in process 2760 she may wirelessly transfer the transaction log and payment tokens to her own phone (in the manner described herein), thereby ‘emptying’ the meter of its virtual money. She may then return with the log, along with logs from other parking meters 2742, to a central location for batch uploading. Or, if the credit network is available from her phone, she may upload the logs and tokens to a credit card data network 2722 directly. Once both sets of logs have been uploaded to the credit card data network 2722, the remainder of the procedures of fraud detection process described above may be applied. In particular, the transaction logs are compared. If the logs match, the appropriate credit account is charged, while if there is a discrepancy, settlement procedures may begin. Settled transactions can be archived for future reference and auditing.

In this embodiment, the parking meter 2742 need only have a short-range wireless capability to communicate with various phones 1012, thereby saving manufacturing costs and load on the cellular networks or on wired networks, and increasing the security of the parking meter against electronic attack. Although described above in a context where a credit card data network 2722 is unavailable, the scope of this invention includes parking meters, vending machines, and similar PKI-using micro-payment devices that participate in such networks. Also included in the scope of the invention are devices that physically attach to a phone 1012 using a cord or cable to transfer credential data, instead of using a short- or long-range wireless connection.

FIG. 28 is a block diagram of processes in accordance with embodiments of the invention by which a mobile electronic device updates itself after a credit data network becomes available. This figure shows in more detail the process 2750. In process 2810 the phone 1012 and credit company 2724 re-establish communications using data network 2722. Once connected, phone 1012 uploads the log of transactions it has made for comparison with the logs uploaded by micro-payment device operators.

In process 2822 these logs are reconciled, as described above. There are three cases: the phone is uploading a record of a transaction for the second time (because a device operator has previously uploaded the record), it is uploading the record for the first time, or it is uploading a false record. In the first case, process 2822 may compare the records. If the records show an identical payment, the appropriate account may be debited in process 2824. If the records do not match, the invalid transaction can be settled in process 2830 using known methods. In the second and third cases, there is no data to reconcile because only one copy of the transaction record is available. Thus, the record is placed into storage for a period of time that may be determined by the credit company, the user, or both. If the period expires, the purported relying party is notified that a record has been entered, and verification that the transaction occurred is requested. Thus, fraud may be detected if the relying party responds negatively to this request. If no response is forthcoming, the credit company may verify that the relying party is still conducting business, or take other remedial measures to resolve the transaction. Preferably, however, relying parties will upload their batch of records on a regular basis within the period of time specified, so that fraud may be detected sooner.

In process 2832 the credit company 2724 calculates new credit data. For example, if the phone 1012 has engaged in any transactions, the credit of the phone's user may have been decreased in process 2824. Additionally, the user's credit limit or other pertinent information may have been changed during the time the network was unavailable. For example, the user's credit card may have expired, and the credit certificate may need to be revoked. This information is collected, then downloaded to phone 1012 in a signed certificate in process 2840. At this point, the phone 1012 is synchronized with the current credit information. If the authorization to conduct secure transactions has not been revoked or the appropriate balance reduced to zero, such transactions may resume.

During disconnected transactions such as those just described, the relying party takes a risk in accepting credentials with only an attestation on the mobile electronic device. Additionally, if a user has not entered any transactions for a time, then updating credit information from the credit company 2724 may not be necessary, and doing so would place a burden on the network 2722. To relieve these problems, a phone 1012 in accordance with embodiments of the invention receives from a credit company 2724 a digitally signed certificate containing the credit data and an expiration time. This expiration time allows the credit company 2724 to deal with the phone 1012 under conditions wherein it will refuse to honor a transaction occurring after the time. Software or hardware in the phone 1012 may compare an internal clock against the expiration time in the certificate. If the current time is after the expiration time, the phone 1012 may disable secure transactions that use an account associated with the credit data in the certificate (although other certificates and accounts may be available for conducting transactions). The phone may do so by revoking the certificate itself. As an added risk-abatement measure, a phone whose data has not been synchronized with a credit company for a period of time may be programmed by the credit company to reduce the balance available on the phone for use in secured transactions. As an additional measure, relying party systems may request from phone 1012 network connection data, including the time the device last synchronized, and how long the device was on the network. Then the relying party system can decide, based on desired parameters, how much risk to accept vis-a-vis a particular transaction.

In a related embodiment, the phone may maintain a record of when it was last connected to the network and for how long the network connection was maintained. In this embodiment, the credential is assumed to be good unless there is deemed to be an unacceptable risk that it has been revoked. Such a record may be used by a micro-payment device or by a merchant payment system to assess risk associated with a transaction with the user of the phone. Given the batch processing of certificate revocations, if the phone is connected to a network for a reasonable length of time, for example more than five minutes, there may be reasonable assurance that a certificate revocation that occurred during the last batch processing will be communicated to the phone, rendering the relevant credential invalid were a revocation effectuated. This approach works best when the phone's software and that of the server with which the phone is in communication is configured to make credential revocation a matter for priority communication. Consequently, if the data show, for example, that the phone is actively connected to the network at the time of the transaction, and has been connected to the network for the past five hours, the micro-payment device or the merchant payment system may be configured to accept the credential and enter into the transaction if the risk is deemed reasonable in view of the network connection data on the phone. On the other hand if the data show that the phone has not been connected to the network for more than a week, the micro-payment device or the merchant payment system may be programmed to refuse the transaction and send a message to the user to connect the phone to the network before seeking again to execute the transaction.

It will be understood that the system in various embodiments described above may be used without the need for a phone 1012 to store a long-term certificate. In one alternate embodiment, the credit company ‘pushes’ credit certificates to a phone 1012 on a regular basis, daily for example. This embodiment mitigates merchant risk further than the system described above, as the credit data is guaranteed to be no older than one day, but it requires more network traffic. Thus, the credit company may charge the user or merchant a fee for providing this service. In another embodiment, the phone 1012 or device 2742 contacts the credit company for each transaction. This embodiment mitigates merchant risk almost entirely, but requires the most network traffic of all. A credit company may charge a high fee for providing this service.

### Physical Access Control

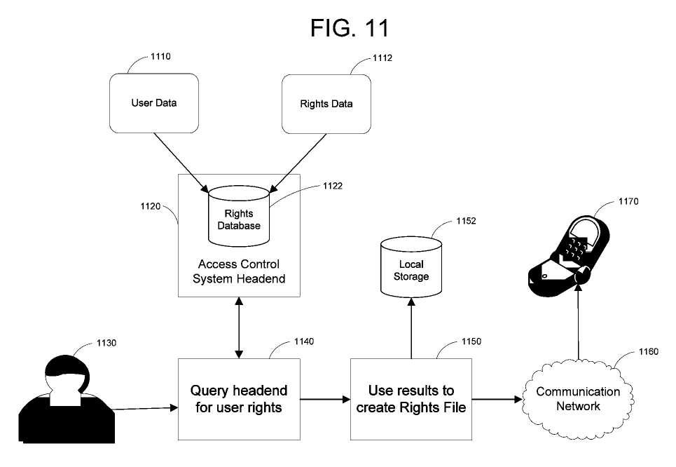

FIG. 11 is a block diagram of a process by which a person may register a device in accordance with an embodiment of the invention to permit physical access to a secured area. Some large organizations have a problem providing their employees with uniform physical access to various locations under their control. For example, a large corporation may have acquired many offices and buildings in different locations through acquisitions or growth. Each building or office campus may have a separate access control system that relies on a local access control system headend. A headend will control physical access to various portions of the physical location, for example by locking and unlocking doors and gates. The computer systems that control the headends may not be interoperable with the systems at other locations, making common access mechanisms difficult without custom software development at a cost in time and money. However, in embodiments of this invention, access control data is stored on a mobile electronic device and retrieved locally by a guard, substantially mitigating these costs. As we have described and defined above, authorization of access is a type of a transaction, but for the purposes of FIG. 11, the type of transaction involves physical access.

Access control in accordance with the embodiment of FIG. 11 is implemented in two parts. During the first part, user data 1110 and rights data 1112 are entered into a database 1122 contained within an access control system headend 1120. User data 1110 includes routine identification information, such as a name, address, telephone number, employee ID, administrative rank (such as employee, manager, or director), job title, or other similar data which may be later used to identify a person. Rights data 1112 includes access rights tied to an individual, job title, or administrative rank. For example, the organization may decide that only an employee with job title including “accountant” may have access to rooms containing financial data of the organization; or, employee John Smith may have access to only public areas. Once database entry is complete, a person may use the local access control system to enter protected areas on the site where the system is installed. Access control systems of this type are known in the art, for example subway turnstiles. In one embodiment, access data for off-site locations is also stored in the headend 1120.

In the second part of access control in accordance with the embodiment of FIG. 11, a user seeks access to an off-site protected area. For example, an employee working at a headquarters campus traveling to a satellite office requires access to restricted areas there. A person 1130 determines that the user must have access at the remote site. Person 1130 may be a security officer, the user herself, her manager, a human resources staffer, or any other authorized person. Person 1130 initiates in process 1140 a query to the access control system headend 1120 using a computer (not shown), to retrieve the user's access rights data for the off-site location from database 1122. Using the retrieved results, in process 1150 the computer creates a file containing the list of access rights for the off-site location. The computer first stores the file in local storage 1152. This record of the rights may be used later for auditing and for determining what rights a traveling user has at any given moment. The file is also transferred to the user's phone 1170, a device in accordance with embodiments of this invention, through communications network 1160.

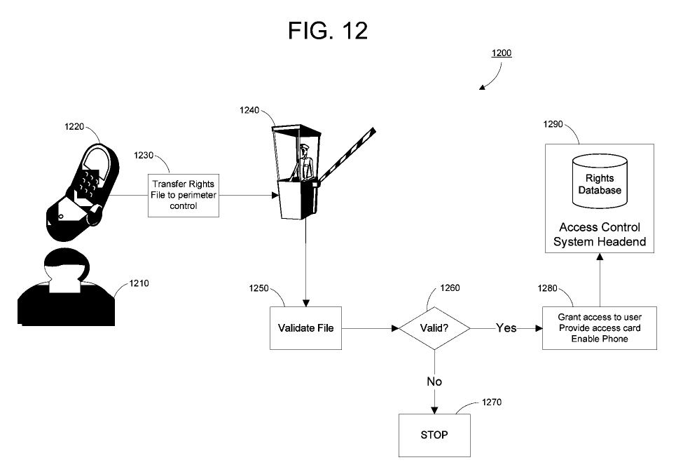

FIG. 12 is a block diagram of a process by which a person may use a device in accordance with an embodiment of the invention to access a secured area. Once a phone has been set up using the process of FIG. 11, a visitor uses the processes 1200 shown in FIG. 12 to access various secure locations at a remote location. A secure location may be a building, a floor of a building, a room in a building, or any other area controlled by an access control system. These processes allow a visitor to securely identify herself to a perimeter control system guarding a secure area and transfer her access rights into the local access control system headend. After the rights have been transferred, the visitor may access secure areas inside the perimeter. The processes 1200 do not require contacting a remote location (such as a security office at a headquarters building) for authorization.

A user 1210 possessing a phone 1220 first approaches a perimeter control system 1240. The system 1240 may be a guard with a computer at a gate, or it may be automatic, consisting entirely of electronic devices. When phone 1220 is within range to communicate with perimeter control system 1240, the phone transmits the rights file it previously received in the embodiment of FIG. 11 to the control system in process 1230. The communications may be wireless, in which case the channel may be encrypted using the phone's built-in hardware security module. Or, for example, the user may dock the phone in a cradle connected to the control system. Once perimeter control system 1240 receives the rights file, then in process 1250 there is a determination of validity of the file. This process may be automatic or require human intervention from a security officer. Validity determination may include ensuring that the rights file is properly decrypted; checking the identity claimed in the file against physical credentials presented by the visitor; accessing the certificate associated with the rights file and verifying the digital signature; checking for revocation of this certificate; or any other appropriate validity check.

The perimeter control system 1240 (or the security officer, if the file requires manual verification) in process 1260 applies the results of the validity determination of process 1250 in deciding whether the visitor has the proper rights to enter any secured areas. If not, as in case 1270, the perimeter control system 1240 stops processing and thus grants no access. Alternatively or in addition, the control system 1240 may take appropriate remedial measures, such as alerting security of an attempted unauthorized access. If the decision in process 1260 is that the visitor has acceptable credentials, he may be granted access, as in case 1280. At this time, any secure applications or data in the phone relating to the secure area may be enabled by the perimeter control system 1240. In one embodiment, a guard may issue the visitor a badge for display as identification. In another embodiment, the perimeter control system 1240 may log the visitor's entry in an audit record. To grant a user access to secured areas within the perimeter, the system may store the verified access rights file in its local access control system headend 1290. This last process may require the phone to process the rights file into a given data format so that it may be recognized by the headend. At the conclusion of the processes of FIGS. 11 and 12, a user has transferred an access control rights file from one site to another site, allowing the user access to secured areas at the second site, without the need for security personnel at the second site to contact the first site to verify her permissions or to authorize the user to access particular secured areas through manual data entry.

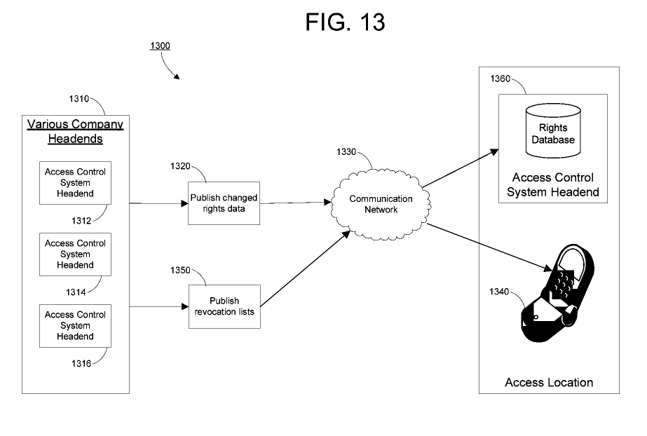

FIG. 13 is a block diagram of a process for updating a device in accordance with an embodiment of the invention to alter or revoke permission to access a secured area. On a company campus such as that described above, it may be necessary from time to time to alter the rights granted to a visitor. For example, an organization may have a standing policy to issue day pass cards to visitors, and revoke them at the end of each business day. Or, it may be policy to revoke a pass automatically if a visitor attempts to enter a secure area for which he has no clearance. Or, a visitor may legitimately need access to a location for which she was not originally granted clearance. An access control system in an embodiment of this invention may propagate rights changes so that access control headends have up-to-date information about these changes.

Process 1300 begins, as before, with organization headends 1310. A single organization may have several headends. For example, there may be a headend 1312 at a corporate headquarters, a headend 1314 at a satellite campus, and a headend 1316 in a building at the satellite campus. Additional headends may be employed for, among other purposes, providing access rights information for secure areas controlled by several agencies or organizations with equal or hierarchical authority to issue access rights. In process 1320, the headends 1310 publish rights data and rights data changes for authorized remote users to a campus-wide or organization-wide communications network 1330. These changes propagate to a phone 1340 possessed by a visitor, which updates its rights data to reflect the changes. From this point forward, the phone will allow the visitor to access only those secure areas permitted by the new rights, even if the local access control system headend has not received a permissions update. Additionally or alternatively, in process 1350 headends 1310 may publish revocation lists to entirely revoke access rights for one or more visitors. A list travels through the communications network 1330 to arrive at phone 1340, which responds by revoking the visitor's access rights to all secure areas. Alternatively or in addition, local headend 1360 may collect rights changes and revocation lists, if it did not issue these in the first place. Having local headend 1360 collect revocations provides an alternate means for altering or revoking a visitor's access to secured areas. Local headend system 1360 is consulted to determine a visitor's access rights in the case that headends 1310 cannot be contacted, or as a local cache to reduce communication with headends 1310.

### Trusted Data Storage

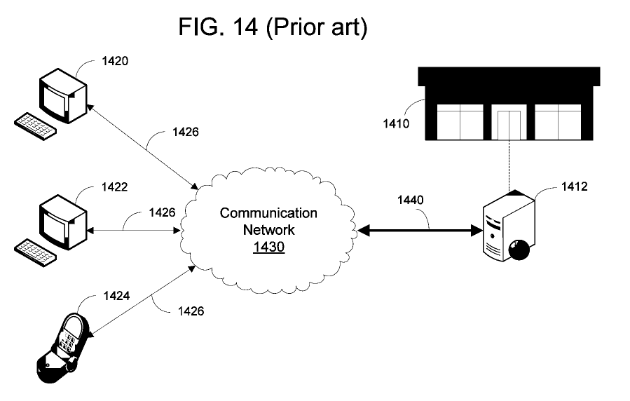

FIG. 14 is a schematic block diagram showing the relevant parts of a prior art system for providing business information. A business or agency 1410 may have one or more servers 1412 for providing business data. Such business data may include, for example, purchase order forms, tracking numbers, account numbers, balances, and other information that business 1410 wishes to make available to its customers, contractors, vendors, or other business associates. The servers 1412 may be, for example, web servers, or may be other types of data servers that rely on a known communications protocol for getting information. A small business may maintain only one server, while a larger business may maintain several servers 1412. Data consumers, such as customer computer 1420, contractor computer 1422, and user smart phone 1424, retrieve data from servers 1412 as needed. To do so, data consumers access the servers 1412 by sending requests through communication network 1430, and receive responses from the servers 1412. This access is indicated by lines 1426.

Several problems exist with this model. Servers 1412 must communicate with several clients including desktop computers 1420 and 1422 and smart phone 1424, perhaps simultaneously. This communication, represented by heavy line 1440, may overwhelm the business's available resources, such as bandwidth or server processing capacity. Thus, communication may incur heavy bandwidth costs for the business, or force the business to purchase more servers 1412. In addition, a business may internally agree on a service level for customer-facing systems, such as 99.99% uptime (“four-nines”, or about one hour per year of service interruption). This level of service requires substantial investment in information technology infrastructure, which may be better spent on other business functions. Alternate methods of communicating business information, such as by email, suffer from other problems. For example, email is generally insecure, and email messages containing confidential business data may be intercepted or lost. Email may be made secure through the use of encryption, but such encrypted systems are not in widespread use, and require significant knowledge and training on the part of end users to work effectively.

FIG. 15A is a schematic block diagram showing the relevant parts of a system for providing business information in accordance with another embodiment of the present invention. In this embodiment, a data service provider provides trusted storage for business data other than resumes. The data service provider allocates a segregated storage area for each business, and allows only that business to write data into the segregated storage area. Access to the storage area may be granted only upon a data service provider's validating a business's identity, by using a digital signature for example. A business, in turn, accesses the trusted storage using a URL or other address that can be controlled by the data service provider. In this way, all parties are guaranteed that only valid business data from the business is stored in the segregated storage area. The data service provider then allows direct access to the trusted storage by data consumers. A PKI system in accordance with embodiments of this invention is used to facilitate the above process.

Continuing the discussion of FIG. 15A, business or agency 1510 acts as a trusted data source. A method in accordance with this embodiment may allow business 1510 to maintain only a single computer 1512, although some businesses may employ more than one. Computer 1512 creates a digitally signed business document containing business data. Ultimately the digitally signed business document is hosted as item 1524 in trusted storage area 1522. Initially, however the computer 1512 securely transmits the digitally signed business document over line 1514 to one of several servers 1520, which may be a web server hosted by a data service provider. Computer 1512 may use a URL or other addressing device to designate the particular trusted storage it wishes to access. Server 1520 has a receiver for securely receiving the data from computer 1512. The server 1520 verifies the identity of the business 1510 using public key encryption, as described above. Server 1520 may have a hardware or software processor to perform the necessary encryption algorithms to verify the identity of business 1510. If the identity of the business is verified, server 1520 stores the data in trusted storage 1522, which is configured so as to accept data only from business 1510. Trusted storage 1522 is embodied as a physical data storage medium, such as a hard disk drive, or a portion of a hard disk drive. Then, server 1520 transmits the data to data consumers including desktop computers 1420 and 1422, and mobile electronic device (implemented as a smart phone) 1424 by communication network 1430. Server 1520 verifies the identity of a data consumer using its processor, and provides the consumer access to trusted storage via link 1534. Server 1520 guarantees, using public key encryption, that only those areas of trusted storage 1522 for business 1510 are visible or readable to a data consumer, and that they are not visible to any other party (except the trusted data source). Data consumer access 1530 may be either “pull”, if the data consumers request the data, or “push”, if the data consumers subscribe to a service that sends them data as it becomes available from the business 1510. In a “push” model, the processor in server 1520 applies business rules relating to the timing of storage and forwarding of the data to a particular data consumer, in order to decide when to forward the data. Both “push” and “pull” systems are within the scope of this invention.

Trusted data may be securely transferred from a trusted data source to a data service provider using a public key infrastructure. The ultimate data recipient may be, for example, the user of computer 1420 or smart phone 1424. In order to ensure that the trusted data may be viewed only by the data recipient, and not the data service provider, computer 1512 uses a PKI to access a public key associated with the recipient and encrypt the trusted data using this public key, according to a well-known encryption algorithm. In addition, computer 1512 packages the trusted data with other information that uniquely identifies the data recipient, for example a PKI certificate number, an email address, a URL, a postal address, or a phone number. All of this data is combined with a digital signature of business 1510, to form a digitally signed document 1524. This document is transmitted to server 1520 for storage as shown. Server 1520 uses a PKI to access a public key of business 1510, in order to verify the digital signature, providing assurances that the document was created by business 1510, and not a fourth, possibly malicious party. In another embodiment, the encrypted data is hashed to form a digest, which is digitally signed instead of the encrypted data itself. A digest is usually much smaller than the encrypted data, and thus lends itself to faster signing and verification. Furthermore, a digest may be uniquely associated with the encrypted data, according to the mathematical properties of the hash function used to create the digest from the encrypted data. Once the data's origin has been positively identified, the data service provider uses the uniquely identifying information in the document to associate the data recipient with the document for later transmittal.

As an additional layer of security, computer 1512 may use a PKI to access a public key for the data service provider, to encrypt the digitally signed document 1524 in a manner that only the data service provider may decrypt. If this additional step is taken, the data service provider may decrypt the encrypted digitally signed document using its own private key to yield document 1524. However, the encrypted data within document 1524 cannot be decrypted by the data service provider, which does not have access to the private key of the data recipient. This layer of security should be viewed separately from a digital signature—while it obscures the contents of the transmission from fourth parties, it does not otherwise provide assurances that the sender vouches for those contents.

Trusted data also may be securely transferred from a data service provider to a data recipient using a public key infrastructure. Using a method similar to that described in the previous paragraph, server 1520 may use a PKI to access a public key for a computing device of the recipient, such as computer 1420 or smart phone 1424. Such a device public key was established previously in accordance with an embodiment of the invention. Server 1520 encrypts digitally signed document 1524 using this public key, and transmits it to the computing device. In this way, the contents of the transmission are obscured from fourth parties. The computing device then decrypts the transmission using its private key, which is stored on a hardware security module internal to the device, as described above. The digitally signed document 1524 is then stored on the computing device.

When the data recipient wishes to view the data, she first authenticates herself to the device using a method in accordance with embodiments of the invention, as described above. Once authenticated, she may access the digitally signed document. The user accesses a PKI to obtain the public key for the document's signer (business 1510), and verifies the signature using well-known methods. Once satisfied of the document's authenticity, the user uses her own private key to decrypt the data within, and uses the decrypted, trusted data for any purpose. The user's own private key may be stored, for example, on a removable smartcard, or in a virtual smartcard in accordance with an embodiment of this invention. As above, the business 1510 may have digitally signed a digest of the encrypted data, rather than the encrypted data. In this alternate embodiment, the end user may verify the signature of the digest before decrypting the data.

The apparatus of FIG. 15A has several advantages over the prior art. First, there are cost advantages. By transmitting secure documents to a trusted third party, a business such as 1510 may save substantial amounts of money in infrastructure development and bandwidth costs. Computer 1512 need not service large amounts of data requests, as this work may be done by the third party. A data service provider centralizes the costs of infrastructure development, and benefits from economies of scale. Several servers 1520 may be employed by a data services provider at a single storage venue, and a services provider may have several storage venues to provide availability. The system lends itself to simple automation, saving a business labor costs over the long term. Next, there are service-level advantages. Computer 1512 need not be always available to service customer requests. Availability of the data can be guaranteed by the data service provider under the terms of a service level agreement (SLA) with the business 1510. Denial-of-service (DOS) attacks become much more difficult, as an attacker must now target the data service provider who may have countermeasures in place, rather than a small business that likely does not. And with a “push” data model, after the targeted data has been transmitted to the data consumer, a DOS attack becomes nearly impossible. Further, there are business operational advantages. The use of encryption and PKI in accordance with embodiments of the invention allows a business to honor its privacy policies for its vendors and customers. The system need not transmit to the data consumer “envelope” information, such as time of transmission, IP address, or other data that might be found in an email header. The system ensures that data was written only by the business 1510 using encryption techniques as described above. This provides a further guarantee to a data consumer, such as a business customer, that the data originated with the business, thereby reducing fraud that may be inherent in other third-party data storage systems. Also, the use of URLs to access a trusted data store simplifies management of data throughout the system.

FIG. 15B shows typical processes for implementing the deposit and secure access of trusted data according to the system of FIG. 15A. In accordance with the process 151, there are received from a first party a deposit of data, a digitally signed document associated with the data, as well as some form of identification of a second party for receipt of the data. In process 152, the digitally signed document is used to verify that the data were in fact sent by the first party. In process 153, the data from the first party are stored in association with the digitally signed document. Finally in process 154, the stored data are made available to the second party in a secure environment.

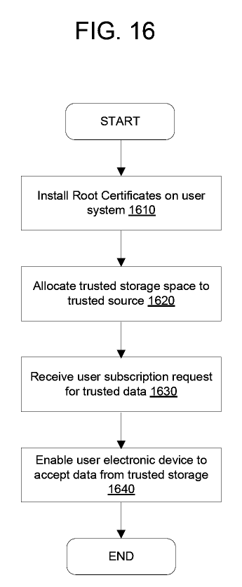

FIG. 16 is a flowchart showing processes in accordance with an embodiment of the present invention, to prepare a trusted storage system, such as that of FIG. 15A, for operation. A trusted storage system, such as that displayed in FIG. 15A, has three phases of operation. In the first phase, the system is initialized. In the second phase, the system receives data for trusted storage. In the third phase, a user may access data stored in trusted storage. Access may be of the “pull” variety, where the user accesses a data service provider. Access may also be of the “push” variety, where the data is already stored on an electronic device in accordance with an embodiment of the invention. Such devices include a user's phone, a computer, or other electronic device.

The initialization process of FIG. 16 begins by establishing necessary trust components of a PKI embodiment. Trusted data producers include banks, hospitals, credit card companies, utility companies, shipping companies, government agencies, and other groups or individuals that have confidential data to distribute. In particular, in process 1610 root certificates are installed on a user system, such as a phone. The certificates allow a consumer of the data to verify that the data has come from a trusted source, by validating a digital signature that may accompany the data. An example validation process is described in connection with FIG. 5. Once the certificates have been established, the system allocates storage for a particular trusted source in process 1620. Ordinarily, identity information about the source will be required by a data service provider, so that the latter may effectively determine whether any given data storage request originates from the trusted source. This identity information may be provided, for example, as a public key certificate or credential in accordance with embodiments of the invention. The data service provider may also allocate a URL to the storage area. Additionally in process 1620, a data service provider may receive business rules governing data to be stored in the allocated, trusted storage space. These rules may be similar to the business policies described in connection with FIG. 7—they could instruct the data service provider to forward or not forward data based on a number of criteria. For example, the rules may instruct to only forward data once per day as a daily digest. This rule is appropriate where a trusted source generates many informational data messages. Or, the rules may instruct to deliver each message as it is received by the data service provider. This rule is better suited to infrequent data updates from the trusted source. Or, the rules may instruct to deliver only messages classified by the trusted source with a particular code or tag. This rule allows a trusted source to use trusted storage as an archive, while only transmitting to the end user data which is relevant to the user. Other rules falling within the scope of the invention may be envisioned by those having skill in the art. A data service provider may implement these rules using any convenient hardware or software, and methods for doing so should be readily apparent.

Each trusted source, such as a shipping company, may have many customers who desire to receive, for example, package tracking numbers and tracking updates securely. Once the rules have been established and installed, a customer (or more generally, a data consumer or user) makes a request to receive data from the trusted source. The user transmits a data message to the data service provider, which receives the request in process 1630. The data service provider registers the user as a target of the business rules regarding forwarding of data. For example, the data service provider may store the user's identification in a database of users who should receive updates on a daily basis. Also, the data service provider may classify the user as a “pull” user or a “push” user Classification may be done according to the wishes of the user, for example by including such a request in the subscription request. Or, classification may be done according to the business rules and policies of the trusted source, such as service-level guarantees to its customers. In another embodiment, the user sends the subscription request to the business, which forwards it to the data service provider. In this embodiment, the user need not know that the trusted storage is hosted by a data service provider. The data service provider then transmits data directly to the user's electronic device.

In process 1640 a data service provider configures a user device, by transmitting to it an appropriate message over a secure communications link. Such communications links are described above. Data received from the trusted source is transmitted to a user's electronic device, such as a phone embodiment or a computer embodiment. Regardless of how the trusted data arrives at the user, by push or by pull, the user's electronic device may be configured to receive the data securely by receiving such a configuration message. The electronic device allocates storage space to receive the trusted data, thereby creating a trusted storage space on the device. Other functions of such configuration messages should be apparent.

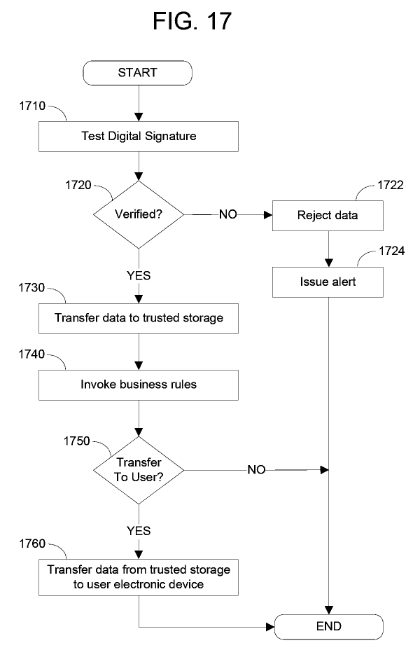

FIG. 17 is a schematic block diagram showing a process of updating a trusted storage system with new business data. The process begins when a data service provider receives new data from a trusted source. The trusted source may produce data in batches, such as a daily update, or it may produce data on a continual basis, or it may produce data sporadically. In process 1710 the data service provider locates a digital signature associated with the business data, and tests it against the cryptographic key(s) provided by the trusted data source. The signature may be tested as described above in connection with FIG. 5. In decision process 1720 the signature is verified or not verified. If the signature is not verified, the data service provider rejects the data in process 1722. Further, the data service provider may conclude that an intruder has attempted to inject data into the trusted data area, and issue an alert in process 1724 to the trusted source, the end user, or both. These parties may then investigate the improper data on their own.

If, however, the digital signature affirmatively verified in process 1720, the new data is transferred to trusted storage in process 1730. Once stored, the data may be securely accessed by the data consumer, using methods described above. After the data has been stored, a data service provider may also invoke business rules of the trusted source in process 1740. These business rules may have been previously installed in process 1620 of FIG. 16, or they may be altered by providing a new set of rules or replacement rules with the updated business data. The rules may require that the new data be immediately transferred to the user, or not. This decision is made in process 1750, and comes from a purely mechanical application of the business rules. If the decision is to not forward the data, then the process ends. This happens in a “pull” model of data transfer, where the user is expected to retrieve (“pull”) the content from the data service provider's trusted storage at a later time. Or the data may be transferred (“pulled”) on a subsequent update. Otherwise, following a “push” model, the process continues to process 1760, in which the data is transferred (“pushed”) to the user without the user's taking any additional affirmative steps. The new business data is transferred to the user's electronic device, and placed therein, in a storage area associated with the trusted source. This storage area was created during the trusted storage system initialization process in process 1640. The user's electronic device, in one embodiment, also verifies a digital signature of the trusted source, using public keys obtained from the PKI during system initialization. In another embodiment, the device verifies a digital signature of the data service provider, to ensure that the data is received from trusted storage and not from a fourth party.

In the third phase of operation, the user accesses the trusted data. The user accesses the phone, computer, or other electronic device by authenticating the user's identity to the device, as described above in connection with FIG. 9. Once authenticated, the user may access the files stored in the secure storage area on the device. The PKI used in embodiments of the invention guarantees that only a properly authenticated user may access the trusted data. For example, the electronic device may contain a credential that permits this user, or other authorized users such as police, to access the information, but no others may access it. In a “push” model, the secure storage area already contains the relevant information. In this model, a user simply logs in to his or her phone or computer, using the appropriate multi-factor security model, and sees updated data. In a “pull” model, the user initiates a request to a data service provider (or to a particular business, which forwards the request) for trusted storage. In this model, the data service provider communicates the data to the user's device on demand. In either case, the data is transferred to the electronic device via a secure communications link, to avoid fourth parties altering the data or substituting their own data.

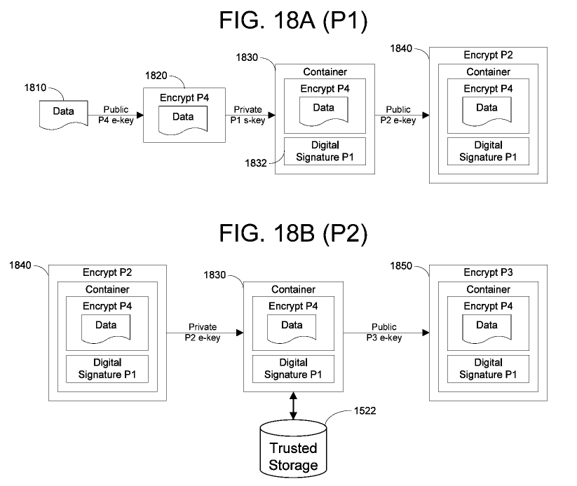

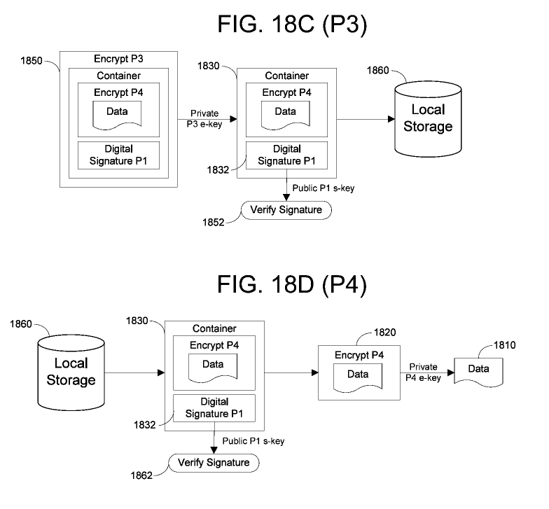

FIGS. 18A-18D (collectively, FIG. 18) show the flow of data in the system of FIG. 15A in a secure fashion between a business 1510 of FIG. 15A and a data consumer, for example the owner of smart phone 1424 of FIG. 15A in accordance with an embodiment of the present invention. As noted above, a party participating in a public key encryption generates a pair of keys, public and private. Such key pairs are generated for purposes including digitally signing documents (for authenticating the sender) and encrypting data. These purposes are important and distinct. While some parties may generate a single key pair for use with both purposes, other parties may generate two key pairs, one for signing and one for encrypting. The scope of this invention includes the use of signing keys (“s-keys”) and encryption keys (“e-keys”) separately, and references to these keys as distinct entities are made where appropriate; however, it will be recognized that these key pairs may be identical in some embodiments.

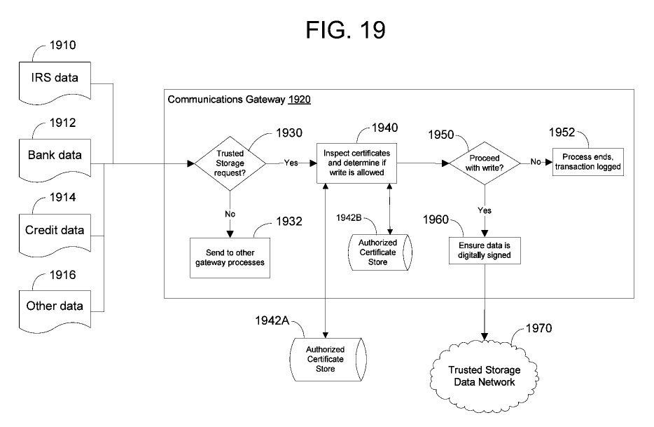

At least four parties participate in a trusted system: a business (party “P1”), a data service provider or trusted party (party “P2”), an electronic device embodiment in accordance with the invention (party “P3”), and a data consumer (party “P4”). Additional parties may participate as well; for example, there may be additional trusted parties or intermediate systems that handle the business data, such as described in connection with FIG. 19, or others as will be evident to those of ordinary skill in the art.

FIG. 18A is a block diagram of the flow of data at a business in a trusted system embodiment. The data flow of FIG. 18A occurs inside a business computer, for example server 1512 of FIG. 15A. The process begins with business data 1810. This data may be any data that the business P1 desires be securely transferred to the data consumer P4. In order to ensure data security, business P1 uses a PKI to retrieve consumer P4's public e-key, and encrypts the data 1810 using well-known techniques so that only a party having P4's private e-key may decrypt it (presumably, this party will be P4). Next, business P1 may wish to attest to the contents of the encrypted data 1820. Thus, business P1 uses its own private s-key (without using PKI) to digitally sign the encrypted data 1820 so that anyone with the data and P1's public s-key may verify the signature. Business P1 places encrypted data 1820, along with the signature 1832, in a signed container 1830. As described above, business P1 may decide to instead create a hash of the encrypted data, sign the hash, and place the data, hash, and signature in a container. In either case, the signed container 1830 is sent to a data service provider P2 for storage. As described above, business P1 may further encrypt signed container 1830 to avoid malicious tampering during the point-to-point communication. Thus, business P1 uses a PKI to retrieve the provider P2's public e-key, and encrypt the signed container 1830 using well-known techniques, so that only a party having P2's private e-key may decrypt it. The encrypted signed container 1840 can now be sent to the data service provider P2 in a tamper-proof form, even over an insecure communications link such as the Internet.

FIG. 18B is a block diagram of the flow of data at a data service provider in the embodiment. A data service provider P2 receives from a business P1 the encrypted signed container 1840 of FIG. 18A. Receiving here corresponds to process 1514, and occurs between the data flows of FIG. 18A and FIG. 18B. The provider P2 now uses its own private e-key (without using a PKI) to decrypt and retrieve the signed container 1830, much like peeling the outer skin off an onion. However the provider P2 cannot peel the ‘inner skin’, namely the encryption on the encrypted data 1820 in the signed container, because provider P2 does not possess, and generally cannot obtain, the data consumer P4's private e-key.

At this time, the provider P2 may perform the process of FIG. 17. Provider P2 may obtain business P1's public s-key using a PKI to validate the digital signature in the signed container 1830 using well-known techniques. If the P1 signature is valid, the signed container 1830 is stored in trusted storage 1522, as also shown in FIG. 15A. Business rules may instruct the provider P2 to forward (push) the signed container 1830 to electronic device P3. Or, in a “pull” model, the consumer P4 may request the signed container 1830. In either case, the provider P2 then uses a PKI to retrieve the public e-key for the electronic device P3, and encrypt the signed container 1830 using this key to form a second encrypted signed container 1850 for secure point-to-point transmission to the device P3.

FIG. 18C is a block diagram of the flow of data into the local storage of an electronic device in accordance with an embodiment of the invention. An electronic device P3 receives from a data service provider P2 the encrypted, signed container 1850 of FIG. 18B. Receiving here corresponds to process 1530, and occurs between the data flows of FIG. 18B and FIG. 18C. The device P3 uses its own private e-key (without using a PKI) to decrypt and retrieve the signed container 1830. The device P3 may use a PKI to retrieve business P1's public s-key to verify the digital signature in process 1852. The device P3 may also use a CRL or OCSP as described above to check whether business P1's public s-key has been revoked. If so, then the data in the signed container is out-of-date, and device P3 requests replacement data. This mechanism allows a business P1 to signal electronic devices P3 that, for example, a business data format has changed and a system-wide update is in progress. Electronic device P3 then requests new data without the intervention (or even knowledge) of the data consumer P4. The electronic device P3 stores the signed container 1830 in its local storage 1860 until the data consumer P4 requests it.

FIG. 18D is a block diagram of the retrieval of data from the local storage of an electronic device so that it may be consumed. A data consumer P4 first authenticates herself to the electronic device P3, for example as in FIG. 9. Authentication may include inserting a physical smartcard containing data consumer P4's private e-key into the device P3. Data consumer P4 may choose to re-verify business P1's digital signature in process 1862, by obtaining business P1's public s-key from a PKI. Data consumer P4 may wish to do this for a number of reasons, including that quite a bit of time may have passed between the storage of the signed container in FIG. 18C and the present access. Once the signature has been verified, data consumer P4 extracts the encrypted data 1820 from the signed container. Finally, data consumer P4 uses her own private e-key (without using PKI) to decrypt the encrypted data 1820, yielding the original business data 1810.

It may be seen from the above description that the end-to-end process of transferring data in a trusted system embodiment is secure. Each of the four parties uses a PKI in accordance with the embodiment to retrieve the public key of another party. Each of the four parties uses a private key to decrypt at least some data or create a digital signature. As each party in a PKI is the only entity that knows its own private keys, the system can only successfully transfer the business data end-to-end if all parties are who they claim to be, and all encryption and signature protocols are properly implemented. Also, the use of a CRL or OCSP ensures that the data arrives in a timely manner. The trusted storage system thus provides data from businesses to consumers in a secure and timely fashion.

Another embodiment performs encryption for point-to-point transmission differently. For example, one embodiment encrypts data using the sender's private e-key rather than the receiver's public e-key. In such embodiments, the receiver consults a PKI to retrieve the sender's public e-key to perform the decryption. The use of such an alternate embodiment may be advantageous in certain circumstances, as it shifts the additional use of PKI from the sender to the receiver, saving the receiver computing resources and network bandwidth. In another embodiment, the data service provider P2 uses its private s-key to digitally sign the signed container 1830 as an added assurance that the contents are correct. In this embodiment, electronic device P3 and the data consumer P4 take the additional step of using a PKI to retrieve the provider P2's public s-key to check the extra signature, and take appropriate action if the signature does not verify. Or, in yet another embodiment, the device P3 verifies the signature automatically, transparently to the consumer P4, so that consumer P4 never needs to know that provider P2 signed the container 1830.

FIG. 19 is a block diagram showing an embodiment of the present invention wherein a trusted data storage arrangement, such as illustrated in FIG. 15A, is coupled to a general communications gateway environment. The external communications gateway provides communications services to the trusted data source, for example real-time chat, email, single sign-on (authentication), web hosting, domain name system (DNS) provision, or other similar services. The communications gateway therefore is not dedicated to handling trusted data from a particular source, and in fact may not necessarily be dedicated uniquely to handling trusted data in other words, the communications gateway may also handle data other than trusted data. An example of such a communications gateway is Microsoft® Windows Live™ online services, although the scope invention is not limited to this example. In accordance with this embodiment, such a communications gateway may be integrated into a trusted system as described above, allowing the communications gateway to offer trusted data storage as an additional service. This embodiment enables one or more trusted data sources, such as a government agency, bank, credit issuer, or business, to use the communications gateway as an intermediary for placing data into trusted storage that is made accessible to a targeted individual, potentially reducing or eliminating significant system integration costs that might otherwise be borne by the organizations that originate the trusted data.

In the embodiment of FIG. 19, an organization data source (corresponding to item 1510 in FIG. 15A) originates trusted data destined for trusted storage of a targeted individual (using the computer 1420 or smart phone 1424 of FIG. 15A), as described above. In the fashion described herein, the gateway 1920 and trusted storage data network 1970 of FIG. 19 together implement some or all of the communication network 1430 of FIG. 15A. The data transferred in FIG. 19 may be Internal Revenue Service data 1910, or bank data 1912, credit issuer data 1914, or other business data 1916. The data source, for example, a bank, may have an online web site to support customer transactions. In the present embodiment of the invention, this web site, in turn, may be coupled to an external communications gateway 1920 to provide a variety of services to customers. The web site typically sends requests for certain URLs to its own web servers, and other URLs to the communications gateway for further processing, depending on the distribution of services between the host organization and the gateway organization.

Although some services offered via the gateway in this arrangement may include traditional ones such as chat and e-mail, the gateway 1920 of FIG. 19 may function in a new way to provide more secure communications. In accordance with this embodiment, a user requests a high value transaction, such as a balance transfer, from the web site. In response the data source sends a request for a secure transactional write to the communications gateway 1920. Gateway 1920 determines in process 1930 whether each request it receives is a request for a write into trusted storage. This determination may be made, for example, on the basis of the URL requested, or on information send along with the request such as HTTP headers. If the request is not for a write into trusted storage, in process 1932 the gateway 1920 sends the request to another gateway process for handling the request (e.g., a chat process). Otherwise, the request is examined in process 1940 to identify appropriate credential certificates for use in the trusted system, and to determine whether to proceed with the transaction. Process 1940 may consult an authorized certificate store 1942 to determine the validity of the credentials for both the data source and the end user. Authorized certificate store 1942 may be, for example, a CA or OCSP responder 1942A within the trusted system. Or, the store could be a memory on the end user device used to request the transaction. Or, the store could be storage 1942B internal to the gateway, or any combination of the above. As an added layer of security, process 1940 may send a secondary, out-of-band message to the end user to verify the transaction, as described below. In process 1950 the gateway determines whether to proceed with the transaction, based on the results of process 1940. If not, then the process ends and the failed transaction is logged in process 1952. At this time, the data source may also be contacted and informed of the failed transaction.

If the transaction should proceed, the gateway ensures that the trusted data is digitally signed in process 1960. If the data source provided the data to the communications gateway 1920 already signed, then process 1960 is complete. Otherwise, communications gateway 1920 must sign the data. If the data source has provided its certificate to the gateway in the authorized certificate store 1942, the gateway may sign the data on behalf of the data source. In this way, the data appears to the user as if it were signed by the data source in the first instance, allowing the operation of the communications gateway 1920 to remain hidden from the end user. Alternatively, the communications gateway 1920 may sign the data using its own credential certificate. In this way, a user may be assured that the data has been validated by the gateway, a party whose data security practices the end user may trust more than those of the data source. Once the data has been appropriately signed, it may be sent to trusted storage data network 1970 for distribution to trusted storage. Network 1970 may correspond, for example, to a portion of communication network 1430 which is connected to trusted storage 1522. From this point onward, the end user may retrieve the data from trusted storage in accordance with the process described above in connection with FIG. 15A. Optionally, the trusted storage 1522 may be hosted and managed by the operator of the gateway 1920. The end user is protected from data attacks directed to the operator of the communications gateway 1920 and of the trusted storage 1522 because the end user's data cannot be decrypted without the end user's private key, and the end user's private key is not in the trusted storage 1522 (as discussed in connection with FIGS. 18A through 18D.

In process 1940, the gateway may send a separate, out-of-band message to the user to verify the secure transaction. The message may be sent to a device other than the device making the original request. For example, the user may use a computer to access the web site of the trusted data source, while the gateway 1920 sends a verification message to a PDA, phone, or other mobile electronic device. Such a verification message can be a text message, a picture message, or in other suitable format. The end user may respond to this message by sending a permission code, such as a pin number, biometric data, or other credential. The end user may digitally sign the response for added security. The gateway 1920 may then verify the response, and decide whether to proceed as above.

This embodiment provides several improvements over current systems. As the verification message is performed out-of-band, the requesting device and the verifying device need not share data or communications services. Logging, tracking, and location services may be added to the gateway, to improve gateway performance and detect and prevent fraud on a real-time basis. For example, the gateway could determine to proceed in process 1950 only with transactions that have a low risk profile. Also, this embodiment gives an end user immediate notice of an attempted fraudulent transaction in her name.

### Trusted Storage on a Memory Device

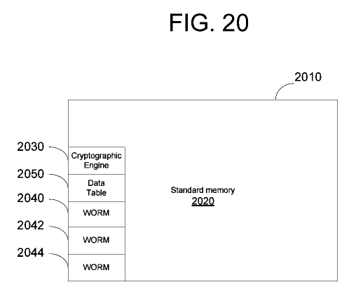

FIG. 20 is a schematic block diagram of another embodiment of the present invention showing a memory device including dedicated write-once, read-many (WORM) storage areas for trusted data. Memory device 2010 may be, for example, a Flash memory or other non-volatile memory device. One application of the memory device of FIG. 20 is for use in receiving secure data from trusted storage source 1522 as illustrated in FIG. 15A; the secure data may be deposited, for example, in flash memory associated with smart phone 1424 of FIG. 15A, and the flash memory may be structured as the memory device illustrated in FIG. 20. Memory device 2010 may contain several memory areas that serve different purposes. Memory device 2010 may have a standard, read-write memory area 2020, which may be used to store e.g. text and data files, web pages, image files, and so on. This area is configured as standard write-many, read-many (WMRM) memory. Memory device 2010 may also have memory areas useful for performing cryptography, such as memory area 2030 that has a cryptographic engine with instructions that may be executed on a microprocessor. Memory area 2030 may be used, for example, to implement the encryption functionality of a smartcard, in a manner described in connection with FIG. 8. Memory areas 2040, 2042, and 2044 are write-once, read-many (WORM) memory areas. These areas can be programmed with data only a single time, for example by physically burning a fuse or anti-fuse for each bit of memory. In this way, these memory areas offer protection against tampering with data stored inside. Such secure storage areas may be used to implement a smartcard, as described below. Memory area 2050 contains a table for cross-referencing data stored in WORM memory with other data, such as dates, times, memory addresses, processing instructions, and so on. Memory area 2050 may be used, for example, to locate a particular data file secured in WORM memory, or compile statistics on the status of WORM memory, or perform similar useful functions.

As described in connection with FIGS. 8 and 9, when a memory device 2010 is used to implement a smartcard, the device serves as a credential for the purposes of authenticating the holder of the device to a trusted system as described above. In this embodiment, WORM memory areas 2040, 2042, and/or 2044 are used to store credential data, such as biometric information or passwords. This data cannot be altered once written, thereby ensuring its security. The memory device 2010 may be combined with a mobile electronic device in accordance with embodiments of this invention (or another electronic device with similar secure functionality) as a substitute for a special-purpose smartcard device. The memory device 2010 possesses all the necessary functionality of a Hardware Security Module (HSM), and can therefore be used in any place a dedicated smartcard can be used. For example, by configuring the memory device 2010 in such a way that the memory addresses of WORM memory 2040, 2042, and/or 2044 are only accessible to cryptographic engine 2030, memory device 2010 provides a private storage area for private keys generated by the device. When used in combination with a mobile electronic device, memory device 2010 provides secure credential data for comparison with credential data provided by a user seeking access to the mobile electronic device, as described above in connection with FIG. 9.

In a further related embodiment, memory device 2010 is used as a repository of trusted data that resists tampering. For example, memory device 2010 stores a number of certificates in WORM memory 2040, 2042, and/or 2044. Such certificates are issued by a CA and programmed onto the memory device 2010 either before or after a user takes possession of the device. The cryptographic engine in memory area 2030 is employed to perform the cryptographic processes necessary to use a stored certificate in the customary manner known in the art, or for purposes related to virtual smartcards in accordance with embodiments of this invention. The write-once nature of WORM memory ensures that the certificate, once issued, cannot be deleted, replaced, or updated, thereby enhancing the security of the certificate against forgery. As an added security measure, a certificate expiration date may be stored in memory area 2050, and the cryptographic engine configured to as refuse to read WORM memory after the expiration date. In this way, data encrypted using the certificate's keys cannot be decrypted after the expiration date, and data signed using the certificate's keys cannot be authenticated. This security feature may also be accomplished by using software (not shown) to erase the association data in memory area 2050 after the certificate expiration date. In this way, the cryptographic engine will be unable to locate in memory the proper certificate to employ, thereby decertifying any data associated with that certificate. Thus, in accordance with this embodiment, after a certificate is deemed inappropriate for further use by the individual, the certificate is rendered unreadable, and any data associated with that certificate may no longer be read.

This embodiment lends itself to ready integration with a PKI infrastructure in accordance with this invention. A certificate stored on memory device 2010 may itself act as a unique characteristic of the device, transforming the device into a physical credential. This physical credential can be presented as an authentication token in accordance with, for example, the creation of a virtual smartcard as described above. Furthermore, the processes described herein for updating certificates, using summary certificates, and so on may be applied to certificates stored on memory device 2010.

Additionally, the embodiment of FIG. 20 lends itself to integration with a trusted storage system as described above. For example, memory device 2010 may be used as local storage 1860 of FIG. 18. Using techniques known in the art, the process of FIG. 18D is extended so that trusted data 1810 is stored first in WORM memory, so that subsequent operations on the data may verify that it has not been altered. Memory device 2010 is thus be employed as a vehicle for trusted business transactions.

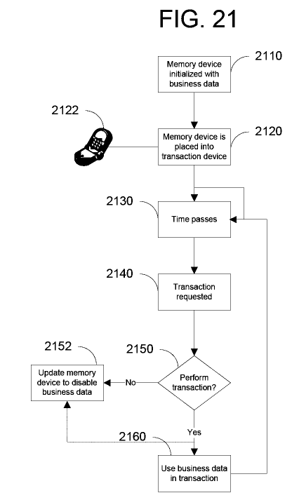

FIG. 21 is a block diagram, in accordance with a further embodiment of the present invention, showing a process for updating the memory device of FIG. 20 in a manner consistent with consumer needs and a relevant business environment. Memory device 2010 may store advertising for display to a user via a computer display or speakers. An advertising agency allocates a separate WORM area to each business, for example memory area 2040. The business places data in that area, such as images, sounds, web pages, software, or other advertising tools in process 2110. Further, the business may place data in memory area 2050 indicating that the business data stored in the WORM memory should expire under a particular set of conditions. The conditions derive from parameters such as time or number of purchases. Revenues resulting from sales generated by the advertising may be used to offset the cost of the memory device 2010, possibly allowing the business or device manufacturer to offer the device to consumers at reduced cost, or even no cost. Because the business data are stored in WORM memory, a user may be assured that offers and applications found therein are genuine, and not ‘phishing’ attempts for improperly obtaining the user's personal information. Thus, the memory device is used to enable a secure advertising and sales model.

Once the memory device has been initialized with business data in process 2110, the memory device is delivered to a user, who installs it into another, transactional device in process 2120. The transactional device is depicted as phone 2122, although it should be understood that the transactional device may be any electronic device capable of reading and writing data on the memory device. Next, a period of time passes, depicted as block 2130, until a transaction is requested in process 2140. The transaction may be requested, for example, by the user activating an application such as a web browser and viewing a page, or on a certain date, or after the passage of a period of time since the last time it was requested, or by another similar method. The transactional device 2122 then determines in process 2150 whether to perform the transaction, by consulting the business using a communications network (not shown), or by consulting business rules stored in the memory device. Process 2150 applies instructions or rules to determine whether to proceed with the transaction. If the transaction should not proceed, transactional device updates the memory device to disable business data in process 2152. This business data is in WORM memory, so disabling the data may involve updating a table such as the table in memory area 2050, as described above. If the transaction should proceed, the business data stored on the memory device in trusted storage is used to execute the transaction in process 2160. The business data may be usable only once, in which case the transactional device may optionally execute process 2152 to disable the business data. Otherwise, the business data is at a later time, as indicated in the figure.

A business may carry out and terminate an advertising campaign using this embodiment. For example, the business data stored on the memory device may be a credential certificate stored in WORM memory 2040, and advertisements stored in standard memory 2020 and digitally signed using the certificate. The business offers purchasers of the memory device a trial product or service, where the offer is good until a certain date, or for a number of days after the first use of the memory device, or until a retail version is purchased. The business can revoke the credential using PKI methods known in the art, and this embodiment will invalidate the corresponding certificate, thereby effectively disabling the advertisement. If the same certificate is installed on many memory devices by repeatedly applying process 2110, revocation of the certificate will disable all of the advertisements on all of the devices. Such an application is useful, for instance, to cease advertising a certain discontinued product. Or, different certificates could be used on each memory device, allowing the business to revoke only that device's certificate when the user purchases a retail version of the trial product or service. The advertisements may be downloaded from the business automatically, and may be replaced by new advertisements until the certificate is revoked. Advertisements may also be statically installed on the memory device in process 2110.

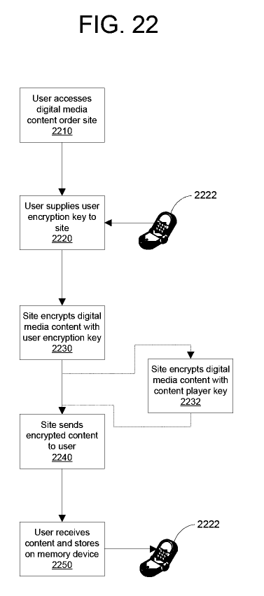

FIG. 22 is a block diagram, in accordance with a further embodiment of the present invention, showing a process for downloading digital media content to the memory device of FIG. 20. This process enables a digital media content distributor, such as a record label or movie distributor, to provide downloadable media content (music, movies, or other content in digital form) to individuals so that only that individual may play the content.

An individual begins the process by accessing a digital media content order site in process 2210. The individual will typically browse the site to find appropriate media content for download. After the individual selects the content, she supplies the site with a public encryption key unique to herself, in process 2220. Software at the site then encrypts the selected digital media content according to well-known methods, using the user encryption key in process 2230. Optionally, in process 2232 the software may also encrypt the media content using a second encryption key associated with a media content player installed on an electronic device of the individual. Although the figure depicts the user encryption before the player encryption, these may occur in any order Once the content is encrypted, it is sent to the individual in process 2240. Sending is done via any communications medium having sufficient transfer speed to ensure that the transfer will complete in a reasonable length of time. In process 2250 the individual receives the encrypted content, and stores it on the memory device of FIG. 20.

The public encryption key used in optional process 2232 may be unique to the individual's media content player, and may include information about the particular hardware or software configuration of the device on which it is installed. However, the public encryption key used in processes 2220, 2230 is unique to the individual, not to any particular hardware or software. The latter may be a private key obtained from a smartcard or other physical credential, or it may derive from a virtual smartcard in accordance with an embodiment of this invention, such as described in relation to FIGS. 8 and 20, among others. The user encryption key may be stored on a mobile electronic device 2222 or on another electronic device. The key may be stored in the memory device of FIG. 20. Or, the key may be stored in a public key storage area, in accordance with PKI standards.

Because the public encryption key is unique to the individual, only that individual's paired private key may be used to decrypt the media content. Thus, only someone in possession of the private key (presumably the individual) can unlock the content. This restriction permits copies of the encrypted content to be made without the chance that the content can be played by others (notwithstanding that related embodiments may employ copy-protection mechanisms). Also, unlike some current systems, a user may access the content on devices other than the one used to select and download the content. The media content is thus both portable and playback-protected.

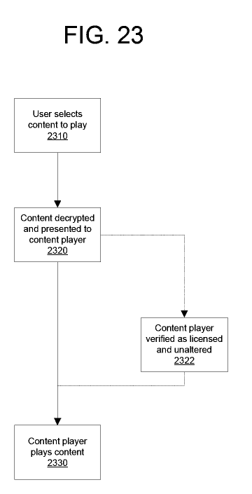

FIG. 23 is a block diagram, in accordance with a further embodiment of the present invention, of a process for playing digital media content, from the memory device of FIG. 20, after the content has been downloaded according to the process shown in FIG. 22. At the beginning of the process, the media content has been encrypted using a key unique to the listener, and optionally a key unique to a media content player. In process 2310 the listener first selects the content to be played. This selection may be made, for example, by clicking a file icon in a user interface, inputting a command into a command window, selecting a file name in a media content player, or other similar method. In process 2320 the content is decrypted and presented to the appropriate content player. Decryption includes decryption using a user private key, and may include decryption using a content player private key, depending on whether optional process 2232 was followed. Once the content has been decrypted, the media content player has access to the media content in its native format. In optional process 2322 the content player verifies that it is licensed to play the content. This process may include analyzing playback restrictions that accompany the media content, sending a request to a central licensing server to determine that the player executable file is unaltered, or other processes known in the art. In process 2330 the content player plays the media content, i.e. renders it in an auditory, visual, or audiovisual manner.

The use of a user encryption key in FIGS. 22, 23 in embodiments of the invention permits the distributor of media content to retain control over the playback of the content, even if the content is freely copied. Thus, risk of infringement of a copyright held on the content is reduced, as individuals are less likely to copy content that they know they will be unable to play. Alternate embodiments include additional processes for preventing or restricting copying in the first instance, providing additional restrictions on the playback of the media content, and curtailing copyright infringement by taking any other steps that are enabled by this invention.

The use of the user-specific encryption key is enabled by embodiments of the invention described herein, and in particular by the combination of PKI embodiments, trusted storage embodiments, and secure transaction embodiments. These embodiments, and others described herein, can be combined in other applications which may be apparent to a person skilled in the art. The scope of the invention also includes these combinations.

### Pre-Caching of Certificate Validation Requests

In order to provide rapid response to data requests across a network, several different strategies have been followed depending on data types and requirements. In the case of certificate validation, one industry practice has been to pre-construct necessary data packets and distribute them though the Internet to secondary certificate authorities (CAs) closer to the actual usage, thus providing less hops and more servers to respond to the validation requests. This is a sound strategy for small numbers of credentials, but breaks down as the number of credentials increases. When hundreds of millions of credentials need to be distributed, and the potential number of distribution sites rises into the thousands, the network traffic to load the distribution sites with the necessary certificates becomes very large, and the computers at those sites need to be specialized in order to handle the size and number of potential requests. This problem increases each day as the number of certificates continues to grow and the number of secondary sites requesting them grows proportionately.

Consider as an example, one hundred million credential certificates in use globally. Suppose that there are 1000 sites scattered around the world acting as certificate caches, each of which must re-verify each certificate once per day. Suppose also that each verification request requires the transfer of 1,500 bytes. Multiplying the numbers, merely verifying the certificates worldwide will result in a daily bandwidth cost of 150 terabytes (150*10¹² bytes). Current network systems would find this a significant load. Additionally, because of the amount of data transfer, network configuration issues would likely force most secondary CAs to reside outside corporate boundaries, resulting in the potential for a man-in-the-middle data attack.

The likelihood that an individual will need to authenticate on more then a few servers is very low, however. For example, in the case of physical access described above in connection with FIGS. 11-13, an individual can only be in one part of the globe at any given time. This is true for any type of access that requires a physical presence. In the case an individual wishes to travel to a satellite office complex to access a computer, only a small subset of individuals will need to validate over more than just a few networks. By monitoring an individual's usage patterns and physical locations, it is possible for a single validation site to fetch and load only the certificate status responses that are likely to be requested at that site, thereby greatly reducing the size of the data load both locally and globally. Such an approach reduces the data set to be moved to a size compatible for storage and access within an enterprise firewall, and allows data transfer systems to eliminate the man-in-the-middle attack.

In one embodiment of the present invention, the decision of where to cache response data is made on the basis of geographic positioning. By the use of cell phone location, which may be obtained using e.g. a cellular network or a global positioning system (GPS), a cache local to an area may load only the status responses of people found in that area. For example, if a company employee travels to Paris and needs access to a building in Paris, then only the company's Paris certificate cache would validate his certificates using the originating CA. The other corporate caches around the globe would not need to load his status response data. The Paris cache could be collocated with the physical access server inside a Paris office intranet, providing a secure physical access request infrastructure.

In another embodiment of the present invention, the decision of where to cache data is made on the basis of site-specific usage patterns. The validation response servers request from an originating CA only those responses they are likely to need based on the credential requests they have served over a recent timeframe, for example the previous 24 hours. The servers which already track credential requests provide the certificate numbers, and forward those numbers to the appropriate caches. Again, this embodiment eliminates from the cache the credential data of all those who do not use the service, and keeps the number of validation responses to the originating CA small.

When validating a certificate, a security system may first consult its local cache. In the event a response is not found, the system reverts back to the standard way of producing a response; that is, it will issue a request back to the certificate authority. This back-up procedure is normally slow; however, because it is only used in the exceptional case, the overall validation response time is improved and the overall network load is reduced. In one embodiment, the validating system may request a nonce, or one-time cryptographic data, to protect the request to the originating CA. Requesting a nonce may be too expense to do for every request, but here it is used only when there is a cache miss. Use of a nonce protects certificate validation requests against a man-in-the-middle attack when a local cache does not contain the appropriate certificate.

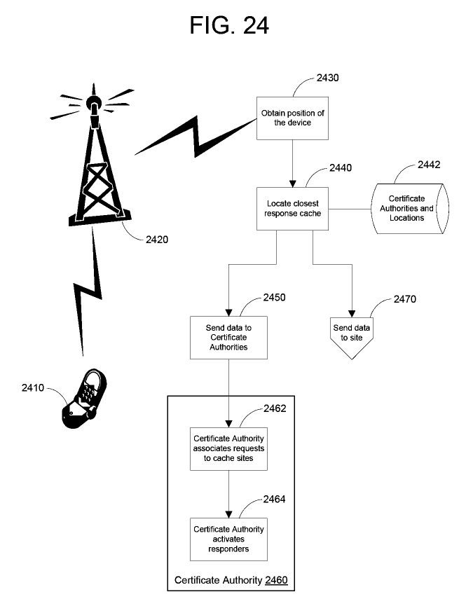

FIG. 24 is a block diagram, in accordance with embodiments of the present invention, of processes for determining sites that require cached credentials. The figure depicts a process of determining response-caching sites based on geographic positioning, as described above. In accordance with the embodiment shown, an individual who requires services enabled by credential verification, possesses a mobile electronic device 2410, shown here as a cell phone. This cell phone is detected by a positioning network 2420. Using algorithms known in the art, in process 2430 the network 2420 determines the distances of the phone 2410 to each of a number of reference points, thereby providing an estimate of the individual's location. In one embodiment, accuracy of only hundreds of feet is sufficient to determine a caching site. In this embodiment, network 2420 may be a cellular telephone network, wherein the reference points are cell towers. In another embodiment where caching sites are densely distributed, a Global Positioning System (GPS) may be employed for finer spatial resolution. In an embodiment using a GPS, the reference points may be satellites in orbit above the Earth. Other positioning networks 2420 that provide this functionality may be used in accordance with embodiments of this invention.

In process 2440, the device position is correlated to the positions of the caching locations to determine the closest response cache, using methods known in the art. To perform process 2440, a database 2442 containing the locations of the response caches may be consulted. The database may contain any information necessary to associate a physical location with a certificate authority, including geographic coordinates (latitude and longitude), cache names, Internet addresses, physical and logical topologies of data networks, a list of users whose certificate responses are authorized to be cached at a given location, and any other useful information.

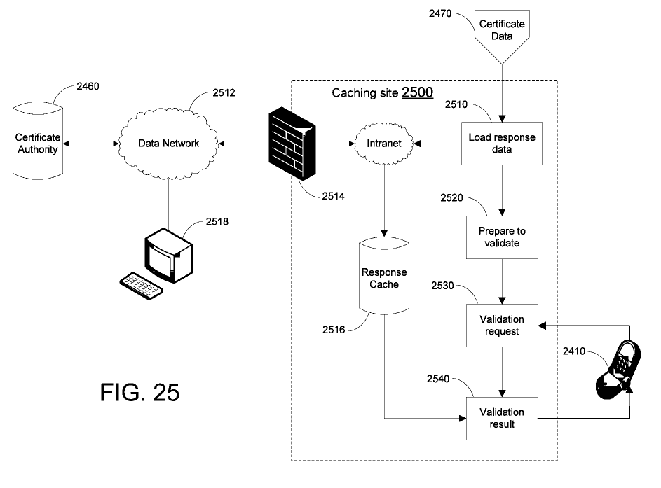

Once an association has been made between a caching site and a CA, two paths are followed. In process 2450 each CA 2460 is notified of the certificates for which it will have to serve validation responses. In process 2462, each CA prepares to serve validation responses by associating each potential request with a caching site from which it is expecting that request. This process allows CAs to deny requests for status responses from locations other than that of the device 2410 authorized to carry a certificate. Thus, process 2462 provides the system with an additional layer of security. In process 2464, each CA activates its certificate status responders to respond to validity status requests. In the second path, process 2470 sends each caching site data representing the list of CAs that site may be contacting to validate certificates. The site then caches credentials from each CA, which has activated a responder to validate those credentials, as depicted in FIG. 25.

FIG. 25 is a block diagram, in accordance with an embodiment of the present invention, of caching credentials at a site determined by the processes of FIG. 24. Certificate data is received at the site 2500 in process 2470. In process 2510, the caching site 2500 determines the CA to contact for each certificate, and loads the response data. If current response data is already in the response cache database 2516, process 2510 need not request another validation status. Otherwise, in one embodiment the caching site 2500 sends a validation request for each certificate to the appropriate CA 2460 using a data network 2512. In another embodiment, the validation request is deferred until actually required by a user. As described above, these requests may contain a cryptographic nonce for additional security. The responses are then stored in database 2516. Database 2516 containing the sensitive response data may be advantageously located behind a network firewall 2514, and therefore inaccessible to a malicious user (man-in-the-middle) 2518.

In process 2520 the caching site prepares to service authentication requests. Process 2520 may include, for example, activating point-of-sale devices (e.g. credit card readers), physical access systems and headends, web servers, and other devices and processes. In process 2530 the caching system receives a request to validate a certificate from mobile electronic device 2410, according to a process described above. By way of example and not limitation, process 2530 may be a request for physical access to a secure location, executed as part of process 1250 depicted in FIG. 12, or a request to access trusted storage as part of process 154 as shown in FIG. 15B. In process 2540 the caching site accesses its response cache database 2516 to determine whether the presented certificate is valid. If the response is not present, then the site requests a response from CA 2460. If the response is present, the site determines a validation result is process 2540. The site may then return that result to the device 2410 as depicted. If the result is favorable, then the site instructs the service for which the validation request was made to proceed.

### Edge-Trusted Computing: Associative Storage

This section provides another perspective on various concepts discussed above, particularly in the section immediately above and the section entitled “Batch Certificate Processing” and in connection with FIG. 10 and related figures. In order for two parties to perform transactions in a trusted way using a chain of trust, the chain should be validated in two ways. First, the integrity of the chain is tested by walking the chain and checking the signatures of each cross-certificate until a trust anchor is reached. If a single signature is invalid, then the chain itself is invalid. The second check is performed on each certificate in the chain, and may be done as each certificate's signature is being checked. The second check ensures that the cross-certificate is still valid, by consulting a certificate revocation list (CRL) or by making an OCSP request, as described above.

Within an enterprise, performing these processes is fairly straightforward, since they may be done by a single administrative entity; however, cross-enterprise trust is different, and presents further complications. The paths leading from one enterprise to another, and the lengths of the trust chains, can both become quite large. For example, for any given two users in different enterprises, thousands of potential validating CAs give rise to millions of potential trust chains between them, and verifying each chain may require dozens of OCSP requests. Even under the best of conditions, locating a complete trust chain and validating it could take several seconds, which for many transactions is too long. To date, systems have used the non-linear approach of contacting central servers to validate chains, but this approach will not handle the volume of transactions and certificates required to deploy PKI systems to the general population. This problem of scale is one of the reasons usernames and passwords remain as a primary security measure.

The problems of cross-enterprise trust may be addressed in accordance with embodiments of the present invention by moving trust transactions to the ‘edge’ of the enterprise namely to the mobile electronic device (phone or PDA) used to enter into a transaction. In such embodiments, the phone acts as a CRL or OCSP cache for the purposes of validating its own certificate. A possible caching mechanism is described in connection with FIGS. 24 and 25 above, although other caching processes may be used. Thus, the phone provides precisely the information necessary for the other (trusting) party to a transaction to validate the trust chain of a certificate presented by the phone. The remainder of the trust chain is contained in cross-certificates already possessed by the trusting party, obtained and stored according to processes convenient to the trusting party. Thus, at the time of the transaction, a trusting party no longer needs to contact a central validation server or OCSP responder to validate the entire trust chain.

The functioning of such a system is aided by the convergence of two facts. First, a phone may be uniquely associated with an individual, through the use of strong authentication protocols. Thus, the multi-factor authentication processes described above, especially in connection with FIG. 2, permit a phone to be used only by a single person (with certain strictly delimited exceptions as described herein). Thus, a relying party may be assured that the individual possessing and presenting a phone to enter into a transaction is the individual whose credentials, stored in the phone, are being offered for use in the transaction.

There are two requirements for such a system. First, the phone user and the relying party must agree on a trust endpoint (CA) to sign the certificate presented by the user through the phone. The parties must agree to a common CA, because that CA will be used to link the two partial trust chains of each party into a complete trust chain that the relying party may validate. Second, the phone must possess and transmit a certificate validation response having certain qualities to the relying party. The relying party may want assurances that the validation response presented by the phone user is reasonably current. This goal may be achieved by regular cache refreshes, for example, every three hours, twice each day, once each day, or at any other interval. Each validation response may include a timestamp, so that the relying party may verify its recency. Or, the validation response may not include a timestamp, in which case the phone includes, in its transmission to the relying party, additional data allowing the relying party to infer the likely time that the response was generated. These data may include, among other things, the time that the phone most recently connected to the validation network (e.g. Internet or cellular network), and the length of time the phone was connected to the network. As an example, if the phone were last connected the day prior to the transaction for ten minutes and the day before that for five hours, and if the caching mechanism refreshes every three hours, than it would be reasonable to infer that the validation response was likely not updated during the ten minute window, but was certainly updated during the five hour window, and thus that the response being presented for use in the current transaction is two days old.

Different trusting parties may employ different logic, based on each party's risk tolerance, for processing such connection information. Consider two examples: a parking meter purchase and a car purchase, both on credit. The amounts involved in renting a parking space tend to run to a few dollars at most. Thus, the owner of the space may be willing to accept a lower level of assurance that the credit credential being presented by a phone to a meter is still valid. In this context, discussed in some detail above in connection with micropayments and FIG. 27, the decision whether to allow a transaction proceed can be premised on data received from the smartphone by the micropayment device indicating that (i) the smartphone has been connected to a network for a period in excess of, for example, 15 minutes within the past 24 hours and (ii) the credential on the phone is still functional. (We assume here handling of certificate revocations using batched transactions as described above in connection with FIG. 10.) This small transaction can be reasonably handled with such an inexpensive determination of certificate status.

However, the amounts involved in purchasing the car that occupies that space are generally much higher, and the owner of a car dealership may require much higher assurances that the credit credential is still valid. In this example, the merchant may require as a condition of allowing the transaction to proceed, an active determination of non-revocation of the pertinent credential. Such a determination may involve a communication from the merchant to the CA (or a validation authority in communication with the CA); in this communication, the merchant sends the identification number of the certificate carried in the phone of the user (exposed to the merchant by the user's two-factor authentication to the phone). In response to this communication, the CA provides status information pertaining to the certificate. In fact, the dealership may require multiple forms of identification credentials, as well as access to the credit of a co-signer, access to a credit report from a major credit bureau, and other assurances beyond simply the credit card number of a would-be purchaser. Thus, knowing that the credential is valid is only a starting point for the dealership to enter into a transaction with the owner of a phone.

Between the levels of risk involved in the parking meter scenario (phone connected to the network and the certificate not revoked) and the automobile purchase scenario (concurrent determination, by merchant communication with CA, that certificate is not revoked), is an intermediate level of risk involving actively pushed certificate status information that is stored on the phone. In this scenario, at periodic intervals, for example, a message is sent from the CA to the phone indicating that the certificate has not been revoked, and this status information is stored on the phone in association with the certificate. Under this scenario, the merchant accessing the certificate gets status information concerning the certificate at the same time.

Generally, edge-trusted transactions occur in three scenarios. The first example involves two networked organizations having individuals attempting to exchange data. The method currently used in the art is to retrieve the chain of trust and validate each cross-certificate from both organizations using verification authorities (VA), which are typically centralized certificate authorities. However, this process is inefficient the two organizations already trust each other enough to enter into a transaction. Instead of consulting a central authority to determine whether an agent or employee is trusted, each party may simply query the other party, thereby pushing validation to the edge. The internal details of one party's validation process should be unimportant to the other party, the important issue is whether each party trusts the other to properly validate its own employee's certificates. The encryption employed in PKI ensures that this validation can be trusted. The only certificate that needs to be validated by each organization is its own trust anchor. This validation can be done on a regular basis (e.g., every three hours, enterprise-wide) and updated to each agent or employee phone as needed. The complexity of validating the trust chain, and changes to the process, are hidden from other parties. A relying party simply receives a yes or no as to the validity of a user without the details. With this methodology the expansion an external storage of trust chains is unnecessary. Each party answers the question, “is this certificate valid”. As described above, this answer can be precompiled and distributed for improved performance.

Each party no longer needs to possess an entire trust chain. Instead, the party merely determines whether or not the other party may be trusted. Each party still receives an end entity certificate and a validation response to provide assurance that the certificate is valid. The computational effort to validate certificates is distributed among the parties, and unnecessary intermediate checks to walk trust chains are removed. It is the responsibility of each organization to represent the trust of the individual, and not for the inquiring party to hunt through trust chains. It is also simple for each organization to verify that an end entity's certificate is valid. Each end entity is paired with at least one anchor, making easy to find out immediately if that end entity is available to enter a trusted transaction without building a huge database of trust chains.

As an example of the usefulness of this embodiment, consider Microsoft's Active Directory (AD). This software is an implementation of directory services, similar to LDAP, for authenticating and authorizing services in Microsoft Windows environments. AD maintains trees (‘domains’) of certificates, and each tree requires the same administration privileges. Thus, joining the certificate trees of two organizations that likely have different privilege structures is difficult at best. Even accessing domains or subdomains of a foreign tree requires the creation of various trust models (one-way, two-way, transitive and intransitive trusts, and so on). However, in accordance with this embodiment of the present invention, certificate trees no longer need to be joined, and access is greatly simplified. Each domain or subdomain in a foreign tree may be queried directly, without the need to set up complicated trust models.

The second major scenario involves an individual transacting with a networked device. In current systems, it is important that an enterprise validate a certificate it has received from an individual in order to send transaction data to the individual using the proper encryption keys. However, in embodiments of the present invention, this need not be the case. Consider the exemplary situation where the user requests data through a trusted gateway, as described above in connection with FIG. 19. The gateway service validates the individual's credentials before data or log on is permitted. The user requests, directly or indirectly, that this data be forwarded to the gateway. By gating the transaction through an intermediary trusted party, this scenario may be transformed into the scenario as described above. The enterprise uses the certificate from the gateway without checking it, as before, because it need not concern itself with validation details. (The chain of trust for the certificate was walked by the gateway when the user created an account with the gateway and added a certificate to the account.) There is thus no reason for the enterprise to check the chain's validity at the time of the transaction. This shortcut represents a large reduction in network and cryptographic load for the enterprise. The gateway's business policies ensure that a certificate is not presented to the enterprise for access to private data unless the certificate is valid and current. The enterprise will become aware that a certificate is not valid or current when the sending of data using that certificate's keys fails. The overhead here is not significant, as the gateway can ensure, through certificate management processes known in the art, that certificate invalidity occurs in only a tiny fraction of total requests (if ever). There is no need for the gateway to distribute validation responses to the enterprise, because those responses are stored with the user.

As another example of this embodiment of the invention, consider an individual who wishes to withdraw money from an automated teller machine (ATM). Typically, a credit card company has a contract with a bank to allow the bank to offer a credit card branded with the company's name. However, to access the actual credit card account from a bank ATM, the banks must be tied to the credit card company. This is accomplished by the creation of interbank networks, such as STAR (First Data), PLUS and INTERLINK (Visa), PULSE (Discover), and CIRRUS (MasterCard, Diners Club). Creating these networks requires data integration between each bank and the credit card company, and maintenance of the networks gives rise to ATM usage fees. However, with an edge trusted computing embodiment, an ATM could verify that an individual has sufficient credit to make a given withdrawal using only data on the phone. Then, the ATM could generate a debit record encrypted with the public key of a credit processor. The individual would be unable to tamper with the record, so it is safe to transfer the record to the phone for upload to the credit processor for debiting at the next update cycle. Combined with pre-caching of certificate validation responses having expiration dates and daily limits on withdrawals, this system ensures that no individual can withdraw money exceeding their available credit limit. Additionally, in this embodiment there is no need for interbank networks to transfer debit information to a credit processor, as a cellular telephone network (or the Internet) assumes that role. Thus, in this embodiment of the invention, ATM fees may be reduced or eliminated. The expense passed on to the individual by an alternate network provider for shifting data transfer from an interbank network would likely be less than current ATM fees.

The third major scenario involves transactions between an individual and a non-networked device. The individual requests data or a service from the device, by sending a packet that contains a certificate, a trust chain (excluding the anchor), and the OCSP validations for the elements of the chain. The device has all information needed to validate the individual's certificate except the anchor certificate in the message. However, the device has negotiated a particular anchor to use in the transaction, as described above, and has validated this anchor prior to the transaction. All the computations to validate the entire trust chain may thus be done without any network validation requests. The device encrypts the transaction data, and the individual can validate the entire returned data set. This process works because the paths in each trust chain are hidden, and all validation can be done inside the domains (i.e., hardware or software) of the individual and the device. The certificate validations are performed on the individual cell phones and transactional devices (parking meters and so on), making this approach scalable and avoiding the storage of unnecessary, redundant data.

### Preventing Replay Attacks

Embodiments of the present invention are designed to prevent replay attacks, where eavesdropping by a third party on a communication, for example, between a user's smartphone and a terminal device can be used to capture data that are replayed for use in a transaction not authorized by the user of the smartphone. A replay attack typically takes advantage of the fact that valuable data, such as a certificate status response for an individual, are transmitted over a network. This response is typically used legitimately by the individual. However, a third party may intercept the data for later fraudulent use. In particular, the third party fraudulently present the saved data as a legitimate response to a status query for the individual's certificate, thereby causing a relying party to believe erroneously that the third party is, in fact, the individual.

To prevent these types of attacks, a PKI provider in currently available systems must typically take several steps designed to verify that the certificate status request actually reached a party who can legitimately validate it (i.e., the issuing CA). In a typical scenario, the relying party, for example, a merchant, will create a cryptographic nonce, or one-time message. The merchant then encrypts the nonce, along with the certificate validation request, in a message to the CA using the CA's public encryption key. The CA decrypts the message, and transmits the nonce and the response back to the merchant, this time encrypted with the CA's private encryption key. The merchant can decrypt the reply (again using the CA's public key), and verify that the nonce is the same as the one originally sent. The security of the system relies on the fact that the reply returns in a span of time too short for a malicious third party to intercept and decrypt the message, and determine the nonce (which is unique to the request). It also relies on the merchant having an accurate copy of the CA's public encryption key.

However, approaches such as described in the previous paragraph do not scale well. A principal reason is that the data traffic experienced by the server of the CA is proportional to the number of certificate status requests involving certificates it has issued. In addition, the certificate authority is a central point of failure, and is also vulnerable to denial of service attacks. For example, if the Visa CA is taken offline by a denial of service attack, merchants would be unable to verify that Visa credential certificates presented by patrons were still valid. In turn, they would have to make a choice as to whether or not to honor the certificate, knowing that the credit card might have been revoked.

Embodiments of the present invention overcome the scalability and single point of failure problems, by modifying the above procedure for validating certificates. In one embodiment, rather than contact the CA directly, a merchant contacts a validation gateway. (For example, Windows Live, a service of Microsoft Corporation, Redmund, Wash., which today operates as a password storage vehicle, could be established to operate as a validation gateway in the manner described herein.) In this embodiment, the merchant transmits a nonce and status request, as before, using the cryptographic keys of the gateway. However, in this embodiment, the transmission is to the validation gateway, and here the validation gateway acts in effect as a proxy for the CA. The validation gateway returns an encrypted certificate status response to the merchant, along with the nonce, which the merchant can verify as before. In this way, the validation gateway shoulders the brunt of the validation traffic. This is a desirable outcome, as the gateway may use a significantly more robust infrastructure (established for the purpose of validation), than a particular certificate-granting agency or organization, such as a state Department of Motor Vehicles.

In another embodiment, the mobile electronic device (smartphone) used in a transaction may itself carry validation data. As discussed in the previous section, this embodiment can be effectuated by actively pushing certificate status information to the phone. Thus, at periodic intervals, for example, a message is sent from the CA to the phone indicating that the certificate has not been revoked, and this status information is stored on the phone in association with the certificate. Thus in this embodiment, the merchant accessing the certificate gets status information concerning the certificate at the same time. In a related embodiment, the certificate status information is sent from the CA first to the validation gateway described in the previous paragraph. Then the validation gateway pushes the status information to the smartphone, where it is stored, as before, in association with the certificate. As discussed in the previous section, because there is typically a delay between the time when the status information is pushed to the smartphone and the time when a merchant may want the status information, this approach carries a greater risk than the approach described in the preceding paragraph. On the other hand, it has a reduced overhead, and may suffice for a wide range of transactions.

In a related embodiment, the validation gateway and the smartphone used in a transaction both contain the same validation data. The phone receives, as before, the pushed certificate status data from the CA. In addition the data is pushed to the validation gateway, as discussed above in connection with batch processing of certificate validations and FIGS. 10, 27, and 28. Thus, a merchant may query an individual's phone in addition to querying the validation gateway, to compare the responses. If they differ, then the merchant may suspect a replay attack and take any corrective measures, such as requesting a different method of payment, in addition to reporting a possible attempt to enter a fraudulent transaction to a credit issuer.

### Restricted Communications

With the growth of the Internet, cell phones, and other digital electronic communications channels, it has become possible to contact minors in an anonymous and potentially inappropriate manner. However, communications channels in accordance with embodiments of the present invention may be opened in such a way as to prevent anonymous contact with minors. Indeed, in various embodiments, many useful restrictions may be placed on communications channels, to provide various desirable features: forming a limited list of parties to the communications, limiting the age of the other party to a communication, limiting the geographic location of the other party, and so on.

In one embodiment of the invention, all data being communicated to a recipient is identified with a identity certificate signed with the sender's public key. By validating the certificate, all data can be traced to the originator. Further, by providing information in the identity certificate such as age of the party, name of the party, geographic location of the party, and other useful information, a software program may filter would-be communications based on pre-selected criteria. For example, in a related embodiment, in order to pass the filter anyone attempting to contacting a minor is required to have a valid identity certificate showing that the person is younger than a given age, or within two years of the minor's age. In this embodiment, the minor may not initiate a conversation with an adult, or vice versa. Thus, would-be predators are deterred. However, certain adults may be granted access. The filter may be configured to recognize the certificates of the minor's parents or teachers, for example. In a similar related embodiment, the filter is configured by a parent to allow a child to contact only those on a ‘whitelist’ of allowed friends, thereby achieving a similar result. In another embodiment, a web site requires each visitor to present an identity certificate before displaying web pages, and refuses to display certain pages to those presenting certificates belonging to minors. In this way, minors are shielded from viewing age-inappropriate materials, without the active oversight of their parents. Techniques for programming filters are known in the art, but in accordance with this invention, the data being input to a filter from an identity certificate is attested by the presence of a digital signature. Devices that process the certificates may contain a list of acceptable certificate signers, to prevent individuals from creating and signing their own age data.

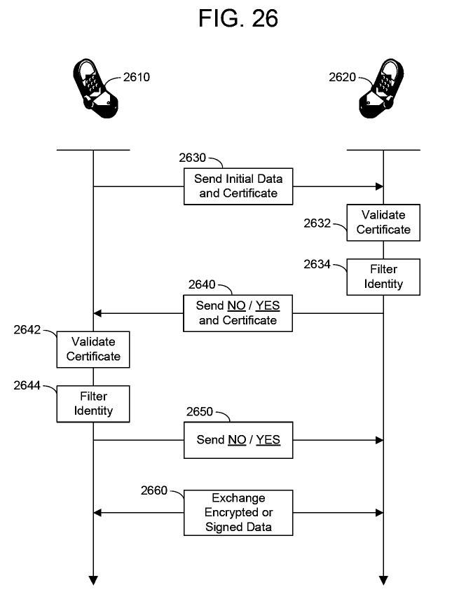

FIG. 26 is a block diagram of a further embodiment of the present invention showing processes for initiating communications between two parties. A first initiating party is represented by phone 2610, and a second responding party is represented by phone 2620. Although the parties are represented by cell phones 2610, 2620, it will be understood that the invention is not limited to this exemplary embodiment. The initiating party attempts to open a communications channel by sending a request to the responding party in process 2630. The request includes an identity certificate, and may include communications parameters such as bandwidth, a communications protocol designation, encryption keys or encryption algorithm initialization vectors, or other initialization data. In process 2632 the responding party uses information in the identity certificate, such as the initiating party's name, to validate the certificate using methods described herein or those known in the art, thereby demonstrating the authenticity of its contents. In particular, the certificate may be signed using the initiating party's private key, or the private key of a third party trusted by the receiving party. In process 2634 a relevant parameter is extracted from the identity certificate, and processed using a filter. Parameters may include, without limitation, the age of the initiating party, the party's name, and the party's geographical location. These parameters, alone or in combination, may be used in the filter to determine whether phone 2620 is configured to accept communication. The result of this determination is sent to phone 2610 in process 2640. If the result is NO, then the process terminates, and a communications link is not established. If the result is YES, then phone 2620 may send an identity certificate of the responding party. In this case, the initiating party proceeds in a symmetrical fashion to validate the responding party's identity certificate in process 2642 and to apply a criteria to information from that certificate in process 2644. It should be noted that the criteria used in processes 2634, 2644 may be different, as the two parties may have different groups of peers with whom they are willing or able to communicate. As before, process 2644 results in a decision whether the party is configured to accept communication, and the result is returned to the responding party in process 2650. As before, if the result is NO, a communications link is not established. If the result is YES, then each device is configured to communicate with the other, and a link is established. From this point, phones 2610, 2620 may exchange communications with each other in process 2660. In order that the communications may be guaranteed against interception and man-in-the-middle attacks, the communications may be encrypted, as described above in connection with FIG. 18, or each portion of exchanged data may be digitally signed. It will be understood that processes 2632, 2634 may be performed in any order, and similarly for processes 2642, 2644.

Purchases, Including Those without Divulgation of Credit Card Number

Credit card fraud is a large and growing problem. The ease with which a credit card number may be obtained (especially over the Internet), the relatively low risk of detection, and the potentially high reward for obtaining a credit card number combine to create an strong enticement for would-be criminals. Once obtained, a person may use a credit card number to fraudulently purchase goods or services over a telephone, in a scenario known as “card not present.” Credit card companies have attempted to address the problem of fraud using various security measures, including the introduction of a security number imprinted on the physical card or encoded in a card's magnetic stripe, known variously as a Card Verification Value (CVV), Card Verification Code (CVC), or Card Identification (CID) number. Such codes have little security value if the physical credit card on which they are located is stolen.

When a charge is made via a phone in accordance with embodiments of this invention, however, a transaction from the phone to the credit processor company does not need to reveal the credit card number. Instead, for example, the hardware security module on the phone may encrypt the credit card number and charge amount with the public key of the appropriate credit card processor. The seller of the product or service never possesses the credit card number in an unencrypted form. All the seller can do is forward a message with the encrypted data to the processor, and the encryption algorithm ensures that only the processor can decrypt the number. After the processor verifies that the credential is valid, the seller receives an authorization code, similar to the credit processing systems of today. The credit card number never leaves the buyer's phone unencrypted, thereby making the number secure for the transaction.

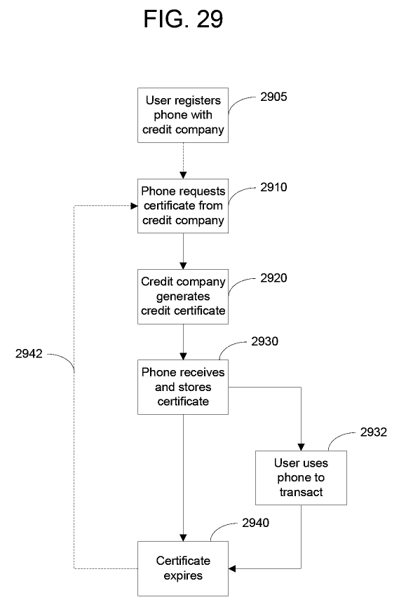

FIG. 29 is a block diagram of a method in accordance with an exemplary embodiment of the present invention, in which a phone as described above is prepared and used in card-not-present transactions. In process 2905 the owner of the phone preliminarily registers the phone with the credit card company, using identity credentials of the owner and the phone to uniquely associate the phone with the owner. The owner's identity credentials were created earlier, as described in connection with FIG. 2A, while the phone's identity credential is described in connection with FIG. 1. Once process 2905 is complete, the credit card company has identified the owner and the phone, and is ready to accept requests for credit authorization. In process 2910 the phone requests a credit authorization certificate from the credit card company. This request may be made over any data network, including the cellular telephone network and the Internet. A request may include an amount, for example $500. The request may include an expiration date, such as 24 hours. By combining these data into a single request, the phone may request an authorization for $500 per day. Other obvious combinations of request parameters are contemplated. This functionality permits the phone to limit the amount of credit that is ‘borrowed’ by the phone during any particular period of time.

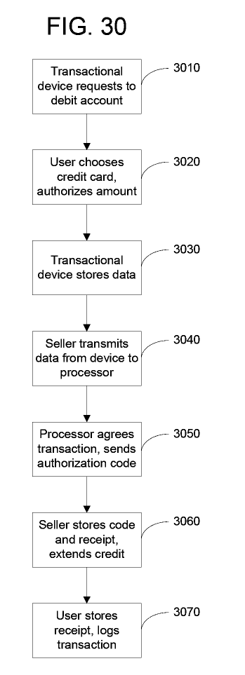

After the credit card company receives such a request, in process 2920 it generates a credit certificate for the phone. This certificate is unique to the phone and to the owner, and has data recognizable only by the credit card company, such as a nonce encrypted with the company's public key. In process 2930 the phone receives this certificate from the credit card company, and stores it. The phone's hardware security module now has the credit card certificate, and when combined with software on the phone, may generate payment tokens for use in card-not-present transactions. A transaction is represented by process 2932, and is explained in detail below in connection with FIG. 30. At some point later, in process 2940 the credit certificate expires, and the user or phone may request a replacement certificate, as indicated in the figure by line 2942. Such a replacement certificate will have a different cryptographic nonce, thereby assuring the credit card company that the certificate is not being reused (‘replayed’) at a later time. In an alternate embodiment, the credit certificate does not expire, but remains valid until it is revoked by the credit card company. Such an alternate embodiment is useful, for example, in scenarios wherein the phone does not (or cannot) connect to a data network for an extended period of time, such as when the owner takes the phone on travel to another continent with an incompatible cellular network. Non-expiring credit certificates may be used to make purchases in such situations, especially when used in combination with cached validity responses as described above.

FIG. 30 is a block diagram of a method for extending credit to an individual having a phone prepared as in FIG. 29. As an example, suppose the individual wishes to purchase a meal she has just consumed. Preliminarily, a waitress totals the charges, and obtains a billing folder to present to the individual. The folder may contain the customary paper bill, but also embedded within the folder is a small transactional device, for example a microprocessor, memory, and short range wireless transceiver. Bluetooth, or another short range wireless protocol, may be used for compatibility with the individual's phone. The waitress programs the transactional device with the charge information, and presents the folder to the individual. Other sellers of goods and services may take other steps to prepare to transact with a customer, but the preparation will be substantially the same.

In process 3010 the transactional device posts a request to the phone that a seller wishes to debit an account of the individual. Typically, in response to receiving this request, the phone notifies the individual that a charge has been requested, by flashing an indicator light, displaying an interaction dialog, or other suitable means. After the individual authenticates herself to the phone, as described above in connection with FIG. 9, software on the phone asks her for an authorization and debit amount. The individual may have stored certificates for several credit accounts, e.g. Visa, Mastercard, American Express, or Discover, in the course of preparing her phone as described above. She may now choose which of these certificates she wishes to expose to the seller. In process 3020 she exposes a credential certificate carrying the name of the credit processor, and encrypts an authorization for the debit amount. The encrypted authorization and amount is sent to the transactional device, which stores this data in process 3030. In process 3040 the seller or seller's agent (i.e., the waitress) takes the transactional device to a merchant computer, where data is read from the device and sent to a credit card processor. Communication with the credit card processor may be done using methods and data networks known in the art. In process 3050 the credit card processor agrees to the transaction, and returns to the seller a payment token containing an authorization code. Such authorization codes are known in the art, and signify to the seller that the processor recognized the party as one having an account containing sufficient credit. As part of process 3050, the processor reads the cryptographic nonce stored in the certificate in process 2920 and validates it using a private encryption key. In process 3060 the authorization code is stored to the transactional device, along with a receipt. In process 3070 the individual's phone receives the receipt from the transactional device and optionally stores a record of the transaction in a record log.

In the above embodiment, the work flow in the exemplary restaurant does not change. The credit card number is never exposed to the seller, thereby making it secure, and a second tip transaction is avoided, thus reducing costs to the seller. These processes may be used in other situations where a seller requires a credit card authorization to extend credit, and the scope of the invention includes these other uses and situations. In an alternate embodiment, the user may only write a phone number on the paper bill. The merchant may then transmit that phone number, along with the purchase amount, to the credit processor, who calls the number. In response to the phone call, the phone receives certificate data from the credit processor, and presents a message to the user that the processor wishes to debit the user's account. From this point, the process may continue analogously to that depicted in FIG. 30, i.e. the credit card processor, having received a response from the phone over the cellular network, can proceed directory to process 3050 and accept the transaction. Optionally, the processor can transmit to the phone a receipt for the transaction immediately, while the phone call is ongoing.

With only a slight modification, the above processes may be followed to allow an individual to make a secure purchase using a desktop computer on the Internet. In order that the process might work, the phone may be connected to the computer via a Universal Serial Bus (USB) connection, or other wired or wireless connection. Resting the phone in a docking cradle may provide this connection, as well as allowing the individual to simultaneously charge the phone. Then, rather than receiving a transactional device in a physical folder, the individual receives an order page on a website. Software on the individual's computer passes data from the page to the phone. Such software is known in the art, an example being Microsoft ActiveSync, which exposes an API allowing a web page to discover whether a phone is present, and to discover the phone's cryptographic capabilities. The user authenticates herself to the phone as before, authorizes the transaction and amount, and transmits these data to the seller (by an Internet connection rather than a short-range wireless connection). In some embodiments, this out-of-band authorization may be sufficient for dollar amounts only up to a certain limit, such as the user's credit limit. The seller's website then forwards the data to a credit card processor, receives an authorization, and completes the purchase, in a manner analogous to that described above. The individual receives an order confirmation page containing a receipt, which software on the computer forwards to the phone for recordation.

This process improves privacy, by making information purely transactional. An individual's credit card number is used to generate a specific transactional message that has no value outside of its context. If the message between the seller and the processor is intercepted, it has no value to the interceptor. This embodiment allows individuals to buy something without disclosing anything about themselves. Their data is protected by their identity certificates, which must be validated before they can use any information stored on the phone. With a widespread deployment of these embodiments, parties no longer would have to exchange credit card numbers, only authorizations to receive money. These embodiments of the invention thus enhance both security and privacy, while making secure and trusted transactions easier. In addition, by providing receipts to both the purchaser and the merchant, these embodiments lend themselves well to fast fraud detection, as described above in accordance with FIG. 10.

### Phone as Source of Stored Credentials for Use in Lieu of Passwords

Single sign-on systems allow a user to store logon credentials for many different Internet services in a single location. The user can then access the central location using a single password, and ask the system to log the user onto a chosen service by transmitting an authentication token. In this way, the user does not have to remember dozens or hundreds of different passwords or credentials. In effect, the single location acts as a ‘wallet’, containing credentials for the user

Single sign-on systems are typically implemented as large, central password repositories that are administered by a company in which the user must place significant trust. While all credential data are encrypted, many attack vectors exist to recover the data. For example, the password must be sent in clear text at least for some part of the transport between the user and the requested service, and the repository typically protects stored passwords for large groups of users with a single storage key. The prevention of multiple logons from different locations is also difficult, due to the stateless nature of HTTP. In fact, since the central server has no contact with the user, a lost connection or a second logon are difficult even to detect. While providing some convenience to the user, the security and privacy overhead for storing passwords centrally is high, and systems that need to communicate for speed need redundant data and services. These types of services are also subject to denial of service attacks, due to their central location in the logon topology. Further, many existing repositories work with different services and do not interoperate, requiring users to maintain accounts with several repositories.

By placing the user credentials on a cell phone and updating the phone with OCSP responses, single sign-on embodiments of this invention have several benefits over existing systems. First, the credentials are stored in a mobile electronic device over which the user has direct, physical control, so there is no need to place trust in a third party storage company. Second, the number of attack vectors to recover the stored credentials is greatly reduced, because the credentials are in the physical possession of the user. Even if the user loses the phone, in order to access the credentials in software, an individual must first authenticate to the phone as described above in connection with FIG. 9. Even if a malicious individual disassembles the phone, the credentials may be stored in trusted storage, such as a Flash memory card with smartcard capabilities, as described above in connection with FIG. 20, to which the individual must present proper authenticate to unlock the credentials. Further, the credentials may be encrypted between the phone and the service, eliminating another attack vector. Third, by storing logon state on the cell phone, it is now possible to determine if a second logon is attempted by another user, as described below. Fourth, it is no longer necessary to contact a central server to have single sign-on functionality. As a corollary benefit, additional network traffic is not required during the sign-on process. As another corollary benefit, denial of service attacks are mitigated, as there is no central server that can be targeted for attack. Fifth, there is no need to integrate several different repository services, and the system may be realized using currently deployed PKI technology. Finally, the system provides for true lock-out of compromised credentials. If the password of an individual to an account in a current central storage system is compromised, the account can be deactivated by the system, but such deactivation does not also deactivate the various logon credentials stored within the account. However, the credentials on a phone can only be accessed using the private key of the individual who owns the phone. So if the individual's identity certificate is revoked for whatever reason, all of the associated logon credentials are instantly rendered useless, thereby guaranteeing the security of the associated accounts.

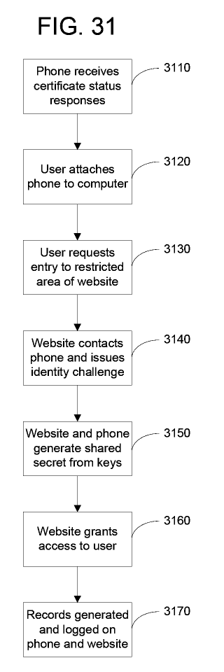

FIG. 31 is a block diagram showing the operation of a single sign-on embodiment of the present invention. In process 3110 the phone queries for and receives a daily certificate status response for each of the logon credentials stored in the phone's trusted storage. In an alternate embodiment, the response could be cached, as described above. In process 3120 the user attaches the phone to his computer, using USB, Bluetooth, or a cellular network. (In some phone embodiments already containing a web browser, wherein the user is seeking to access a web site directly from the phone, this step is unnecessary.) In process 3130 the user navigates to a website and identifies his user name for entry into a restricted area. Normally, at this point, the website would request the user's password. However, in process 3140 in this embodiment, the web page uses special software to contact the user's phone to issue an identity challenge. The user authenticates himself to his phone, as described above in FIG. 9 (not shown). In process 3150 the phone and site validate certificates and perform a key exchange to generate a shared secret, each party using its own private key and the other party's public key. Such exchanges are known in the art: the Diffie-Hellman key exchange is a widely known example. If the shared secret is identical for both phone and website, then the website may permit access, as in process 3160. Advantageously, the shared secret may now be used to perform symmetric cryptography between the browser and the site. Once access has been granted, the phone and website generate records of the access, and store them locally in logs in process 3170. These logs may be compared later using batch processing, as described above in connection with FIG. 10.

This sequence of processes does not exchange any private information the validity of the user's identity certificate is all that is required for entry into the secured area. Any secondary logon to the site will be detected by the phone, and a message will be sent to the site that the same user is logging on from another location. The site may then act in accordance with site rules to address the multiple-logon situation. In an alternate embodiment, the user need not even enter a username. Instead, this information is replaced by a certificate number, or kept on the phone in a database allow the user to keep this information in one place. Finally, because this embodiment uses standard PKI logic, one can build upon it to create a set of single sign-on protocols that are interoperable across systems and sites.

### Preventing Multiple Contemporaneous Accesses to Secure Sites

Physical perimeter controls are often set up at incident sites. An authorized individual is checked by security personnel, and allowed in the site if her credentials are acceptable. Nevertheless, such a system properly processes only those individuals who choose to enter the site through the front door. Generally speaking, security is only as strong as its weakest point, and the front door is usually not a location's weakest entry point. Malicious individuals may enter through lower-security areas, and once on-site, may gain access to unprotected areas without undergoing further security checks.

What we have said in the context of perimeter controls for physical access applies equally to access to computing resources, including to computer systems and to web sites. More generally, “access control” thus can refer to control of physical access or to control of access to computing resources. An access control system may be foiled not simply by avoiding the “front door” but also by a fake or copied credential

In accordance with an embodiment of this invention, the above problems may be addressed through storing a token on a mobile electronic device. At the front door, which may be a physical barrier or a logon screen, when an individual is permitted on site, a token is placed on the phone. The token includes one or more credentials from the phone, so as to associate the token uniquely to the phone. The token is signed using a private key of the access control system. Each point in the interior of the site can validate that the gatekeeper was seen and passed properly, by (1) determining that the token is present on the phone, and (2) assuring that the phone has an original token (as opposed to a copied token) by verifying that the credential used in the token matches a corresponding credential of the phone. Only phones containing the proper token may be used to access secure areas. The token cannot be used on another phone that has different identity credentials. Using this embodiment, it becomes possible to thwart duplicate entry even at interior points that have a lower threshold of security, and even if a passed user attempts to copy a valid token to another phone.

### Secure and Portable HTTP Cookies

HTTP connections, used in web-page based sessions between a user and a web site, are stateless. In order to preserve session state, many websites employ cookies, which are name value pairs that are retrieved from the website on one connection, and sent by the browser to the website on a subsequence connection. For the most part, cookie data are maintained in clear text in a web browser or on a user's hard drive, making this information easy to maliciously forge or alter. In addition, cookie data are typically stored on the computer running the web browser, so that if the user wishes to access the website from a different computer, he must re-establish his cookies. In particular, cookies containing logon data will be missing on the second computer. In other words, current implementations of cookies are device-specific, not user-specific.

In accordance with embodiments of this invention, cookie data are encrypted end-to-end, between the website and a mobile electronic device like a phone or PDA. By encrypting the cookies this way, we can realize several important advantages over plain-text cookies. First, users of the computer running the browser cannot read the cookies. The browser itself may continue to store the (encrypted) cookies as normal, but the data stored within are useless to anyone who attempts to simply read them from the hard drive. Second, state is kept securely on the phone. The cookie data are stored in encrypted form on the phone, and only decrypted inside the phone's cryptographic hardware (hardware security module). Third, state can now move between devices. The previous problem of establishing cookies on a new computer is solved, because the phone acts as a cookie storage device. A user merely connects his phone to the new computer, and all of his state is recovered. Last, the key used to encrypt the cookie data can be based in part on the user's identity credentials. Thus, the cookie data may only be decrypted by the user, even if the cookie data are copied to another phone.

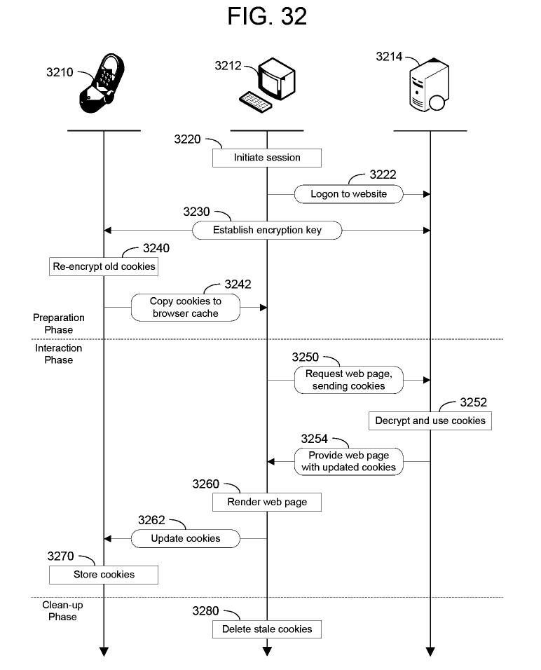

FIG. 32 is a block timing diagram of an embodiment of the present invention in which cookie data are end-to-end encrypted. The depicted embodiment shows a three-phase process for end-to-end cookie encryption. In the first, preparation phase, a web browser 3212 establishes a new session with a web server 3214. In the second, interaction phase, the web browser and web server interact within the session, using cookies that are stored on, and encrypted by, a phone 3210. In the third, clean-up phase, stale cookies are removed from the browser cache, leaving the browser in a pristine condition for the next user or session. It should be noted that the web browser 3212 may run on the phone 3210 as an application; in such a case, it should be noted that cryptographic secrets on the phone are stored in a hardware security module, and are inaccessible to other phone applications.

The preparation phase begins when the browser 3212 initiates a session in process 3220. Typically, the session begins when the browser requests a logon page from a website, although a session may be restarted due to an inactivity timeout. In process 3222 the user interacts with the logon page to logon to the website, using methods known in the art or in accordance with embodiments of this invention. Now, in process 3230, the web server 3214 and phone 3210 establish a shared secret, or ‘session key’. This session key is used to securely transfer cookie data between the phone 3210 and web server 3214. It may be established using any technique for doing so known in the art, especially, for example, the Diffie-Hellman key exchange described above. This shared secret is known only to the phone 3210 and web server 3214, and not to the browser 3212. Furthermore, the shared secret is stored in the phone's hardware security module, so that even someone in possession of the phone may not easily extract it. The session key itself may be re-established each time a new session begins, providing additional security. To do so, a timestamp, or even a completely random number, may be used as the input into the shared secret generation algorithm. Once the session key is established, existing cookies left over from previous sessions are optionally encrypted with the session key in process 3240. Process 3240 may require that the stored cookies that were previously encrypted with an old session key be decrypted. To this end, the previous session key is stored in a hardware security module of the phone 3210 (i.e., in an internal smartcard, or in an identity credential of the owner having a smartcard with an HSM). Or, the cookies may be decrypted using another private key (for example, a private key of the phone or of the owner) if they were encrypted with that key for intra-session storage. When the cookies have been encrypted using the proper session key, in process 3242 they are copied to the browser cache for use by the browser, completing preparation for interacting with the website.

Once the user has logged onto the website, the interaction phase begins. This phase may be repeated a number of times during the course of a single session. First, the user directs the web browser 3212 to request a web page in process 3250. Typically, the server 3214 will require cookies to construct the requested web page. Thus, these cookies are sent with the web page request, using methods such as HTTP headers that are well known in the art. Cookie metadata, such as domains and paths, are kept unencrypted so that a browser 3212 may identify in process 3250 the proper cookies to send in any given request. In process 3252 the web server 3214 receives the cookies and decrypts them using the session key established in process 3230. Using the decrypted cookies, the web server 3214 creates a web page and creates or updates cookies. In process 3254 the web server provides the web page and cookies to the browser. The cookies that the web server provides in process 3254 are encrypted using the same session key established in process 3230. By using a symmetric encryption and a shared secret, no network communication by the web server to validate certificates is required for the server to perform cookie decryption. In process 3260 the browser renders the web page provided in process 3254. The web page may contain instructions, such as Microsoft ActiveSync described above, for updating cookies on the phone in optional process 3262. In this way, each web page may ensure that any cookies it sends are properly stored on the phone 3210. If a page contains these instructions, then the phone stores the new or updated cookies in process 3270. Regardless of whether these cookies are immediately stored on the phone, once the browser has rendered the web page in process 3260, the user is free to begin the interaction phase again by requesting a new web page in process 3250. Any cookies that were provided in process 3254 were encrypted using the session key, which the web server can use to decrypt them.

Once a sessions ends, the clean-up phase occurs. In process 3280 the cookies are deleted from the browser cache and moved to the phone, where they are stored, encrypted, until the next session is started. Deleting cookies from the browser cache keeps the computer running browser 3212 ‘fresh’. Storing the cookies on the phone makes them portable and secure, requiring no complex network or server interactions.

### Real-Time Certificate Updates

In current systems, there are two methods to check whether a certificate is still valid: checking a Certificate Revocation List (CRL) that is regularly updated, and checking status in real-time using an interactive status protocol. In the first method, a Certificate Authority (CA) provides a CRL to anyone seeking a list of revoked certificates. This list is produced on a regular basis, and contains all revoked certificates that have not expired. In the second method, a certificate's status is requested interactively. The status may be obtained from the CA, or produced from a batch process when the CRL is produced. The interactive request requires complex computations, and requires the CA to provide Internet connections that form a security risk.

In current systems, there is a lag time between actual revocation and notice of the revocation to users. Hundreds of servers need to be updated with millions of statuses, providing additional delay. In a typical example, the Department of Defense may require 18-24 hours for the notice to propagate to interested users. Thus, there exists a window of up to 24 hours for a malicious individual to take advantage of a revoked certificate.

However, real-time updates are possible in accordance with embodiments of this invention. As revocations are produced at a responsible CA, the CA determines which cellular devices are associated with the revoked certificate, as described above in connection with FIG. 7. In particular, process 760 includes informing parties that rely on the certificate revocations. These parties, or nearby caches, may be determined as described above in connection with FIGS. 24 and 25. Typically, less than 0.01% of certificates are revoked each day. Because of the low volume, updating is a low cost process. The receiving phone can confirm the reception of the status, and the update is completed in seconds instead of the hours or even days that the update might take in current systems. CRL lists are as short as one entry long, because of the frequency and rapidity of these updates.

To ensure that the security of the system cannot be defeated, the relying party to a transaction must be assured that the cell phone presenting a certificate has been recently connected for sufficient time, and that there are no outstanding updates to the certificate's revocation status. We have described a number of methods of ensuring security of the system above under the heading “Batch Certificate Processing”, including discussion of FIG., 10 and related figures. There are two cases to consider. If the relying party requires low to moderate assurance, the relying party device is likely a cellular device as well. It therefore can determine that connectivity is available and that the device offering the certificate has connectivity. Under these circumstances the relying party can depend on the phone's being updated and accurate. If there is no cellular signal available, then various timing factors are applied as described above in connection with FIG. 27, and depending on the location and status the relying party will determine whether or not to grant access.

On the other hand, some systems, such as physical access systems, require high levels of assurance. In these systems, the cellular system supplies updates to phones in the same venue as the relying parties. Now, an acknowledgement system is used, whereby each phone must acknowledge each revocation update that it receives. A phone's refusal to acknowledge a revocation update triggers the CA to notify relying parties using the same cellular tower. Depending on load, the system can send a message to all relying parties with phones that have rejected requests or could not be notified within the acceptable parameters. This real-time system updates the requester, and also notifies relying parties of failures.

### Secure Electronic Car Keys

An increasing number of cars are being equipped with smart car keys. A smart key is a key that contains a small fob or circuit for sending a cryptographic message to the car in order to enable the car to start. Any holder of the key fob can start the car—the fob does not authenticate its user before activation.

In accordance with an embodiment of this invention, the car authenticates its owner using PKI. The car's PKI hardware and/or software is embodied in the car's computer system, or in a separate system if necessary. The owner's hardware and/or software is embodied in a key fob, or in a cell phone or PDA. In the latter cases, a car key per se is no longer necessary, as the purpose of the key is to authenticate its holder to the machinery, to gain access to the passenger compartment and to the starter motor. In accordance with this embodiment, the cell phone performs the authentication. Further, if the phone key certificate is revoked, the car will not start. Such a use may be very desirable to, for example, the holders of defaulted car loans who need to repossess an automobile. Merely by revoking a certificate, the driver of the car can be prevented from driving off, thereby reducing or eliminating tense confrontations between the driver and a repossession agent.

In a related embodiment, the key's use may be restricted to certain dates or times by adding software to the phone. This embodiment is useful to car rental companies, who may deactivate cars when they are not rented. In this way, a renter who exceeds the terms of his rental agreement may be prevented from entering the passenger compartment, and must call the rental company to reactivate his key. (Luckily, perhaps, his key is embodied as a cell phone.) In another related embodiment, the key software may use a GPS device in the phone. In this embodiment, the key may monitor the position or speed of the vehicle, which is useful to ensure that the driver is not exceeding a posted speed limit. Those skilled in the art may appreciate additional uses for a PKI-based car key that are within the scope of the invention.

Similarly, a user, having a secure electronic car key, may also permit another person to drive the user's car by providing transfer of a proxy credential to the other person's phone. The proxy credential include conditions of use (for example for only three days) established by the user.

### Phone as Gateway for Trusted Data Acquisition and Storage

The mobile electronic device as described above, and especially as embodied as a smartphone, acts as a “personal” endpoint in a secure data distribution network. The endpoint is “personal,” in that access to the network may be obtained only by the person who is authorized to use the particular endpoint. The network is secured using the various encryption schemes described herein, or their obvious variations.

A wide range of electronic data gathering devices can utilize a smartphone in accordance with an embodiment of the invention to take advantage of the personal and secure nature of this network. There are a proliferation of data devices available in the market that collect data personal to an individual in some way. Some of these devices may be found in the smartphone itself: for example, cameras and microphones for recording video and audio data. Some devices are not found in the phone examples of these external devices are external audio or visual equipment, thermometers, glucose meters and other medical devices, radar guns, computers, tape recorders, and even other, wire-line telephones. An expanded PKI network as described herein may be expanded to incorporate these devices securely, so that the data gathered from, and even displayed using, these devices may be associated to a single individual and a single mobile electronic device.

By way of illustration only, and not by way of limiting the invention, this process is given concrete description below using a glucose meter (glucometer) as an exemplary data gathering device. The exemplary meter has a lancet for pricking the skin and drawing blood, a sensor for detecting the amount of glucose in a blood sample, and a digital video and audio display for reading out the detected glucose level and other information useful to a patient. The device also has a short-range wireless transceiver, such as a Bluetooth transceiver, and a cryptographic module, such as a hardware security module on a smartcard, for transacting with a smartphone connected to the PKI network. The device may be configured or disabled remotely. The exemplary glucometer is battery operated. Other devices, such as those listed above, and similar devices not listed for the sake of brevity, can be adapted by those having ordinary skill in the art to embody the invention described herein without undue experimentation.

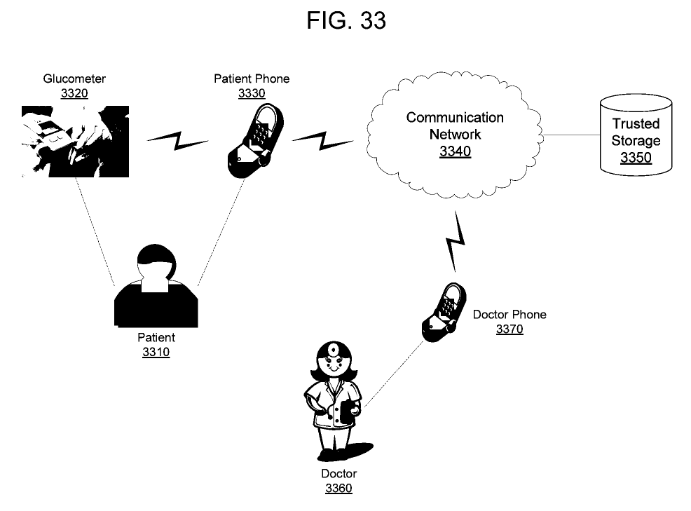

FIG. 33 is a diagram showing the different components used in a method for acquiring data with an electronic data gathering device and publishing the data to trusted storage for later retrieval by a trusted individual, in accordance with an embodiment of the invention. An individual, such as patient 3310, possesses the exemplary glucometer 3320 and a smartphone 3330, as indicated by the broken lines. The glucometer communicates with the smartphone using Bluetooth, or other communications technology. In this embodiment, the patient receives glucometer 3320 from his doctor 3360 at a visit in which the doctor programs the glucometer with encryption information, as described more fully below. Patient 3310 proceeds to use glucometer 3320 according to its intended purpose; however, in embodiments according to this invention, the glucometer automatically transmits its glucose reading to smartphone 3330. Upon receiving the data, smartphone 3330 attempts to save the data to a medical database in trusted storage 3350. In particular, smartphone 3330 will determine which communications network 3340, if any, may be used to upload the data. If none is available, smartphone 3330 may wait for a period of time and retry the upload. This process is repeated until the upload succeeds. Once the data have been uploaded, the patient's doctor 3360, or other authorized individual, may use her own smartphone 3370 to access the medical data stored in trusted storage 3350, using processes described above.

The above process generally requires some initialization before it can work as described. A patient is first vetted using appropriate health system standards. For instance, research into the patient's medical history may be conducted in order to satisfy insurance requirements. Once the patient is qualified to receive the device, a medical computer system issues digital encryption credentials. These credentials, in the form of public and private encryption keys, may be used to verify the patient's identity or the device identity, encrypt and decrypt medical records, or communicate securely with the data gathering device. The medical computer system also issues certificates for these credentials, which are stored on the smartphone and the device.

The data gathering device is programmed with several encryption keys and certificates. Programming may be done during an office visit or consultation, for example. In order for the doctor to program the device, the device itself must be present, along with access to the user's key. This key is stored on the user's phone, which the patient brings to the doctor's office. The doctor may access using a docking station or cradle. The docking station itself may connect to the data gathering device using a data connection. Or, the docking station may be a computer, in which case the device is programmed by executing a suitable computer program, connecting the phone and device to the computer in turn. Once the key is stored in the device, the onboard cryptographic module may use the key to encrypt and decrypt data. Although the example of a glucometer is used, other medical and non-medical embodiments of the invention may use analogous initialization procedures to prepare the device for use.

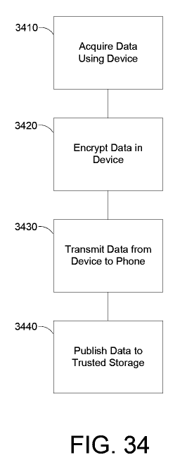

FIG. 34 is a block diagram of the process for uploading data in the method of FIG. 33. The method begins with process 3410, in which a user acquires data using a data gathering device. In an exemplary embodiment, a glucometer senses a concentration of glucose in a patient blood sample. In process 3420 the gathered data are encrypted in the device, using a public encryption key of the phone's user. As described above, this key was pre-programmed into the data gathering device. In process 3430 the encrypted data are transmitted from the device to the user's smartphone. Because the data are encrypted such that only the user may decrypt it, the transmission in process 3430 may be done without further channel-level encryption, although such encryption may be optionally performed using device-specific encryption keys for the data gathering device or the smartphone. Once the data appear in the smartphone, the phone attempts to publish it to trusted storage in process 3440. In process 3440 the phone attempts to contact trusted storage using several alternate forms of communication. In an exemplary embodiment, the phone may attempt to access a wireless cellular telephone network or the Internet. When a connection is established, the phone uploads the data to the trusted storage database. Once stored in the database, the data are now available for retrieval by appropriate, authorized individuals, such as doctors, police officers, co-workers, or others. An individual may be authorized to view that data based on several criteria which are discussed above. For example, data regarding a patient's blood glucose may be released to the patient's doctor, but also to an emergency medical technician (EMT) at the scene of an emergency if the EMT requests the data using proper, verifiable medical credentials in a mobile electronic device.

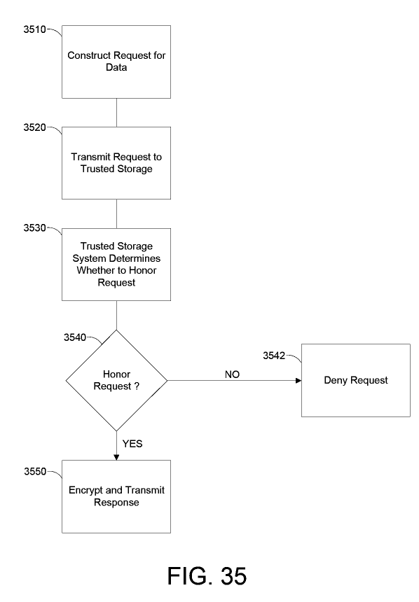

FIG. 35 is a block diagram of a method for a trusted individual to access data acquired and published as in the embodiment of FIG. 34. In process 3510 an authorized individual constructs a request for the data. Such a request may take the form of a database query, for example. This request also contains cryptographic information regarding the requesting individual, including that individual's credentials and certificates, or sufficient information to locate them. The credentials may be sent in the form of a digital resume, as described above. In process 3520 the request is transmitted to a system having control over the trusted storage. The request may be sent using any convenient mechanism, including web-based services. In process 3530 the trusted storage system determines whether to honor the request for the data. The determination includes evaluating at least the credentials of the individual, and may incorporate such other factors as the system operator or application requires. These factors are contained within trust chains associated with the patient, or other data depositor. When the appropriate information has been assembled and evaluated, and all trust chains have been walked and validated, process 3540 determines one of two outcomes. If the request should be denied, in process 3542 a denial notice is sent back to the requesting individual, and appropriate security measures may be taken to validate the access. If the request should be honored, in process 3550 the data (after being decrypted using the individual's private key) are thereafter encrypted using the requestor's public encryption key and transmitted to the requestor. Upon receiving the response, the requestor can decrypt it using her own private encryption key, and use the data contained within.

In addition to viewing the data, a doctor or other authorized individual may analyze it. In such cases, the doctor may decide that a message should be sent to the patient regarding his health care. According to an embodiment of this invention, the data gathering device may also act as an informational device for such communications. In such cases, the device may be equipped with a data receiver to receive data from the mobile electronic device, and an audio or video display to display the received data. Of course, the display also may be used to display data gathered by the sensor.

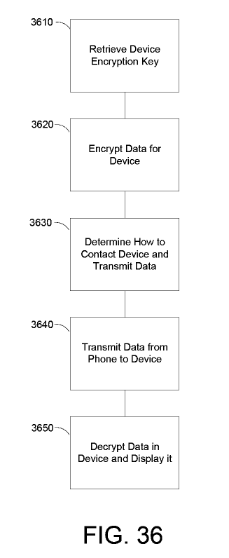

FIG. 36 is a block diagram of a method for a trusted individual to transmit information to the measuring device of FIG. 33. In process 3610 the trusted individual, such as the doctor, retrieves a public encryption key for the target device from a database. As mentioned above, this key is created before the device is placed in service, and may be stored on a hardware security module embedded within the device. The database itself is stored in trusted storage. In process 3620 the doctor uses her phone to encrypt data for the target patient device, using techniques known in the art. In process 3630 the doctor's phone determines the best communications channel for contacting the target device and uploads the message, in the manner of process 3440. At this point, the individual's phone cannot display the message because it has been encrypted with the device's public encryption key, the decryption key for which is stored only in the device itself. In process 3640 the phone transmits the data to the target device. As before, this message may be transmitted without channel encryption, because only the target device can decrypt it. Finally, in process 3650 the device decrypts the data for display using the video and/or audio displays.

The embodiment described above has several advantages. All data are encrypted using the patient's public encryption key. The patient validates his identity and controls the transmission of all data which is protected by his encryption key. The data gathering device can also be updated, and transmissions to the device will be encrypted, with the device public encryption key. Thus even software updates must be validated. The use of these encryption keys enhances overall system security.

As a further advantage, the smartphone acts as a local data server. It has all of the necessary certificates for data gathering devices and trusted storage servers to validate system communications. Each system component validates each message before it makes any acknowledgements of them. Each system component has its own certificate, including the patient phone. The user has an identity certificate that is used to issue a challenge for any sensitive transactions. Since a smartphone in accordance with an embodiment of the invention can include significant memory, all communications between the data gathering device and the phone can be done without a cellular network. This feature can represent a significant cost savings for manufacturers of data gathering devices who wish for their devices to take advantage of the PKI network system described herein.

As an additional advantage, the trusted cloud server has a certificate and is treated like any other device on the network. All communications are encrypted by the patient's encryption keys. Therefore there is no single key that can decode all of the data on the trusted storage server, enhancing overall security. A trusted storage server can be configured to deny general logins, and to only process trusted transactions. Based on a transaction's content, its data may be published to various distributed trusted servers. Patient data may be published to a patient-accessible server in which all data remains encrypted until requested by the patient. Such data can be accessed only by that patient, or an authorized individual. An enterprise server and database may be created to house this data. Access to patient-identifying data, including that covered by laws such as HIPAA, requires validation of a trust chain and a high level of assurance. Thus, the system can be configured with sufficient security features to comply with applicable governing laws.

The present invention may be embodied in many different forms, including, but not limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive. Numerous variations and modifications will be apparent to those skilled in the art. All such variations and modifications are intended to be within the scope of the present invention as defined in any appended claims.

What is claimed is:

1. A process for authenticating an individual to participate in a transaction with a relying party, the process comprising:
producing a mobile electronic device, the device storing a digitally signed document containing a set of credential data of the individual, and requiring, as a condition to using the stored set of credential data for authentication purposes, entry into the device of authentication data authenticating a would-be user of the device as the individual;
entering the authentication data into the device to authenticate the individual to the device, so that the individual can use the stored set of credential data; and
causing the device to communicate the set of credential data to a system of the relying party, for purposes of authenticating the individual to participate in the transaction.

2. A process according to claim 1, wherein the transaction includes a purchase.

3. A process according to claim 1, wherein the transaction includes receiving an extension of credit.

4. A process according to claim 1, wherein the transaction includes obtaining access to money stored in a financial account.

5. A process according to claim 1, wherein the transaction includes obtaining access to a physical location.

6. A process according to claim 1, wherein the transaction includes obtaining access to a web page.

7. A process according to claim 1, wherein the transaction includes obtaining access to a computing resource.

8. A process according to claim 1, wherein the transaction includes obtaining access to data by downloading.

9. A process according to claim 1, wherein the transaction includes receiving an HTTP cookie.

10. A process according to claim 1, wherein the transaction includes uploading medical data of the individual.

11. A process according to claim 1, wherein the mobile electronic device includes one of a smartphone and a personal digital assistant.

12. A process according to claim 1, wherein the mobile electronic device includes WORM memory.

13. A process according to claim 12, wherein the WORM memory includes a set of encryption data, the set having a private encryption key of the individual.

14. A process according to claim 12, wherein the WORM memory includes a set of encryption data, the set having a private signature key of the individual.

15. A process according to claim 12, wherein the mobile electronic device includes a display and an advertisement associated with an item in the set of encryption data, the process further comprising displaying the advertisement on the display in connection with use of the device.

16. A process according to claim 15, wherein the advertisement is stored in the WORM memory.

17. A process according to claim 1, wherein the set of credential data is derived from one or more of: a passport, a birth certificate, a Transportation Worker Identification Credential (TWIC), a Common Access Card (CAC), a smartcard, a driver's license, a pilot's certificate, an identification card, an organization membership card, an insurance card, a credit card, a debit card, a store discount card, a public transportation card, or a library card.

18. A process according to claim 1, wherein entering authentication data includes entering data pertaining to one of: a fingerprint, a handprint, a photograph, an iris scan, a retina scan, a password, an authorization code, or a personal identification number.

19. A process according to claim 1, wherein entering authentication data includes providing two-factor authentication data.

20. A process according to claim 19, wherein entering authentication data includes providing a password and biometric data.

21. A process according to claim 1, wherein causing the device to communicate includes triggering wireless communication by the device.

22. A process according to claim 1, wherein the system of the relying party includes one of: a vending machine, a parking meter, an electronic toll collection system, a physical access system, and a magnetic stripe reader.

23. A process according to claim 1, wherein a suite of applications is stored on the device, and the set of credential data identifies a subset of the suite of applications to be made available to the individual upon authentication of the would-be user as the individual.

24. A process according to claim 1, further comprising:
causing the device to run an application loaded thereon, the application being unavailable for use until there has been entry into the device of authentication data authenticating the would-be user of the device as the individual.

25. A process according to claim 1, further comprising:
receiving at the mobile electronic device, from the system of the relying party, a response to the communication of the set of credentials.

26. A process according to claim 25, wherein receiving the response includes receiving a verification of the set of credential data of the individual.

27. A process according to claim 25, wherein receiving the response includes receiving a notification that the transaction has been completed.

28. A process according to claim 25, wherein receiving the response triggers updating a transaction log maintained on the mobile electronic device.

29. A process according to claim 28, wherein receiving the response triggers setting of an upload flag to enqueue uploading of data reflecting the transaction.

30. A process according to claim 25, wherein the mobile electronic device includes a WORM memory, and the mobile device performs, on the WORM memory, an operation triggered by receiving the response.

31. A process according to claim 30, wherein the operation is storage of data related to the response.

32. A process according to claim 30, wherein the operation is rendering a portion of the WORM memory unreadable.

33. A process according to claim 1, wherein causing the device to communicate the set of credential data triggers storing, in a transaction log maintained on the mobile electronic device, a record having data related to the transaction.

34. A process for use by a relying party in authenticating an individual having a mobile electronic device to participate in a transaction with the relying party, the device storing a digitally signed document containing a set of credential data of the individual and requiring, as a condition to using the stored set of credential data for authentication purposes, entry into the device of authentication data authenticating a would-be user of the device as the individual, the process comprising:
receiving, in a system in communication with the device, the digitally signed document from the device, wherein receipt of the digitally signed document constitutes verification of entry into the device of the authentication data;
using the system to evaluate a credential in the set of credentials; and
storing data, associated with the transaction and the digitally signed document, in the system of the relying party in a transaction log.

35. A process according to claim 34, wherein the transaction includes a purchase.

36. A process according to claim 34, wherein the transaction includes granting an extension of credit.

37. A process according to claim 34, wherein the transaction includes providing access to money stored in a financial account.

38. A process according to claim 34, wherein the transaction includes providing access to a physical location.

39. A process according to claim 34, wherein the transaction includes providing access to a web page.

40. A process according to claim 34, wherein the transaction includes providing access to a computing resource.

41. A process according to claim 34, wherein the transaction includes providing access to data for downloading by the individual.

42. A process according to claim 34, wherein the transaction includes transmitting an HTTP cookie.

43. A process according to claim 34, wherein the mobile electronic device includes one of a smartphone and a personal digital assistant.

44. A process according to claim 34, wherein the mobile electronic device includes WORM memory.

45. A process according to claim 44, wherein the WORM memory includes a set of encryption data, the set having a private encryption key of the individual.

46. A process according to claim 44, wherein the WORM memory includes a set of encryption data, the set having a private signature key of the individual.

47. A process according to claim 46, wherein using the system to evaluate the credential includes validating a digital signature of the digitally signed document, using a public signature key of the individual that forms a key pair with the private signature key of the individual.

48. A process according to claim 34, wherein the set of credential data is derived from one or more of: a passport, a birth certificate, a Transportation Worker Identification Credential (TWIC), a Common Access Card (CAC), a smartcard, a driver's license, a pilot's certificate, an identification card, an organization membership card, an insurance card, a credit card, a debit card, a store discount card, a public transportation card, or a library card.

49. A process according to claim 34, wherein receiving the digitally signed document includes receiving the document wirelessly.

50. A process according to claim 34, wherein using the system to evaluate the credential includes validating a digital signature of the digitally signed document using a public signature key of the individual.

51. A process according to claim 34, wherein using the system to evaluate the credential includes comparing a digest derived from the credential with a stored digest.

52. A process according to claim 34, wherein using the system to evaluate the credential includes comparing the time the digitally signed document was received from the device with a timestamp in the document.

53. A process according to claim 52, wherein the timestamp is indicative of the time when credentials on the mobile electronic device were last updated.

54. A process according to claim 53, wherein the timestamp is indicative of the time when the mobile electronic device was last connected to a network in a session meeting pre-specified criteria.

55. A process according to claim 34, wherein using the system to evaluate the credential includes obtaining a certificate status response from the mobile electronic device.

56. A process according to claim 55, wherein obtaining the certificate status response comprises:
transmitting a first message including a cryptographic nonce to the mobile electronic device, the first message encrypted with a public encryption key of the individual; and
receiving a second message including the nonce and the certificate status response from the mobile electronic device.

57. A process according to claim 34, wherein using the system to evaluate the credential includes communicating with a computer system, of a third party, that can validate the accuracy of the credential or verify that the credential is unexpired.

58. A process according to claim 57, wherein the third party is an issuer of the credential or an agent of the issuer.

59. A process according to claim 57, further comprising obtaining a certificate status response from the third party.

60. A process according to claim 57, further comprising obtaining a certificate revocation list from the third party.

61. A process according to claim 57, wherein communicating includes receiving, from the third party, data indicating that the credential has not been revoked.

62. A process according to claim 34, further comprising:
transmitting, to the mobile electronic device, a response to the communication of the set of credentials.

63. A process according to claim 62, wherein transmitting the response includes transmitting data indicating that a credential in the set of credentials is valid and unexpired.

64. A process according to claim 62, wherein transmitting the response includes transmitting a notification that the transaction has been completed.

65. A mobile electronic device, usable by an individual for authentication of transactions, the device comprising:
a storage module in which are stored:
(i) a digitally signed document containing a set of credentials of the individual, and
(ii) authentication data of the individual;
a data entry arrangement for entering data into the device;
a controller, coupled to the storage module and the data entry arrangement, programmed to require, as a condition to using the stored set of credentials for authentication purposes, entry of the authentication data into the device via the data entry arrangement, so as to authenticate a would-be user of the device as the individual; and
a communication port for receiving and transmitting the digitally signed document.

66. A device according to claim 65, wherein the set of credentials includes a plurality of credentials of the individual, so that the device can be used to authenticate distinct classes of transactions, each class of transactions being associated with a distinct one of the credentials.

67. A device according to claim 65, wherein the storage module includes non-volatile memory.

68. A device according to claim 65, wherein the storage module includes WORM memory.

69. A device according to claim 68, wherein the WORM memory includes the digitally signed document.

70. A device according to claim 68, wherein the WORM memory includes a set of encryption data, the set having a private encryption key of the individual.

71. A device according to claim 68, wherein the WORM memory includes a set of encryption data, the set having a private signature key of the individual.

72. A device according to claim 65, wherein the storage module includes both WORM memory and WMRM memory incorporated in flash memory.

73. A device according to claim 65, wherein the storage module includes an application, stored therein, and the device further comprises:
an access control module restricting use of the application until there has been entry into the device, via the data entry arrangement, of the authentication data, to authenticate the would-be user of the device as the individual.

74. A process for configuring an electronic device to be usable by an individual for authentication of transactions, the process comprising:
storing a digitally signed document in the electronic device, the digitally signed document including credential data derived from a set of credentials pertaining to the individual;
storing, in the electronic device, authentication data associated with the individual;
wherein the device includes an access control module that precludes access to the credential data without entry into the device of the authentication data.

75. A process according to claim 74, wherein the set of credentials includes a physical credential.

76. A process according to claim 75, wherein the physical credential is selected from the group consisting of: a passport, a birth certificate, a Transportation Worker Identification Credential (TWIC), a Common Access Card (CAC), a smartcard, a driver's license, a pilot's certificate, an identification card, an organization membership card, an insurance card, a credit card, a debit card, a store discount card, a public transportation card, and a library card.

77. A process according to claim 74, wherein the set of credentials includes a virtual credential.

78. A process according to claim 74, further comprising:
receiving the physical credential from the individual;
manually determining that the set of credentials pertains to the individual;
creating the digitally signed document; and
entrusting the device to the individual.

79. A process according to claim 74, further comprising obtaining biometric data of the individual and including the biometric data in the authentication data.

80. A process according to claim 74, wherein a digital signature in the digitally signed document is verifiable using a public signature key of the individual.

81. A process according to claim 74, wherein a digital signature in the digitally signed document is verifiable using a public signature key of a third party.

82. A process according to claim 74, wherein the electronic device includes WORM memory, and storing the digitally signed document in the electronic device includes storing the document in the WORM memory.

83. A process according to claim 74, further comprising storing a private encryption key of the individual in the electronic device.

84. A process according to claim 74, further comprising storing a private signature key of the individual in the electronic device.

85. A computer-implemented method of developing information pertinent to authentication of a set of credentials of a given individual, the set of credentials associated with a plurality of sets of credentials of other individuals, the method comprising:
for each of the individuals,
verifying such individual's credentials as being at the end of a chain of trust, placing such individual's credentials in a digitally signed document, and storing the digitally signed document in a credential database; and
automatically and repetitively checking, in a computer process, for revocation of any credentials in the credential database and storing data identifying credentials that have been revoked.

86. A method according to claim 85, wherein storing data identifying credentials that have been revoked includes updating the credential database.

87. A method according to claim 85, wherein storing data identifying credentials that have been revoked includes storing in a revocation database a listing of credentials that have been revoked.

88. A method according to claim 85, further comprising, for each of the individuals, storing the digitally signed document includes storing it in a token entrusted to such individual.

89. A method according to claim 85, wherein checking includes checking at least as often as once per day.

90. A method according to claim 85, wherein checking includes checking in conformity with a PKI standard.

91. A computer-implemented method of authenticating a given individual's set of credentials, each credential in the set having been authenticated as of a given time, the method comprising:
receiving the set of credentials over a communications network; and
in a computer process, comparing the set of credentials against a database listing of revoked credentials to identify a credential in the set that has been revoked since the given time.

92. A method according to claim 91, wherein receiving the set of credentials comprises receiving them from a federated data store.

93. A method according to claim 91, wherein receiving the set of credentials comprises uploading a digital document from a token in the possession of the given individual, such digitally signed document containing the individual's set of credentials.

94. A method according to claim 91, wherein identifying credentials of the individual that have been revoked implicitly determines that all other credentials of the given individual have not been revoked.

95. A method according to claim 91, wherein comparing is performed in a batch computer process.

96. A computer-implemented method of processing transactions between a relying party having a transaction system, and a set of individuals, each individual in the set of individuals having an electronic device capable of communication with the transaction system, the method comprising:
obtaining access to a first digitally signed document created in the transaction system of the relying party, the document containing one or more transaction records, each transaction record having data pertaining to a selected transaction between the relying party and a selected individual in the set of individuals; and
for each selected transaction,
obtaining access to a second digitally signed document created in the electronic device of the selected individual, the document containing a transaction record corresponding to the selected transaction; and
in a computer process, checking for consistency between the transaction record in the first digitally signed document and the transaction record in the second digitally signed document.

97. A method according to claim 96, further comprising validating a digital signature of the first digitally signed document, using a public signature key of the relying party.

98. A method according to claim 96, further comprising, validating a digital signature of the second digitally signed document of the selected individual, using a public signature key of the selected individual.

99. A method according to claim 96, further comprising, in the event that checking yields an inconsistency, communicating a warning to the relying party or the selected individual.

100. A method according to claim 96, wherein each transaction record contains data pertaining to at least one of a transaction time, a transaction date, a purchase amount, a loan number, a financial account number, a physical location, an address of a web page, an identifier of a computing resource, a file name, an HTTP cookie name, and a medical condition.

101. A method according to claim 96, wherein obtaining access to the first digitally signed document includes receiving the first digitally signed document over a computer data network.

102. A method according to claim 96, wherein obtaining access to the second digitally signed document includes receiving the second digitally signed document over a computer data network.

103. A method according to claim 96, wherein checking is performed in a batch computer process.

104. A method according to claim 96, wherein checking is performed in a process substantially contemporaneously with the selected transaction.

105. A system enabling a second party to obtain data in a secure manner from a first party, the system comprising:
a receiving port for securely receiving the data, along with a digitally signed document associated with the first party and a reference to the second party;
a physical data storage medium for storing the received data and the digitally signed document in association with the second party;
a processor for validating that the sender of the received data is the first party using the digitally signed document, and for determining whether to securely forward data stored in the storage area to the second party according to a rule associated with the first party and the second party; and
a transmitting port for forwarding the data to a computer facility of the second party.

106. A system according to claim 105, wherein the storage area is readable only by the first party and the second party.

107. A system according to claim 105, wherein the storage area is associated with a URL.

108. A computerized method enabling a second party to obtain data in a secure manner from a first party, the method comprising:
receiving from the first party items including the data, a digitally signed document associated with the data and with the first party, and a reference to the second party;
verifying that the received data were sent by the first party, by using the digitally signed document;
storing the data in association with the digitally signed document and with the reference; and
making the stored data available to the second party using the reference, such that the second party may securely access the data.

109. A method according to claim 108, wherein the data have been encrypted using a public key of the second party.

110. A method according to claim 108, wherein the items are included in a message that has been encrypted using a public key associated with the receiver and receiving the items includes:
receiving the message from the first party, and
decrypting the message using a private key associated with the public key.

111. A method according to claim 108, wherein the reference includes at least one of a digital certificate, a telephone number, a postal address, and an electronic address.

112. A method according to claim 108, wherein making the stored data available comprises:
encrypting a second message, containing the data and the digitally signed document, using a public key of the second party; and
transmitting the encrypted second message to the second party.

113. A method according to claim 108, wherein the storage space is readable only by the first party and the second party.

114. A method according to claim 108, wherein receiving the data from the first party includes using a secure communications link.

115. A method according to claim 108, further comprising deciding whether to forward the data to the second party according to a set of computer-implemented rules associated with the first party and the second party.

116. A method according to claim 108, further comprising forwarding the data to the second party.

117. A method according to claim 116, wherein forwarding the data to the second party includes using a secure communications link.

118. A method according to claim 108, wherein receiving the items from the first party includes receiving the items through a communications gateway that is not dedicated to handling trusted data from a particular source.

119. A method according to claim 118, wherein the communications gateway also handles data other than trusted data.

120. A method according to claim 118, wherein verifying that the received data were sent by the first party is accomplished by the communications gateway.

121. A method according to claim 120, wherein verifying that the received data were sent by the first party includes accessing an authorized certificate store to retrieve a certificate of the first party.

122. A method according to claim 121, wherein making the stored data available to the second party using the reference is accomplished by the communications gateway.

123. A method according to claim 120, wherein storing the data in association with the digitally signed document and with the reference is caused by the communications gateway.

124. A method according to claim 118, further comprising:
upon receiving the items from the first party, initiating communication with the second party to obtain authorization to cause storage of the data.

125. A method according to claim 124, wherein the second party has a mobile telephone, and making the stored data available to the second party includes sending a communication to the mobile telephone identifying the received data and seeking authorization to make the received data available to the second party, and, upon such authorization, making the received data available to the second party.

126. A method according to claim 125, wherein making the received data available to the second party includes making the data accessible to the mobile telephone for storage in memory thereof.

127. A method according to claim 126, wherein the memory of the mobile telephone is flash memory.

128. A method according to claim 126, wherein the data include information relating to a credential, and making the data accessible to the mobile telephone for storage in memory thereof includes making the data accessible for storage only in a portion of such memory configured as WORM memory.

129. A method according to claim 108, wherein the data include information relating to a credential, and making the stored data available to the second party includes making the data accessible for storage only in memory configured as WORM memory.

130. A method according to claim 129, wherein the WORM memory is implemented in flash memory.

131. A method according to claim 108, wherein the data are digital media content encrypted with a public key of the second party.

132. A computerized method for creating a virtual smartcard for an individual based on a physical credential applicable to the individual, the method comprising:
receiving, over a communications network, credential data derived from the physical credential;
receiving, over the communications network, authentication data pertinent to the individual;
using a computer process to establish a pair of cryptographic keys; and
creating a virtual smartcard for the individual by storing the credential data and the authentication data in association with the pair of cryptographic keys.

133. A method according to claim 132, wherein the physical credential is selected from the group consisting of a passport, a birth certificate, a Transportation Worker Identification Credential (TWIC), a smartcard, a driver's license, a pilot's certificate, an identification card, an organization membership card, an insurance card, a credit card, a debit card, a store discount card, a public transportation card, and a library card.

134. A method according to claim 132, wherein authentication data are selected from the group consisting of biometric data and a passcode.

135. A method of evaluating a primary credential issued by an agency, the method comprising:
using the primary credential to access from storage a summary certificate associated in the storage with the primary credential, the summary certificate containing a collection of secondary credentials considered by the agency in issuing the primary credential;
in a revocation computer process, collecting secondary credential revocation information by (i) identifying each of the secondary credentials that is the subject of a revocation, and, (ii) for each revoked credential, accessing data that characterize a basis for the revocation; and
in an evaluation computer process, applying a set of policy rules to the collected secondary credential revocation information to evaluate its effect on the primary credential.

136. A method according to claim 135, wherein the revocation computer process includes accessing a database of revoked credentials, the database established by automatic, computer-implemented, repetitive checking for revocation of secondary credentials of a plurality of individuals.

137. A method according to claim 135, wherein one of the secondary credentials that is the subject of revocation is another primary credential that has been previously revoked by operation of computer processes, so that processes herein may spawn a cascade of revocations when permitted by policy rules to do so.

138. A method according to claim 135, wherein accessing data that characterize a basis for the revocation include accessing data indicating that a chain of trust for a secondary credential has been broken.

139. A method according to claim 135, further comprising revoking the primary credential when the policy rules being applied so require.

140. A method according to claim 135, wherein the evaluation computer process leads to revocation of the primary credential, further comprising:
in a further revocation computer process, identifying a set of additional primary credentials, the set having at least one member, for which the primary credential serves as a secondary credential in a corresponding set of summary certificates; and
in a further evaluation computer process, subjecting the set of primary credentials to evaluation in a manner generally analogous to the evaluation computer process.

141. A computerized method for responding to a given individual's request for access, the method comprising:
receiving, over a first communications network, a first data set defining rights of the given individual to access;
receiving, over a second communications network, from a token possessed by the given individual, a digitally signed document including a second data set defining rights of the given individual relating to the access; and
in a computer process, comparing the first access rights data and the second access rights data to respond to the given individual's access rights.

142. A method according to claim 141, wherein receiving over the first communications network includes receiving data from a cellular telephone network.

143. A method according to claim 141, wherein receiving over the first communications network includes receiving data from the Internet.

144. A method according to claim 143, wherein receiving over the first communications network includes receiving data from a virtual private network.

145. A method according to claim 141, wherein receiving over the second communications network includes receiving data from a Bluetooth network.

146. A method according to claim 141, wherein the token is a smartphone.

147. A method according to claim 141, further comprising validating a digital signature of the digitally signed document.

148. A method according to claim 147, wherein validating the digital signature includes receiving data from the token pertaining to a digital certificate, the digital certificate having a public signature key.

149. A method according to claim 148, wherein receiving data includes receiving a cached OCSP response.

150. A non-volatile memory device encoded with computer-readable data, such device including a first portion thereof configured as WORM memory in which are encoded credential data and a second portion thereof configured as WMRM memory.

151. A device according to claim 150, wherein the device is also encoded with computer-readable instructions, such instructions including program code defining a cryptographic engine.

152. A device according to claim 150, wherein the credential data relate to a plurality of credentials of an individual.

153. A device according to claim 150, such device being implemented in flash memory.

154. A method for efficiently authenticating an individual in connection with a transaction, at a physical transaction location, such location using a public key infrastructure and having a terminal for use in the transaction, the method comprising:
using data provided over a cellular telephone network to estimate a present location of a smartphone of the individual on which is stored credential data relating to a credential of the individual, such smartphone requiring the individual to authenticate himself to the smartphone as a condition of use of the credential data;
if the present location is determined to be within a specified range of the physical transaction location, sending data as to status of the credential to the terminal,
so that the individual will be able to present the credential for use in the transaction only by authenticating himself to the smartphone, and status information of the credential will be available to the terminal for use in connection with the transaction when the individual appears at the physical location.

155. A method according to claim 154, wherein using data provided over a cellular telephone network to estimate a present location includes using base station data.

156. A method according to claim 154, wherein using data provided over a cellular telephone network to estimate a present location includes using GPS data from the smartphone.

157. A method for gating communication to a user's smartphone from a caller's smartphone based on a set of pre-specified criteria as to attributes of the caller, the method comprising:
receiving on the user's smartphone a control message from the caller's smartphone constituting a request to establish communication with the user's smartphone, such control message including a credential of the caller;
using a process running on the user's smartphone, determining validity of the credential, and if the credential is determined to be valid, evaluating the credential for conformity with the set of criteria;
if the credential is determined to be in conformity with the set of criteria, then allowing the communication to be established.

158. A method according to claim 157, wherein the set of criteria includes presence of the name of the caller on a white list.

159. A method according to claim 157, wherein the user has an age, and the set of criteria includes a requirement that the caller have an age that is within two years of the user's age.

160. A data gathering device for communicating with a mobile electronic device of an individual, the mobile electronic device being capable of decrypting messages according to an encryption key of the individual, the data gathering device comprising:
a sensor for gathering data;
a cryptographic module for encrypting gathered data using the encryption key; and
a transmitter for transmitting encrypted data to the mobile electronic device.

161. A device according to claim 160, wherein the transmitter is a Bluetooth transmitter.

162. A device according to claim 160, wherein the cryptographic module is a hardware security module.

163. A device according to claim 160, further comprising a smartcard, wherein the cryptographic module is embedded within the smartcard.

164. A device according to claim 160, further comprising:
a receiver for receiving encrypted data from the mobile electronic device; and
a display for displaying received data,
wherein the cryptographic module is further capable of decrypting received data according to the encryption key.

165. A device according to claim 164, wherein the display is a video display.

166. A device according to claim 164, wherein the display is an audio display.

167. A device according to claim 164, wherein the display is further capable of displaying gathered data.

168. A device according to claim 160, wherein the sensor gathers medical data, and the data gathering device is a medical device.

169. A method for securely obtaining, from a medical data gathering device, medical data pertinent to an individual, the method comprising:
receiving the medical data over a wireless network from a smartphone of the individual coupled to the medical data gathering device, wherein:
(i) the smartphone stores and forwards, over the wireless network, the data from the medical data gathering device; and
(ii) the medical data are encrypted with a public key of the individual.

170. A method according to claim 169, wherein the smartphone is wirelessly coupled to the medical data gathering device.

171. A method according to claim 169, wherein the smartphone includes flash memory in which the medical data are stored.

172. A method according to claim 169, wherein the smartphone includes a storage module in which is stored a digitally signed document containing a set of credentials of the individual.

173. A method according to claim 172, wherein the storage module also stores authentication data of the individual and the smartphone further includes a data entry arrangement for entering data into the device, a controller, coupled to the storage module and the data entry arrangement, programmed to require, as a condition to using the stored set of credentials for authentication purposes, entry of the authentication data into the device via the data entry arrangement, so as to authenticate a would-be user of the device as the individual.

174. A method according to claim 169, further comprising storing the data received over the wireless network in a database coupled to a server for access by authorized medical professionals.

175. A method according to claim 174, further comprising decrypting and granting access to the medical data in response to a request by a person determined to be an authorized medical professional.
